(19) United States
(12) Patent Application Publication
(10) Pub. No.: US 2026/0197386 A1
(43) Pub. Date: Jul. 9, 2026

(54) HANDHELD ELECTRONIC DEVICE

(71) Applicant: Apple Inc., Cupertino, CA (US)

(72) Inventors: Jiachen Xu, Milpitas, CA (US); Jia Yuan Neoh, Cupertino, CA (US); Ana Solbes Alonso, San Francisco, CA (US); Daniel W. Jarvis, Sunnyvale, CA (US); Jon F. Housour, San Francisco, CA (US); Michael D. Quinones, Santa Cruz, CA (US); Shen Wang, San Francisco, CA (US); Benjamin S. Bustle, Cupertino, CA (US)

(21) Appl. No.: 19/322,559

(22) Filed: Sep. 8, 2025

Related U.S. Application Data
(60) Provisional application No. 63/741,766, filed on Jan. 3, 2025.
(60) Provisional application No. 63/767,463, filed on Mar. 5, 2025.

(51) Int. Cl. H04M 1/02

(52) U.S. Cl. CPC H04M 1/0266

(57) ABSTRACT

A mobile phone may include a display, a front cover, and a housing structure coupled to the front cover and including a first metal segment defining at least a portion of a first side exterior surface of the mobile phone and at least a portion of a second side exterior surface of the mobile phone, a second metal segment at least partially defining a protrusion, the protrusion defining a rear-facing sensor array region of the mobile phone, and a nonconductive joint structure positioned in a gap defined between the first metal segment and the second metal segment, the gap extending at least partially around the protrusion and defining a slot antenna. The mobile phone may further include wireless communications circuitry conductively coupled to at least one of the first metal segment or the second metal segment and configured to cause the slot antenna to radiate to produce a wireless signal.

### CROSS-REFERENCE TO RELATED APPLICATION(S)

This application is a nonprovisional patent application of and claims the benefit of U.S. Provisional Patent Application No. 63/741,766, filed Jan. 3, 2025 and titled “Handheld Electronic Device,” and U.S. Provisional Patent Application No. 63/767,463, filed Mar. 5, 2025 and titled “Handheld Electronic Device,” the disclosures of which are hereby incorporated herein by reference in their entireties.

### FIELD

The subject matter of this disclosure relates generally to handheld and/or portable electronic devices, and more particularly, to portable electronic devices such as mobile phones.

### BACKGROUND

Modern consumer electronic devices take many shapes and forms, and have numerous uses and functions. Smartphones, for example, provide various ways for users to interact with other people that extend beyond telephone communications. Such devices may include numerous systems to facilitate such interactions. For example, a smartphone may include a touch-sensitive display for providing graphical outputs and for accepting touch inputs, wireless communications systems for connecting with other devices to send and receive voice and data content, cameras for capturing photographs and videos, and so forth. However, integrating these subsystems into a compact and reliable product that is able to withstand daily use presents a variety of technical challenges. The systems and techniques described herein may address many of these challenges while providing a device that offers a wide range of functionality.

### SUMMARY

A mobile phone may include a display, a front cover positioned over the display, a housing structure coupled to the front cover. The housing structure may define a protrusion, the protrusion defining a rear-facing sensor array region and having a metal surface defining a first portion of a rear exterior surface of the mobile phone, and a bezel portion defining at least a portion of an opening in the housing structure. The mobile phone may further include a rear cover including glass and positioned at least partially in the opening in the housing structure, the rear cover defining a second portion of the rear exterior surface of the mobile phone, the second portion of the rear exterior surface substantially flush with a surface of the bezel portion of the housing structure, and a camera module positioned at least partially in a hole formed through the protrusion in the rear-facing sensor array region.

The camera module may be a first camera module, the hole may be a first hole, and the mobile phone may further include a second camera module positioned at least partially in a second hole formed through the protrusion in the rear-facing sensor array region, a third camera module positioned at least partially in a third hole formed through the protrusion in the rear-facing sensor array region, a depth sensor module positioned at least partially in a fourth hole formed through the protrusion in the rear-facing sensor array region, and a flash module positioned at least partially in a fifth hole formed through the protrusion in the rear-facing sensor array region.

The housing structure may include a first metal segment defining at least a portion of a first side exterior surface of the mobile phone and at least a portion of a second side exterior surface of the mobile phone, a second metal segment defining the protrusion, and a nonconductive joint structure positioned in a gap between the first metal segment and the second metal segment and conductively isolating at least a portion of the first metal segment from at least a portion of the second metal segment. The nonconductive joint structure may structurally couple to the first metal segment and the second metal segment. The housing structure may further include a third metal segment defining a third side exterior surface of the mobile phone and first and second corner surfaces of the mobile phone, and a fourth metal segment defining a fourth side exterior surface of the mobile phone, and second and third corner surfaces of the mobile phone. The first metal segment may define a first portion of the opening in the housing structure, and the second metal segment may define a second portion of the opening in the housing structure.

A portable electronic device may include an enclosure including a light transmissive cover defining a front exterior surface of the portable electronic device, a housing structure defining a protrusion having a metal surface, the metal surface defining a first portion of a rear exterior surface of the enclosure and a bezel portion extending at least partially around an opening, a rear cover defining a silicate-based material surface, the silicate-based material surface positioned in the opening and defining a second portion of the rear exterior surface of the enclosure, a display coupled to the light transmissive cover, and a camera array coupled to the housing structure and including a camera module extending at least partially into a hole formed through the metal surface of the protrusion. The second portion of the rear exterior surface may be substantially flush with a surface of the bezel portion.

The camera module may be a first camera module, the hole may be a first hole, the camera array may further include a second camera module extending at least partially into a second hole formed through the metal surface of the protrusion and a third camera module extending at least partially into a third hole formed through the metal surface of the protrusion, and the portable electronic device may further include a depth sensor module extending at least partially into a fourth hole formed through the metal surface of the protrusion and a flash module extending at least partially into a fifth hole formed through the metal surface of the protrusion.

The housing structure may include a first metal segment defining at least a portion of a first side exterior surface of the portable electronic device and at least a portion of a second side exterior surface of the portable electronic device, and a second metal segment defining the protrusion. The second metal segment may be welded to the first metal segment. The first metal segment and the second metal segment may be part of a unitary forged component.

The housing structure may include a first segment defining the protrusion, a second segment defining the bezel portion, a third segment defining a top exterior surface of the portable electronic device, and a fourth segment defining a bottom exterior surface of the portable electronic device. The hole may be a first hole, the third segment may define a second hole extending therethrough, and the portable electronic device may further include an antenna module positioned at least partially within the enclosure and configured to transmit and receive wireless signals through the second hole in the third segment.

A mobile phone may include a housing structure defining a protrusion formed of metal and defining a first portion of a rear exterior surface of the mobile phone and defining a recess positioned along a side of the protrusion. The mobile phone may further include a silicate-based material panel positioned in the recess and defining a second portion of the rear exterior surface of the mobile phone, a rear-facing sensor array including a camera module positioned in a hole formed through the protrusion, and a front cover assembly coupled to the housing structure and including a display and a light transmissive cover over the display and defining a front exterior surface of the mobile phone.

The recess may be defined at least partially by a bezel portion of the housing structure, the bezel portion defining a third portion of the rear exterior surface of the mobile phone, and the second portion of the rear exterior surface may be substantially flush with the third portion of the rear exterior surface defined by the bezel portion. The silicate-based material panel may be formed of a glass-ceramic material.

The housing structure may include a first metal segment defining at least a portion of a first side exterior surface of the mobile phone and at least a portion of a second side exterior surface of the mobile phone, a second metal segment defining the protrusion, and a third metal segment defining a portion of a top exterior surface of the mobile phone. The hole may be a first hole, and the third metal segment may define a recess having a bottom surface, a second hole formed through the bottom surface of the recess, and a third hole formed through the bottom surface of the recess. The mobile phone may further include an antenna module configured to transmit and receive wireless signals through the second hole, and a nonconductive joint structure may extend through the third hole, substantially fills the recess, and covers the antenna module. The nonconductive joint structure may define an additional portion of the top exterior surface of the mobile phone.

A mobile phone may include a display, a front cover positioned over the display, and a housing structure coupled to the front cover and including a first metal segment defining at least a portion of a first side exterior surface of the mobile phone and at least a portion of a second side exterior surface of the mobile phone, a second metal segment at least partially defining a protrusion, the protrusion defining a rear-facing sensor array region of the mobile phone, and a nonconductive joint structure positioned in a gap defined between the first metal segment and the second metal segment, the gap extending at least partially around the protrusion and defining a slot antenna. The mobile phone may further include wireless communications circuitry conductively coupled to at least one of the first metal segment or the second metal segment and configured to cause the slot antenna to radiate to produce a wireless signal.

The wireless signal may be a first wireless signal, the slot antenna may be a first slot antenna along a first portion of the gap, the wireless communication circuitry may be first wireless communication circuitry, the gap may define a second slot antenna along a second portion of the gap different from the first portion of the gap, and the mobile phone may further include second wireless communications circuitry configured to cause the second slot antenna to radiate to produce a second wireless signal. The mobile phone may further include a first conductive element conductively coupling the first metal segment to the second metal segment across the gap at a first location to define an end of the first slot antenna, and a second conductive element conductively coupling the first metal segment to the second metal segment across the gap at a second location to define an end of the second slot antenna.

The gap may be a first gap, and the housing structure may further include a third metal segment coupled to the first metal segment and the second metal segment and defining at least a portion of a top side exterior surface of the mobile phone, and a fourth metal segment coupled to the first metal segment and the second metal segment and defining at least a portion of a bottom side exterior surface of the mobile phone. The wireless communication circuitry may be first wireless communication circuitry, and the mobile phone may further include second wireless communications circuitry conductively coupled to the third metal segment and configured to operate a portion of the third metal segment as an additional antenna. The third metal segment may define a hole, and the mobile phone may further include an antenna module positioned at least partially within the housing structure and configured to transmit and receive wireless signals through the hole in the third metal segment. The mobile phone may further include a dielectric material window positioned in the hole and covering the antenna module.

A portable electronic device may include an enclosure including a light transmissive cover defining a front exterior surface of the portable electronic device, and a housing structure including a first metal segment defining a portion of a rear exterior surface of the portable electronic device, and a second metal segment protruding from the portion of the rear exterior surface defined by the first metal segment. The second metal segment may be conductively isolated from the first metal segment along a gap defined between the first metal segment and the second metal segment, the gap defining a slot antenna. The portable electronic device may further include wireless communications circuitry operatively coupled to the slot antenna and configured to send and receive wireless signals via the slot antenna.

The second metal segment may define a rear-facing sensor array region, a first hole extending through the second metal segment in the rear-facing sensor array region, and a second hole extending through the second metal segment in the rear-facing sensor array region. The portable electronic device may further include a first camera module positioned at least partially in the first hole, and a second camera module positioned at least partially in the second hole.

The portable electronic device may further include a nonconductive joint structure positioned in the gap and configured to conductively isolate a portion of the first metal segment from a portion of the second metal segment. The nonconductive joint structure may define a portion of a curved transition surface between the first metal segment and the second metal segment. The portion of the curved transition surface may be a first portion of the curved transition surface, the first metal segment may define a second portion of the curved transition surface, and the second metal segment may define a third portion of the curved transition surface. The gap may extend continuously around a periphery of the second metal segment, and the nonconductive joint structure may define a continuous ring structure positioned in the gap, the continuous ring structure defining an additional portion of the rear exterior surface of the portable electronic device.

The slot antenna may be a first slot antenna, the wireless communication circuitry may be first wireless communication circuitry, the wireless signals may be first wireless signals, the gap may further define a second slot antenna and a third slot antenna, and the portable electronic device may further include second wireless communication circuitry operatively coupled to the second slot antenna and configured to send and receive second wireless signals via the second slot antenna, and third wireless communication circuitry operatively coupled to the third slot antenna and configured to send and receive third wireless signals via the second slot antenna.

A mobile phone may include a housing structure including a first housing segment defining a portion of a rear exterior surface of the mobile phone, a second housing segment defining a protrusion protruding from the first housing segment and defining a rear-facing sensor array region and a dielectric structure positioned at least partially within a gap defined between the first housing second and the second housing segment and extending around the protrusion, wireless communication circuitry operatively coupled to the housing structure at a first location to operate a first portion of the gap as a first slot antenna and operatively coupled to the housing structure at a second location to operate a second portion of the gap as a second slot antenna, and a camera module coupled to the second housing segment in the rear-facing sensor array region.

The housing structure may further include a first conductive element conductively coupling the first housing segment to the second housing segment across the gap at a third location to define an end of the first slot antenna, and a second conductive element conductively coupling the first housing segment to the second housing segment across the gap at a fourth location to define an end of the second slot antenna. The first housing segment may be a first metal housing segment, the second housing segment may be a second metal housing segment, the first conductive element may be welded to the first metal housing segment and the second metal housing segment, and the second conductive element may be welded to the first metal housing segment and the second metal housing segment.

The portion of the rear exterior surface may be a first portion of the rear exterior surface, the second housing segment may define a second portion of the rear exterior surface, and the dielectric structure may define a portion of a curved transition region extending from the first portion of the rear exterior surface to the second portion of the rear exterior surface.

The wireless communication circuitry may be first wireless communication circuitry, the housing structure may further include a third housing segment formed of metal and defining at least a portion of a first corner of the housing structure and at least a portion of a second corner of the housing structure, and the mobile phone may further include second wireless communication circuitry operatively coupled to the third housing segment and configured to operate at least a portion of the third housing segment as an additional antenna. The third housing segment may define a hole extending therethrough, the mobile phone may further include a nonconductive window element positioned in the hole and defining a portion of a top exterior surface of the mobile phone, and an antenna module coupled to the third housing segment and configured to transmit and receive wireless signals through the nonconductive window element.

A mobile phone may include a housing structure including a unitary metal housing segment, the unitary metal housing segment defining a first side wall defining at least a portion of a first side exterior surface of the mobile phone, a second side wall defining at least a portion of a second side exterior surface of the mobile phone, and a rear panel extending between the first side wall and the second side wall and defining at least a portion of a rear exterior surface of the mobile phone. The mobile phone may further include a chassis member extending between the first side wall and the second side wall and set apart from the rear panel by a gap, a battery coupled to a first side of the chassis member and positioned within the gap, a circuit board assembly coupled to the first side of the chassis member and positioned within the gap, a display positioned over a second side of the chassis member, the second side of the chassis member opposite the first side of the chassis member, and a front cover positioned over the display and coupled to the unitary metal housing segment, the front cover defining at least a portion of a front exterior surface of the mobile phone.

The chassis member may define a hole extending therethrough, the mobile phone may further include a thermal spreading module positioned in the hole and coupled to the chassis member, and the circuit board assembly may be thermally coupled to the thermal spreading module. The circuit board assembly may be set apart from an interior surface of the rear panel by a clearance distance. The thermal spreading module may be thermally coupled to the chassis member and may be configured to transfer heat received from the circuit board assembly to the chassis member. The thermal spreading module may be a vapor chamber module, the vapor chamber module may define a flange extending about a periphery of the vapor chamber module, and the flange may be welded to the chassis member.

The circuit board assembly may define an alignment hole, the unitary metal housing segment may further define an alignment pin extending from an interior surface of the rear panel and into the alignment hole of the circuit board assembly, and the circuit board assembly may be fastened to the chassis member and set apart from an interior surface of the rear panel by a clearance distance. The alignment pin may be a first alignment pin, the alignment hole may be a first alignment hole, the circuit board assembly may further define a second alignment hole, and the unitary metal housing segment may further define a second alignment pin extending from the interior surface of the rear panel and into the second alignment hole of the circuit board assembly.

A portable electronic device may include a housing structure including a unitary metal housing segment, the unitary metal housing segment defining a first lateral side wall, a second lateral side wall, and a rear panel extending between the first lateral side wall and the second lateral side wall and defining at least a portion of a rear exterior surface of the portable electronic device. The portable electronic device may further include a chassis member extending between the first lateral side wall and the second lateral side wall and set apart from the rear panel, the chassis member defining a hole extending therethrough, a circuit board assembly positioned between the chassis member and the rear panel, the circuit board assembly structurally coupled to the chassis member, and a vapor chamber module positioned in the hole extending through the chassis member, the vapor chamber module thermally coupled to the circuit board assembly and configured to transfer heat away from the circuit board assembly.

The rear panel may define an interior surface opposite the rear exterior surface and an alignment pin extending from the interior surface of the rear panel, and the circuit board assembly may define an alignment hole that receives the alignment pin to align the circuit board assembly relative to the unitary metal housing segment. The alignment hole may be a first alignment hole, the alignment pin may be a substantially cylindrical alignment pin, the rear panel may further define a diamond-shaped alignment pin extending from the interior surface of the rear panel, and the circuit board assembly may define a second alignment hole that receives the diamond-shaped alignment pin to further align the circuit board assembly relative to the unitary metal housing segment.

The vapor chamber module may define a flange formed from a first metal and extending about a periphery of the vapor chamber module, the chassis member may be formed of a second metal different from the first metal, and the flange may be welded to the chassis member.

The portable electronic device may further include a battery positioned between the chassis member and the rear panel and adhered to the chassis member. A first portion of the vapor chamber module may be positioned over the circuit board assembly and a second portion of the vapor chamber module may be positioned over the battery.

The rear panel may define an interior surface opposite the rear exterior surface, and the circuit board assembly may be set apart from the interior surface of the rear panel by a clearance distance.

A mobile phone may include a front cover assembly including a display and a light transmissive cover positioned over the display and defining at least a portion of a front exterior surface of the mobile phone, a metal housing segment coupled to the front cover assembly and including a rear panel, the rear panel defining an interior surface, an exterior rear surface opposite the interior surface, and an alignment pin extending from the interior surface, a chassis member coupled to the metal housing segment and set apart from the rear panel, and a circuit board assembly positioned between the rear panel and the chassis member, the circuit board assembly engaged with the alignment pin extending from the interior surface of the rear panel and fastened to the chassis member.

The circuit board assembly may be set apart from the interior surface of the rear panel by a clearance distance. The alignment pin may be a circuit board alignment pin, and the metal housing segment may further include a first side wall defining a first side exterior surface of the mobile phone, a first chassis mounting feature, and a first chassis alignment pin extending from the first chassis mounting feature. The housing segment may further include a second side wall defining a second side exterior surface of the mobile phone, a second chassis mounting feature, and a second chassis alignment pin extending from the second chassis mounting feature. The chassis member may define an alignment slot configured to engage the first chassis alignment pin and an alignment hole configured to engage the second chassis alignment pin. The chassis member may be coupled to the metal housing segment via a plurality of threaded fasteners.

The mobile phone may further include a vapor chamber module positioned in a hole defined through the chassis member and thermally coupled to the circuit board assembly. The mobile phone may further include a battery positioned between the rear panel and the chassis member and attached to the chassis member via an adhesive, the battery thermally coupled to the vapor chamber module.

A mobile phone may include a housing structure, a display at least partially enclosed by the housing structure, a front cover positioned over the display and coupled to the housing structure, the front cover defining at least a portion of a front surface of the mobile phone, a rear cover coupled to the housing structure, the rear cover formed of a dielectric material and including a panel region defining a first portion of a rear surface of the mobile phone and a rear-facing sensor array region defining a second portion of the rear surface of the mobile phone. The rear-facing sensor array region may be defined by a protrusion along an exterior surface of the rear cover and a recess, opposite the protrusion, along an interior surface of the rear cover. The mobile phone may further include a camera module coupled to the rear cover along a bottom surface of the recess and positioned at least partially in a hole defined through the rear cover in the rear-facing sensor array region. The recess may have a depth between about 2.0 mm and about 3.0 mm.

The rear cover may be attached to the housing structure along a mounting interface, the rear cover may define a curved transition surface along the interior surface of the rear cover and extending from the panel region to a bottom surface of the recess, and the mobile phone may further include a polymer structure coupled to the rear cover along the curved transition surface and defining a portion of the mounting interface. The mobile phone may further include a support plate coupled to the rear cover along the bottom surface of the recess, and the camera module may be coupled to the support plate, thereby coupling the camera module to the rear cover. A portion of the support plate may be encapsulated by the polymer structure.

The camera module may be a rear-facing camera module, and the mobile phone may further include a flash module positioned at least partially in the recess and configured to illuminate a subject during an image capture operation, a speaker module positioned at least partially in the recess and configured to produce an audio output, and a front-facing camera module positioned at least partially in the recess.

The dielectric material may include glass ceramic, and the recess and the protrusion may be formed by a machining operation.

A portable electronic device may include an enclosure including a housing structure defining a peripheral wall of the enclosure, a front cover coupled to the housing structure and defining a front exterior surface of the portable electronic device, and a unitary rear cover formed of a silicate-based material and coupled to the housing structure, the unitary rear cover including a panel region defining a first portion of a rear surface of the portable electronic device and having a first thickness and a rear-facing sensor array region defining a second portion of a rear surface of the portable electronic device and having a second thickness different from the first thickness. The rear-facing sensor array region may be defined at least in part by a recess along an interior surface of the unitary rear cover. The portable electronic device may further include a display positioned below the front cover and a camera module coupled to the unitary rear cover and positioned at least partially in the recess.

The rear-facing sensor array region may be further defined by a protrusion along an exterior surface of the unitary rear cover, and the second thickness may be greater than the first thickness. The unitary rear cover may define a transition region between the panel region and the rear-facing sensor array region, the transition region defined by a first curved surface along the exterior surface of the unitary rear cover and a second curved surface along the interior surface of the unitary rear cover. The portable electronic device may further include a molded polymer structure coupled to the unitary rear cover along the second curved surface. The molded polymer structure may define a portion of a mounting interface along which the unitary rear cover may be coupled to the housing structure. The portable electronic device may further include a support plate positioned in the recess and at least partially encapsulated by the molded polymer structure, and the camera module may be coupled to the support plate, thereby coupling the camera module to the unitary rear cover. The first curved surface may be a first machined surface, and the second curved surface may be a second machined surface.

A mobile phone may include a housing structure defining at least one side wall of the mobile phone, a front cover assembly coupled to the housing structure and defining at least a portion of a front exterior surface of the mobile phone, and a rear cover assembly coupled to the housing structure along a mounting interface of the rear cover assembly and defining at least a portion of a rear exterior surface of the mobile phone, the rear cover assembly including a rear cover member formed of a silicate-based material and defining a first interior surface portion defining a first portion of the mounting interface of the rear cover assembly, a second interior surface portion recessed relative to the first interior surface portion, and a transition surface extending from the first interior surface portion to the second interior surface portion, and a polymer structure coupled to the rear cover along the transition surface and defining a second portion of the mounting interface of the rear cover assembly.

The polymer structure may be a thermoset polymer structure molded against the transition surface. The mobile phone may further include a continuous adhesive extending along the first portion of the mounting interface and the second portion of the mounting interface. The first portion of the mounting interface may be coplanar with the second portion of the mounting interface.

The mobile phone may further include a cosmetic member positioned on the transition surface and between the rear cover member and the polymer structure. The cosmetic member may include at least one opaque layer applied directly to the silicate-based material, and at least one outer layer over the at least one opaque layer, the polymer structure adheres to the outer layer, and the cosmetic member may have a thickness between about 30 microns and about 70 microns.

A portable electronic device may include a display, a front cover over the display, a housing coupled to the front cover and defining a first portion of a rear exterior surface of the portable electronic device, and a protrusion defining a raised sensor array region, the raised sensor array region defining a second portion of the rear exterior surface, a first hole defined through the protrusion in the raised sensor array region, and a second hole defined through the protrusion in the raised sensor array region. The portable electronic device may further include a camera lens assembly aligned with the first hole and defining a first principal axis perpendicular to the second portion of the rear exterior surface, and a depth sensor module including a depth sensor lens assembly, the depth sensor lens assembly aligned with the second hole and defining a second principal axis oblique to the second portion of the rear exterior surface.

The second principal axis may be angled towards the first principal axis. The housing may further define a depth sensor mounting surface opposite the second portion of the rear exterior surface, and the depth sensor mounting surface may define a mounting plane that may be nonparallel to the second portion of the rear exterior surface. The mounting plane may be angled between about 1 degree and about 5 degrees relative to the second portion of the rear exterior surface.

The second principal axis may be angled between about 1 degree and about 5 degrees towards the first principal axis. The second principal axis may be angled between about 2 degrees and about 7 degrees towards the first principal axis.

The camera lens assembly may define a first field of view, the depth sensor lens assembly may define a second field of view, and the first field of view may at least partially overlap the second field of view between about 50 centimeters and about 100 centimeters from the second portion of the rear exterior surface.

The depth sensor lens assembly may be an image capture lens assembly, the depth sensor module may include the image capture lens assembly and a projector lens assembly, and the projector lens assembly may define a third principal axis oblique to the second portion of the rear exterior surface. The second principal axis may be angled between about 2 degrees and about 5 degrees towards the first principal axis, and the third principal axis may be angled between about 2 degrees and about 5 degrees towards the first principal axis. The second and third principal axes may be angled at a same angle towards the first principal axis.

A portable electronic device may include a display, a front cover over the display, and a housing coupled to the front cover and defining a rear exterior surface of the portable electronic device and a depth sensor mounting surface opposite the rear exterior surface, the depth sensor mounting surface defining an oblique angle relative to the rear exterior surface. The portable electronic device may further include a camera lens assembly coupled to the housing and defining a first principal axis perpendicular to the rear exterior surface, and a depth sensor module mounted to the depth sensor mounting surface and including a depth sensor lens assembly, the depth sensor lens assembly defining a second principal axis, the oblique angle of the depth sensor mounting surface configured to angle the second principal axis of the depth sensor lens assembly towards the first principal axis of the camera lens assembly.

The second principal axis may be angled between about 1 degree and about 5 degrees towards the first principal axis. The camera lens assembly may define a first field of view, the depth sensor lens assembly may define a second field of view, and the first field of view may overlap the second field of view between about 50 centimeters and about 100 centimeters from the rear exterior surface. The depth sensor lens assembly may be at least one of an image capture lens assembly or a projector lens assembly. The depth sensor lens assembly may be an image capture lens assembly, the depth sensor module includes the image capture lens assembly, and a projector lens assembly, and the projector lens assembly may define a third principal axis oblique to the rear exterior surface. The second and third principal axes may be angled at a same angle towards the first principal axis.

A portable electronic device may include a display, a front cover over the display, a housing coupled to the front cover and defining a rear exterior surface, a rear-facing camera lens assembly coupled to the housing and defining a first principal axis perpendicular to the rear exterior surface, and a rear-facing depth sensor lens assembly coupled to the housing and defining a second principal axis oblique to the rear exterior surface.

The housing may define a protrusion defining a raised sensor array region, the raised sensor array region defining a portion of a rear exterior surface of the portable electronic device and a hole defined through the protrusion, and the rear-facing depth sensor lens assembly may be aligned with the hole defined through the protrusion. The hole may be a first hole, the housing may further define a second hole defined through the protrusion, and the rear-facing camera lens assembly may be aligned with the second hole defined through the protrusion. The second principal axis may be angled towards the first principal axis.

A mobile phone may include a housing structure including a metal segment, the metal segment defining at least a portion of a bottom side of the mobile phone, an opening of a charging port, the charging port positioned along the bottom side of the mobile phone and configured to receive a plug of a charging cable, and a port structure extending from an interior side of the metal segment and defining at least a portion of an interior wall of the charging port. The mobile phone may further include a molded polymer structure coupled to an end of the port structure and defining at least a bottom surface of the charging port, a charging cable connector coupled to the housing structure and including a connection member extending through a hole formed through the bottom surface of the charging port, the connection member configured to conductively couple to the plug of the charging cable, a rear cover assembly coupled to the housing structure and defining a rear side of the mobile phone, and a front cover assembly coupled to the housing structure and defining a front side of the mobile phone.

The metal segment may be a clad structure including a first portion formed of titanium and at least partially defining an exterior surface of the metal segment and a second portion formed of aluminum and defining at least a portion of an interior surface of the metal segment, and the port structure may be formed of titanium and may be welded to the first portion.

The port structure may define a first portion of the interior wall of the charging port, and the molded polymer structure may define a second portion of the interior wall of the charging port. The molded polymer structure may conductively isolate the connection member from the port structure.

The metal segment may further define a first corner of the mobile phone and a second corner of the mobile phone, and the opening of the charging port may be positioned between the first corner and the second corner. A first portion of the metal segment on a first side of the opening may be configured to operate as a first antenna, and a second portion of the metal segment on a second side of the opening may be configured to operate as a second antenna.

The port structure may define a first outer surface and a second outer surface opposite the first outer surface, the front cover assembly may be adhered to the first outer surface of the port structure, and the rear cover assembly may be adhered to the second outer surface of the port structure.

A portable electronic device may include a display, a front cover over the display and defining a front side of the portable electronic device, a rear cover defining a rear side of the portable electronic device, and a housing structure between and coupled to the front cover and the rear cover. The housing structure may include a housing segment including an exterior portion formed from a first metal and defining an opening of a charging port, the charging port configured to receive a plug of a charging cable therein, an interior portion formed from a second metal different from the first metal, and a port structure extending from the interior portion and formed from the first metal, the port structure defining a wall configured to surround an outer periphery of the plug of the charging cable. The portable electronic device may further include a charging cable connector coupled to the housing structure and including a connection member extending into the charging port and configured to conductively couple to the plug of the charging cable.

The first metal may be titanium and the second metal may be aluminum. The port structure may be welded to a titanium surface of the housing segment.

The portable electronic device may further include a molded polymer structure coupled to the port structure and defining a bottom surface of the charging port and a hole extending through the bottom surface of the charging port, and the charging cable connector extends through the hole through the bottom surface of the charging port. The molded polymer structure may further define a nonconductive portion of an interior surface of the charging port, the nonconductive portion configured to conductively isolate the plug of the charging cable from the wall of the port structure.

The housing segment may define a first antenna radiator, and a second antenna radiator, and the port structure may be positioned between the first antenna radiator and the second antenna radiator. The port structure may be conductively coupled to an electrical ground of the portable electronic device, thereby isolating the first antenna radiator from the second antenna radiator.

A mobile phone may include an optically transmissive front cover, a display below the optically transmissive front cover, and a housing structure coupled to the optically transmissive front cover and including a unitary metal segment. The unitary metal segment may include a first portion defining a first antenna radiator, a second portion defining a second antenna radiator, and a metal port structure positioned between the first portion of the unitary metal segment and the second portion of the unitary metal segment and defining at least a portion of an interior wall of a charging port, the metal port structure coupled to an electrical ground of the mobile phone, thereby isolating the first antenna radiator from the second antenna radiator. The mobile phone may further include wireless communications circuitry conductively coupled to the first portion of the unitary metal segment and the second portion of the unitary metal segment and configured to cause the first antenna radiator to radiate a first wireless signal and cause the second antenna radiator to radiate a second wireless signal.

The first portion of the unitary metal segment may define a first corner of the housing structure, and the second portion of the unitary metal segment may define a second corner of the housing structure. The unitary metal segment may be a clad structure including a titanium portion at least partially defining an exterior surface of the housing structure and an aluminum portion defining at least a portion of an interior surface of the housing structure. The metal port structure may be formed of titanium and may be welded to the titanium portion of the unitary metal segment.

The mobile phone may further include a molded polymer structure coupled to the metal port structure and defining a bottom surface at an end of the interior wall of the charging port. The metal port structure may define a first outer surface and a second outer surface opposite the first outer surface, and the optically transmissive front cover may be adhered to the first outer surface of the metal port structure.

### BRIEF DESCRIPTION OF THE DRAWINGS

The disclosure will be readily understood by the following detailed description in conjunction with the accompanying drawings, wherein like reference numerals designate like structural elements, and in which:

FIGS. 1A-1B depict an example electronic device.

FIGS. 1C-1D depict another example electronic device.

FIGS. 1E-1F depict another example electronic device.

FIG. 2 is an exploded view of an example electronic device.

FIG. 3 is an exploded view of an example electronic device.

FIG. 4 is an exploded view of an example electronic device.

FIG. 5A is a front plan view of an example electronic device.

FIG. 5B is a rear plan view of an example electronic device.

FIG. 5C is a rear perspective view of a portion of an example electronic device.

FIG. 6A is a rear plan view of an example electronic device, illustrating example antenna locations.

FIGS. 6B-6D illustrate example configurations for devices with plateau structures and multi-segment housing structures.

FIGS. 7A-7C are partial exploded views of an example electronic device, illustrating component arrangements with an assembled chassis member.

FIGS. 7D-7E illustrate rear and front views, respectively, of a chassis member.

FIG. 8A illustrates an example thermal spreading module.

FIG. 8B is a partial cross-sectional view of an example thermal spreading module.

FIGS. 8C-8D illustrate additional example thermal spreading modules with different pillar configurations.

FIG. 9A is a partial plan view of an example electronic device.

FIGS. 9B-9C are detail views of an example electronic device showing mounting configurations for a chassis member.

FIG. 9D is a partial cross-sectional view of an example electronic device showing a construction of a chassis member and a housing segment.

FIG. 10A is a partial view of an example electronic device with a circuit board assembly.

FIG. 10B is a partial cross-sectional view of an example electronic device showing the coupling of a battery and circuit board assembly to a chassis member.

FIGS. 11A-11B illustrate components of an example housing in various states of assembly.

FIGS. 12A-12B illustrate components of another example housing in various states of assembly.

FIG. 13A is a top end view of an example electronic device.

FIGS. 13B-13C are perspective views of a portion of an example electronic device illustrating an example antenna module integration.

FIG. 13D is a perspective top end view of a portion of an example electronic device, illustrating a housing structure with an antenna window.

FIGS. 14A-14B are perspective views of an example housing structure, illustrating an electrically isolated mounting feature for a chassis member.

FIG. 15A is a bottom end view of an example electronic device, illustrating example fields of view of optical systems.

FIG. 15B is a partial cross-sectional view of an example electronic device, illustrating a depth sensor module.

FIG. 15C is a partial view of an interior side of a housing of an example electronic device at a depth sensor mounting location.

FIG. 15D is a perspective view of a depth sensor module in an electronic device.

FIG. 16 is a rear perspective view of an example electronic device.

FIG. 17A is a cross-sectional perspective view of an example rear cover of an electronic device.

FIGS. 17B-17C are partial cross-sectional views of an example rear cover of an electronic device.

FIG. 18 illustrates an example mounting tab for attaching a cover to a housing.

FIG. 19 is a rear plan view of a portion of an example electronic device, illustrating example component locations.

FIGS. 20A-20B are partial cross-sectional views of an example electronic device.

FIGS. 21A-21B are perspective views of a portion of a circuit board assembly with an inter-level shielding member.

FIG. 22 is a plan view of an example electronic device, illustrating example antenna locations.

FIGS. 23A-23B illustrate an example assembly process for a housing segment with an integrated port structure.

FIG. 23C illustrates a portion of a housing segment with an integrated port structure.

FIGS. 23D-23E are detail views of a portion of a housing segment with an integrated port structure.

FIG. 24A is a partial cross-sectional view of an example electronic device with an integrated port structure.

FIG. 24B is a perspective cross-sectional view of an example housing segment with an integrated port structure.

FIG. 25 is a schematic illustration of housing segments that are used as antennas.

FIG. 26 is a schematic diagram of an example electronic device.

### DETAILED DESCRIPTION

Reference will now be made in detail to representative embodiments illustrated in the accompanying drawings. It should be understood that the following descriptions are not intended to limit the embodiments to one preferred embodiment. To the contrary, it is intended to cover alternatives, modifications, and equivalents as can be included within the spirit and scope of the described embodiments as defined by the appended claims.

Mobile phones as described herein may include complex, sophisticated components and systems that facilitate a multitude of functions. For example, mobile phones according to the instant disclosure may include touch- and/or force-sensitive displays, numerous cameras (including both front- and rear-facing cameras), global positioning systems (GPS), haptic actuators, wireless charging systems, and all requisite computing components and software to operate these (and other) systems and otherwise provide the functionality of the mobile phones.

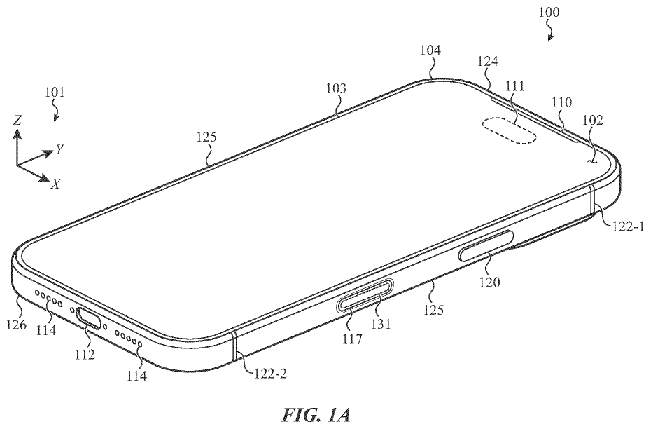

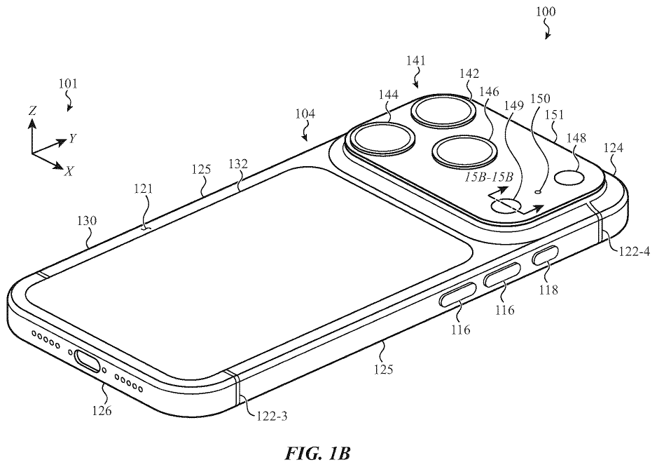

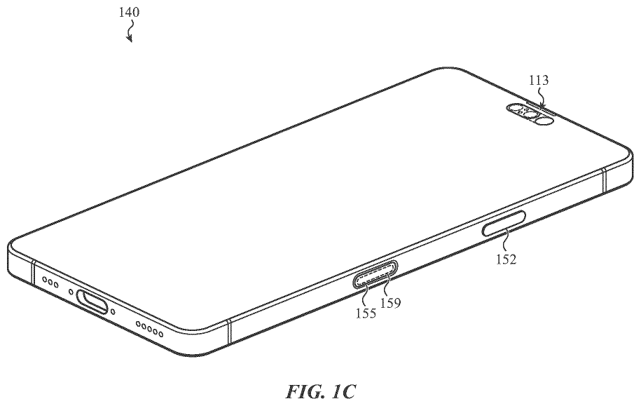

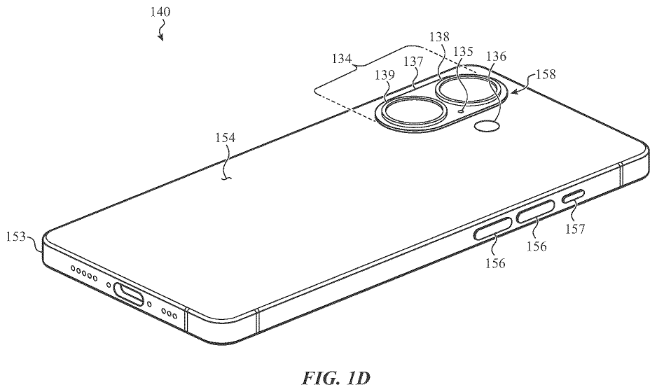

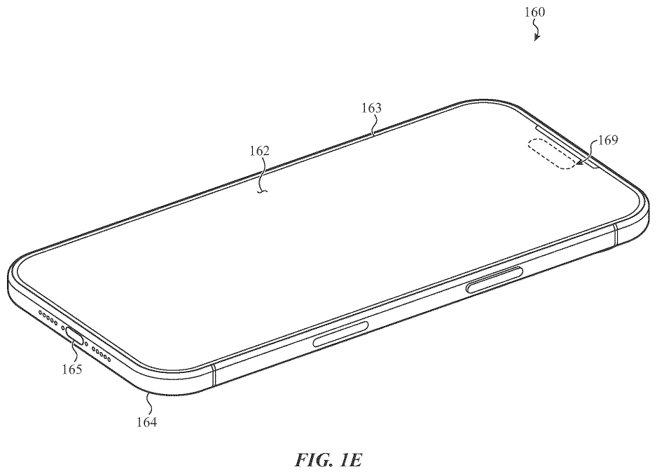

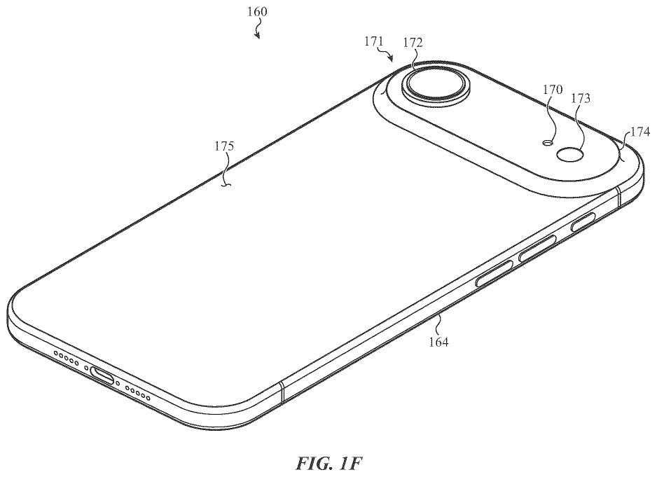

FIGS. 1A and 1B show an example electronic device 100 embodied as a mobile phone. FIG. 1A illustrates a front of the electronic device 100 (or simply device 100), while FIG. 1B illustrates a back side of the device. While the device 100 is a mobile phone, the concepts presented herein may apply to any appropriate electronic device, including portable electronic devices, wearable devices (e.g., watches), laptop computers, handheld gaming devices, tablet computers, computing peripherals (e.g., mice, touchpads, keyboards), or any other device. Accordingly, any reference to an “electronic device” encompasses any and all of the foregoing, and optionally other electronic devices not expressly listed.

As used herein, portable electronic devices generally refer to devices that are designed to be readily carried or worn by a user and to operate without continuous connection to an external power supply. Such devices may incorporate an onboard energy source, such as a rechargeable or replaceable battery, sufficient to support the functionality of the device in mobile or untethered conditions. Portable electronic devices may generally have a compact form factor, integrated housings, and self-contained input/output and control interfaces. Examples of portable electronic devices include, without limitation, mobile phones, tablet computers, laptop computers, head-mounted displays, headphones, earbuds, audio playback and recording devices, wearable computing devices, watches (e.g., smart watches), personal digital assistants, handheld gaming systems, and similar apparatus, it being understood that such examples are illustrative and not limiting.

The electronic device 100 includes a cover 102 (e.g., a front cover) attached to a housing structure 104 (which may be defined by one or more housing components). The cover 102 may be positioned over a display 103. The cover 102 may be a sheet or sheet-like structure formed from or including a transparent or optically transmissive material. The cover 102 may define a front side of the device, and may define a front exterior surface of the device and an interior surface opposite the exterior surface. In some cases, the cover 102 is formed from or includes a glass material and may therefore be referred to as a glass cover member. The glass material may be a silicate-based glass material, an aluminosilicate glass, a boroaluminosilicate glass, an alkali metal aluminosilicate glass (e.g., a lithium aluminosilicate glass), or a chemically strengthened glass. Other example materials for the cover 102 include, without limitation, sapphire, ceramic, glass-ceramic, crystallizable glass materials, or plastic (e.g., polycarbonate). A glass-ceramic material may be a silicate-based glass-ceramic material, such as an aluminosilicate glass-ceramic material or a boroaluminosilicate glass-ceramic material. The glass-ceramic material may be chemically strengthened by ion exchange. The cover 102 may be formed as a monolithic or unitary sheet. The cover 102 may also be formed as a composite of multiple layers of different materials, coatings, and other elements.

The display 103 may be at least partially positioned within the interior volume of the housing structure 104 (or simply housing). The display 103 may be coupled to the cover 102, such as via an adhesive or other coupling scheme. The display 103 may include a liquid-crystal display (LCD), a light-emitting diode (LED) display, an organic light-emitting diode (OLED) display, an active layer organic light-emitting diode (AMOLED) display, an organic electroluminescent (EL) display, an electrophoretic ink display, or the like. The display 103 may be configured to display graphical outputs, such as graphical user interfaces, that the user may view and interact with. Graphical outputs may be displayed in a graphically active region of the display 103 (e.g., an active display region). The active display region may be surrounded or defined by a border region, which may be defined by an opaque mask on the interior surface of the cover 102 (or using other components or techniques). In some cases, the borders are small (e.g., less than about 3 mm, less than about 2 mm, or less than about 1 mm).

The display 103 may also define a primary display region, which may generally correspond to the main front-facing, contiguous display region, in which graphical user interfaces, images, videos, applications, and other graphical outputs may be displayed.

The device 100 may also include an ambient light sensor that can determine properties of the ambient light conditions surrounding the device 100. The device 100 may use information from the ambient light sensor to change, modify, adjust, or otherwise control the display 103 (e.g., by changing a hue, brightness, saturation, or other optical aspect of the display based on information from the ambient light sensor). The ambient light sensor may be positioned below an active area of the display 103 (e.g., below a portion of the display that produces graphical output). The ambient light sensor may transmit and/or receive light through the active area of the display 103 to perform sensing functions.

The display 103 may include or be associated with one or more touch- and/or force-sensing systems. In some cases, components of the touch- and/or force-sensing systems are integrated with the display stack. For example, touch-sensing components such as electrode layers of a touch and/or force sensor may be provided in a stack that includes display components (and is optionally attached to or at least viewable through the cover 102). The touch- and/or force-sensing systems may use any suitable type of sensing technology and touch-sensing components, including capacitive sensors, resistive sensors, surface acoustic wave sensors, piezoelectric sensors, strain gauges, or the like. The outer or exterior surface of the cover 102 may define an input surface (e.g., a touch- and/or force-sensitive input surface) of the device. While both touch- and force-sensing systems may be included, in some cases the device 100 includes a touch-sensing system and does not include a force-sensing system.

The device 100 may also include a front-facing camera. The front-facing camera may be positioned below or otherwise covered and/or protected by the cover 102. The front-facing camera may have any suitable operational parameters. For example, the front-facing camera may include a 24-megapixel sensor (with 1 micron pixel size), and an 80-90° field of view. The sensor may be a square sensor. The front-facing camera may have an aperture number of f/1.9. The front-facing camera may include auto-focus functionality (e.g., one or more lens elements may move relative to an optical sensor to focus an image on the sensor). Other types of cameras may also be used for the front-facing camera, such as a fixed-focus camera.

The front-facing camera (as well as other components, such as an optical facial recognition system) may be positioned in a front-facing sensor region 111. The front-facing sensor region 111 may be positioned in an island-like area of the front of the device 100 and may be surrounded by a display region (e.g., a main or primary display region) of the device 100. In some cases, as described herein, the front-facing sensor region 111 may be positioned in or defined by one or more holes formed through the display 103. In such cases, the front-facing sensor region 111 may be bordered on all sides by active areas or regions of the display 103. Stated another way, the front-facing sensor region 111 may be completely surrounded by active display areas (e.g., an outer periphery of the front-facing sensor region 111 may be surrounded by active areas of the display). In some cases, the front-facing sensor region 111 includes or is defined by one or more masks or other visually opaque component(s) or treatment(s) that define openings for the sensors of the front-facing sensor region 111. The front-facing sensor region 111 may include components such as an infrared illuminator module (which may include a flood illuminator and a dot projector), an infrared image capture device, components of a proximity sensing system, and the front-facing camera. The infrared illuminator module is an example of a light emitter, and the infrared image capture device is an example of an optical receiver.

The proximity sensing system may determine the proximity of an object (e.g., a user's face) to the device 100. The device 100 may use information from the proximity sensing system to change, modify, adjust, or otherwise control the display 103 or other function of the device 100 (e.g., to deactivate the display when the device 100 is held near a user's face during a telephone call). The proximity sensing system may be part of an integrated module that includes components of the proximity sensing system as well as the illuminator module and the infrared image capture device. The proximity sensing system may include an optical emitter and an optical receiver, each of which may be associated with its own light guide. The proximity sensing system may estimate a distance between the device and a separate object or target using lasers and time-of-flight calculations or using other types of proximity sensing components or techniques.

In some cases, the front-facing sensor region 111 is defined by or includes two holes formed through the display 103, such as a first hole to provide optical access for the front facing camera and a second hole to provide access for the infrared illuminator module, the infrared image capture device, and the proximity sensing system. A supplemental display region may be located between the first and second holes. The supplemental display region may provide graphical output and touch- and/or force-sensing functionality to the front-facing sensor region 111. For example, the supplemental display region may be used to display graphical outputs such as lights, shapes, icons, or other elements (e.g., to provide notifications and/or information to the user). In some cases, the supplemental display region may be visually distinguished from other active regions of the display, such that the supplemental display region does not appear to be part of the display. For example, graphical outputs (e.g., graphical user interfaces, images, videos, etc.) displayed on the display 103 may not extend into the supplemental display region. In such cases, the front-facing sensor region 111 may appear visually as a single continuous area of the display, despite the display having two separate holes separated by an active display region or area. The supplemental display region, and optionally the touch-sensing components of the display that surround the front-facing sensor region 111, may also include touch- and/or force-sensing functionality, such that a user can touch the front-facing sensor region 111 to provide an input to the device. In some cases, touch inputs applied anywhere in the front-facing sensor region 111 (e.g., even directly over the optical components) may be detected by the device. These and other features of the front-facing sensor region 111 are described herein.

The device 100 may also include one or more buttons (e.g., buttons 120, 116, 117, and 118), switches, and/or other physical input systems. Such input systems may be used to control power states (e.g., the button 120), control applications, change speaker volume (e.g., the buttons 116), switch between “ring” and “silent” modes (e.g., the button 118), and the like. The buttons 116, 117, 118, and 120 may include strain-sensing systems that detect inputs to the buttons based on a detected strain. The buttons 116, 117, 118, and 120 may also be associated with haptic actuation systems that produce a tactile output in response to a detection of a strain that satisfies a condition. Thus, for example, upon detecting a strain or force that satisfies a condition (and/or an electrical parameter that is indicative of a strain satisfying the condition), a haptic actuation system may impart a force on a button to produce a tactile output (e.g., resembling a “click”). This tactile output or response may provide tactile feedback to the user to indicate that the input has been recognized by the device.

In some cases, one or more of the buttons 116, 117, 118, and 120 may use switch members, such as collapsible dome switches, to detect button presses. Such dome switches may be used in place of (and optionally in addition to) strain-based or other non-binary force-sensing systems. In some cases, however, dome switches or other collapsible or tactile switches may be used in addition to strain-based or non-binary force sensing systems in a given button. In such cases, the button may facilitate the detection of binary or momentary inputs, while also detecting a magnitude of a force being applied to the button. In such cases, the device 100 may perform different operations in response to detecting the binary input and in response to detecting a force that satisfies a condition. More particularly, a user may provide a partial actuation of the button (e.g., a half click or half press), in which a force is applied but the switch is not collapsed. The device 100 may perform one or more operations in response to detecting the partial actuation of the button (e.g., in response to detecting a force that satisfies a condition). A user may subsequently (or instead) provide a complete actuation of the button, in which the force is increased until the switch is actuated or otherwise registers an input (e.g., the dome switch collapses). The device 100 may perform one or more additional or different operations in response to detecting the switch actuation. As one nonlimiting example, the button may be used to provide inputs to the device 100 when the device 100 is operated in an image capture mode. In such cases, a partial actuation may cause the device 100 to initiate a focusing operation, or lock an exposure setting for image capture (or perform other operations or combinations of operations). When the complete actuation is detected (e.g., the binary or momentary switch is actuated), the device 100 may capture an image with one of the onboard cameras. Other functions may also be initiated in response to partial and/or complete actuation of the button, including other image-capture functions, or other device or application functions. For example, a partial actuation may initiate a scrolling operation (e.g., scrolling through items in a displayed list), and a complete actuation may initiate a selection of a selected item in the list. In some cases, a button includes both a dome switch (or other binary or momentary type switch) and a strain-based sensing system. In some cases, one or more other buttons of the device 100 include both a dome switch (or other binary or momentary type switch) and a strain-based sensing system.

In some cases, one or more of the buttons 116, 117, 118, and 120 may use touch-sensing systems, such as capacitive touch-sensing systems, to detect inputs. For example, the button member of a button (e.g., the movable component that a user presses in order to actuate or provide an input to the button) may include a touch-sensing element positioned thereon. A button equipped with a touch-sensing element may detect various types of touch-based inputs, including static touch inputs (e.g., a finger touching the touch-sensitive button surface), dynamic touch inputs (e.g., a finger sliding along the touch-sensitive button surface, also referred to as gesture or swipe inputs), or the like.

In some cases, a button may include a touch-sensing element to detect such touch-based inputs. The device 100 may perform various operations in response to detecting touch-based inputs. Continuing the example above, when the device 100 is being operated in an image capture mode, a static touch input may initiate a focusing or exposure lock operation, while a dynamic or swipe touch input may initiate a zoom operation (e.g., swiping in one direction may initiate a zoom-in operation, and swiping in the opposite direction may initiate a zoom-out operation).

In some cases, the touch-sensing element may detect the location of a touch input on the button during a button actuation, and the device may perform different actions based on the location of the touch. For example, if the button is actuated with a press input at a first location on the button (e.g., at one end of the button, as detected by the touch-sensing element), the device may perform a first action (e.g., a zoom-in operation), and if the button is actuated with a press input at a second location on the button (e.g., at an opposite end of the button, as detected by the touch-sensing element), the device may perform a second action different from the first action (e.g., a zoom-out operation).

In some cases, the touch-sensing element may detect whether an input to the button is applied with a single finger or two fingers, and may perform different operations in response. For example, if the button is actuated with a single finger (as detected by the touch-sensing element), the device may perform a first action (e.g., capture a single image), and if the button is actuated with multiple fingers (as detected by the touch-sensing element), the device may perform a second action different from the first action (e.g., capture a sequence of images for the duration of the actuation, or initiate a video capture operation).

Other sensing techniques may also be used to detect inputs to the buttons. In some cases, a switch or other input device is used in place of one or more of the buttons.

As noted above, one of the buttons may be force- and/or pressure-sensitive (e.g., able to detect variable force inputs) and can produce multiple controls or outputs based on amount of force input, presence of touch, location of touch, movement of touch (gesture). The particular operation that is initiated in response to any given button input may vary in accordance with (e.g., in proportion to) an amount of applied force. In some cases, a force-based input without a detected touch input at the touch-sensing element may suppress an action or be ignored by the device. The button may also be paired with one or more other buttons for designated operations or commands (e.g., the device may perform certain operations in response to detecting simultaneous inputs at multiple buttons or certain sequences of inputs at multiple buttons).

As described in several examples above, a button (e.g., the button 117, 118 or another button) may be operable to initiate or control image capture functions and operations. For example, a light touch of the button (e.g., a sensed touch input without a force, or with a force that satisfies a first force condition corresponding to a slight deflection of the button) may initiate focus and light metering operations, and a larger force or deflection of the button (e.g., satisfying a second force condition) may initiate an image or video capture operation. Additionally, different haptic outputs may be produced in response to detecting different inputs at the button and/or in response to the different operations that are initiated by the button inputs.

Other example image manipulations and/or camera function controls that can be initiated by inputs to the button (force and/or touch inputs) may include: zooming in or zooming out in response to swipe inputs on the button surface in different directions; increasing or decreasing volume output in response to swipe inputs on the button surface in different directions; capturing a single image or a series of multiple images in response to different force inputs (e.g., single image for a light press, multiple images for a harder press). In such cases, different haptic outputs may be produced in response to detecting different inputs at the button and/or in response to the different operations that are initiated by the button inputs.

The button can also cause the device to perform other functions that are either tied to the operation of the device or set in response to operation of a particular application or use mode on the phone. For example, inputs to the button may cause the device to perform operations such as: selecting one or more alert suppression (mute) modes; verifying purchase or application commands; controlling timer commands including watch-related operations; providing input to games such as throttle control or other continuously variable inputs; initiating hard and/or soft reset of the device; initiating user programmable operations; and launching or terminating applications. In some cases, the particular operation of the button may be user programmable or selectable. For example, a user may select what functions or operations are initiated in response to various force inputs, gesture inputs, and touch inputs. The user may also establish different input schemes for different device modes. For example, the user may map force, touch, and gesture inputs to a first set of functions when the device is operating in a first mode (e.g., when a first application is being executed, such as an image capture application), and may map force, touch, and gesture inputs to a second set of functions when the device is operating in a second mode (e.g., when a second application is being executed).

In some cases, the operation of the button may change based on the orientation of the device. For example, if the device is being held in a vertical or “portrait” orientation, the force, touch, and gesture inputs may map to a first set of functions, and if the device is being held in a horizontal or “landscape” orientation, the force, touch, and gesture inputs may map to a second set of functions.

The button may also be used to initiate stereoscopic image or video capture. In some cases, the selection of a stereoscopic image capture mode (or switching between stereoscopic and non-stereoscopic image modes) may be controlled by operation of the button or other device inputs (e.g., other buttons, touch-screen inputs, etc.). In some cases, the ability to select a stereoscopic image mode (or switch between a stereoscopic image mode and other image modes) with the button may be dependent on the orientation of the device.

The device 100 may also include a speaker port 110 to provide audio output to a user, such as to a user's ear during voice calls. The speaker port 110, which is an example of an audio port, may also be referred to as a receiver, receiver port, or an earpiece in the context of a mobile phone. The speaker port 110 may be defined by an opening that is defined, along at least one side, by the housing structure 104, and along at least another side, by the cover 102. In some cases, the cover 102 defines a notch along an edge of the cover, and the notch (also referred to as a recess or cutout) defines at least three sides of the speaker port 110. The speaker port 110 may lack a mesh or other covering that is flush with the front surface of the cover 102. In some cases, a protective grill or grate is positioned within the device 100 and in an audio path between a speaker and the speaker port 110 to inhibit ingress of debris into the device 100. The protective grill or grate may be recessed relative to the front surface or front face of the cover 102.

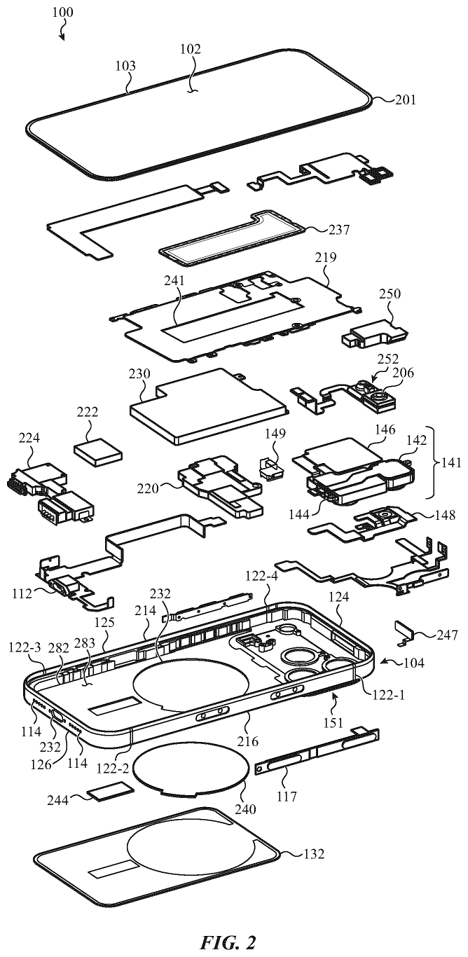

The device 100 may also include a charging port 112 (e.g., for receiving a connector of a charging cable or power cable for providing power to the device 100 and charging the battery of the device 100). The charging port 112 may be aligned with an opening 232 (FIG. 2) in the housing structure 104, and may receive a connector of any suitable design. In some cases, the charging port 112 receives a connector corresponding to a universal serial bus (USB) connector type, such as a USB-C connector. The charging port 112 may also be configured to send and/or receive data via a cable, such as with a USB or other communication protocol.

The device 100 may also include audio openings 114 (e.g., ports). The audio openings 114 may allow sound output from an internal speaker system (e.g., the speaker system 224, FIG. 2) to exit the housing structure 104. The device 100 may also include one or more microphones. In some cases, a microphone within the housing structure 104 may be acoustically coupled to the surrounding environment through an audio opening 114.

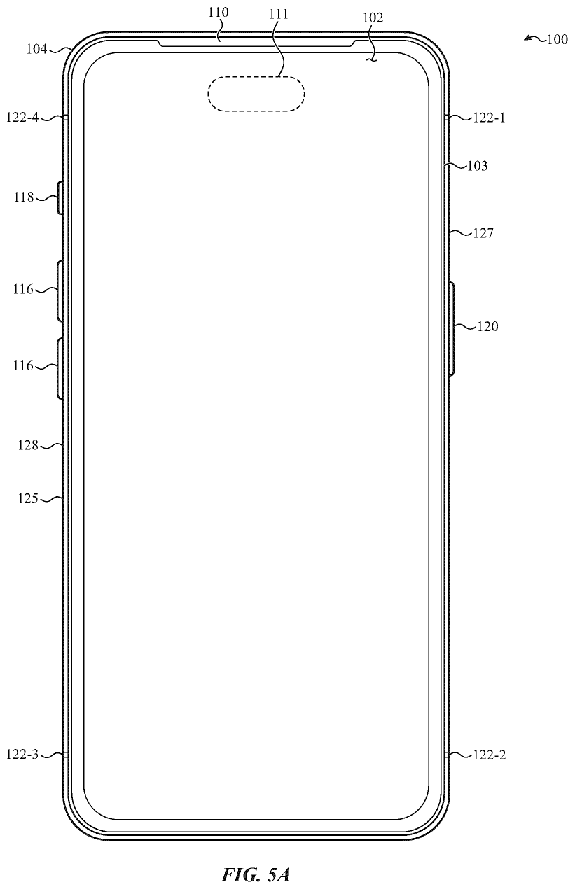

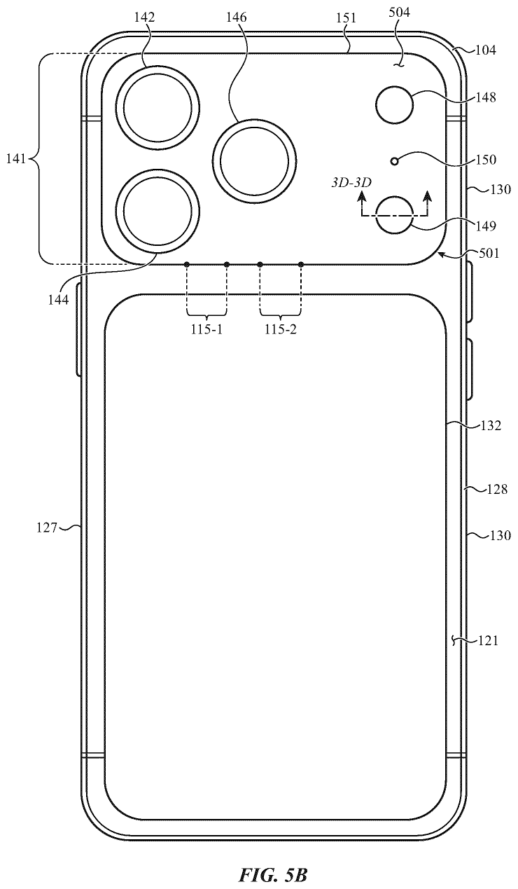

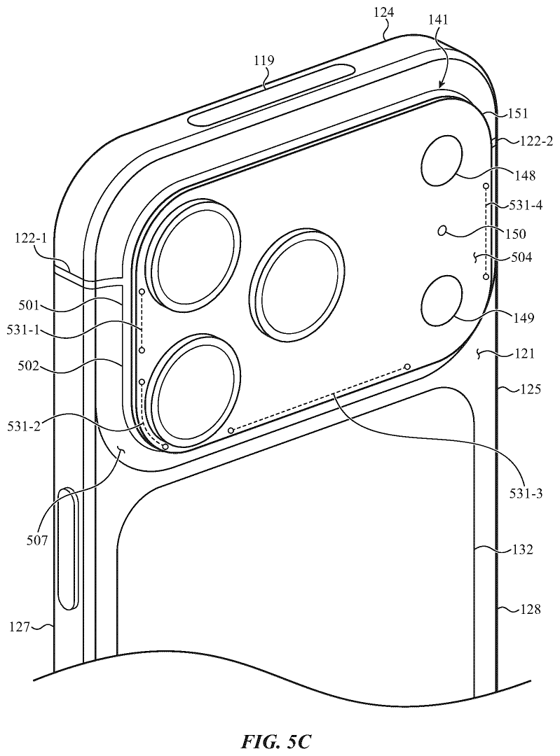

The housing structure 104 may be a multi-piece housing. For example, the housing structure 104 may be formed from multiple housing components 124, 125, 126 (which may be and/or may include metal segments), which are structurally coupled together via one or more intermediate elements, such as joint structures 122 (e.g., 122-1-122-4). Together, the housing components 124, 125, 126 and the joint structures 122 may define a band-like housing structure that defines four side walls (and thus four exterior side surfaces) of the device 100. The four walls may include a top wall (e.g., proximate the front-facing sensor region 111), a bottom wall opposite the top wall, a first lateral side wall 127 (FIG. 5A), and a second lateral side wall 128 (FIG. 5A) opposite the first side wall. Thus, both the housing components and the joint structures define portions of the exterior side surfaces of the device 100.

The housing components 124, 125, 126 may be formed of a conductive material (e.g., a metal), and the joint structures 122 may be formed of one or more polymer materials (e.g., glass-reinforced polymer). The joint structures 122 may include two or more molded elements, which may be formed of different materials. For example, an inner molded element may be formed of a first material (e.g., a polymer material), and an outer molded element may be formed of a second material that is different from the first (e.g., a different polymer material). The materials may have different properties, which may be selected based on the different functions of the inner and outer molded elements. For example, the inner molded element may be configured to make the main structural connection between housing components, and may have a higher mechanical strength and/or toughness than the outer molded element. On the other hand, the outer molded element may be configured to have a particular appearance, surface finish, chemical resistance, water-sealing function, or the like, and its composition may be selected to prioritize those functions over mechanical strength. The joint structures 122 may be mechanically interlocked with the housing components to structurally couple the housing components and form a structural housing assembly.

The housing components 124, 125, 126 may be formed from a metal (e.g., aluminum, steel, stainless steel, titanium, etc.), a polymer material, a composite material, or the like. In some cases, the housing components 124, 125, 126 may be formed from a clad structure that includes multiple materials. For example, the housing components may include a core portion formed from a first metal and a cladding portion formed from a second metal. The cladding portion may define exterior surfaces of the housing components. The exterior surface defined by the cladding portion may have a surface texture that produces a certain visual appearance and/or tactile feel. For example, the surface may have a texture that produces diffuse reflections. The surface texture may be produced by grinding, lapping, machining, ablation, blasting (e.g., sand blasting, bead blasting), etching (via mechanical etching, laser etching, chemical etching), or any other suitable texturing operation(s). The exterior surface of the housing components may also include a coating, such as a deposited coating. In some cases, the cladding portion is polished. A deposited coating may be deposited on the housing components via plasma vapor deposition (PVD), chemical vapor deposition (CVD), or the like.

In the case of a clad structure, the core portions of the housing components may be aluminum (e.g., an aluminum alloy), and the cladding portions may be titanium (e.g., a titanium alloy). Other metals may be used instead of aluminum and titanium for the core and cladding portions, such as an aluminum core with a stainless-steel cladding, or a nickel core with a titanium cladding, or a steel core with stainless steel cladding. Other metals and combinations of metals are also contemplated. In some cases, the core portions of the housing components are aluminum, and the cladding portions are stainless steel. The cladding portions may have an average thickness of between about 0.1 mm and about 1.0 mm. The aluminum of the housing may include recycled aluminum (e.g., up to 70% recycled aluminum, up to 85% recycled aluminum, or another value).

As used herein, unless otherwise specified, a reference to a metal (e.g., aluminum, titanium) includes both pure metals as well as metal alloys. Thus, for example, a component that is formed from aluminum may be formed from pure aluminum, 6061 aluminum alloy, 7071 aluminum alloy, or another aluminum alloy. Similarly, a component that is formed from titanium may be formed from pure titanium, Ti-6Al-4V titanium alloy, Ti-5Al-2.5Sn titanium alloy, or another titanium alloy. References to steel may include various types and/or alloys of steel, including but not limited to low carbon steel, stainless steel, high carbon steel, etc.

In some cases, one or more of the housing components 124, 125, 126 (or portions thereof) are configured to operate as antennas (e.g., components that are configured to transmit and/or receive electromagnetic waves to facilitate wireless communications with other computers and/or devices). To facilitate the use of the housing components as antennas, feed and ground lines may be conductively coupled to the housing components to couple the housing components to other antennas and/or communication circuitry. The joint structures 122 may be substantially non-conductive to provide suitable separation and/or electrical isolation between the housing components (which may be used to tune the radiating portions, reduce capacitive coupling between radiating portions and other structures, and the like). The joint structures 122 may be generally positioned in gaps between conductive (e.g., metal) housing segments. For example, as described herein, the housing structure 104 may include housing components 124, 125, and 126. The first housing component 124 may be set apart from the second housing component 125 by a first gap, and the third housing component 126 may be set apart from the second housing component 125 by a second gap. Joint structures 122 (which may be one contiguous joint structure or multiple noncontiguous joint structures) may be positioned in both gaps, as well as in other gaps of the housing structure (e.g., the gap formed around a protrusion 151, as described herein). For example, joint structures 122-1, 122-4 may be positioned in a first gap between the first housing component 124 and the second housing component 124, and joint structures 122-2, 122-3 may be positioned in a second gap between the third housing component 126 and the second housing component 125.

In some cases, supplemental antenna segments are conductively coupled to the housing components to change an antenna performance parameter of the housing component. Supplemental antenna segments may be coupled to the housing components via switching circuitry that allows the supplemental antenna segments to be selectively coupled or decoupled from the housing components.

The device 100 may include various internal antenna elements that are configured to transmit and receive wireless communication signals through various regions of the device 100. For example, internal antenna elements may be configured to transmit and receive wireless communication signals through the front cover 102, a back or rear cover 132 (FIG. 1B), or optionally through radio-frequency transmissive windows formed through housing components.

The exterior surfaces of the housing components 124, 125, 126 may have substantially a same color, surface texture, and overall appearance as the exterior surfaces of the joint structures 122. In some cases, the exterior surfaces of the housing components 124, 125, 126 and the exterior surfaces of the joint structures 122 are subjected to at least one common finishing procedure, such as abrasive-blasting, machining, polishing, grinding, or the like. Accordingly, the exterior surfaces of the housing components and the joint structures may have a same or similar surface finish (e.g., surface texture, roughness, pattern, etc.). In some cases, the exterior surfaces of the housing components and the joint structures may be subjected to a two-stage blasting process to produce the target surface finish.

FIG. 1B illustrates a back side of the device 100. The back of the device 100 may be formed from or include multiple different components. In particular, the back of the device 100 may include multiple different components that together form the back portion of the overall device enclosure, which provide structural attachment points for numerous components, and that provide communications functionality. For example, as noted above, the device 100 includes a housing component 125. The housing component 125 may define a portion of each of the lateral side walls 127, 128, and a rear frame 130 of the device. The rear frame 130 may define a first portion of the rear exterior surface of the device 100.

The housing component 125, including the side walls 127, 128, and the rear frame 130, may be formed from a single unitary piece of material, such as metal (e.g., a unitary structure formed by machining the housing component 125 from a single billet or extrusion). In other examples, the housing component may be formed by coupling multiple components together. For example, the side walls 127, 128 may be welded to the rear frame 130. In such cases, the side walls 127, 128 and the rear frame 130 may be formed from the same metal material, such as aluminum, titanium, stainless steel, or the like. In some cases, the sidewalls and/or the rear frame may be formed from a clad structure that includes multiple materials. In such cases, the exterior surfaces of the side walls 127, 128 and the rear frame 130 may be formed of the same material (e.g., the same metal). In some cases, the housing components may be formed from materials other than metal, such as polymers (e.g., reinforced polymers), composites, or the like (including combinations of different types of materials, such as polymer and metal).

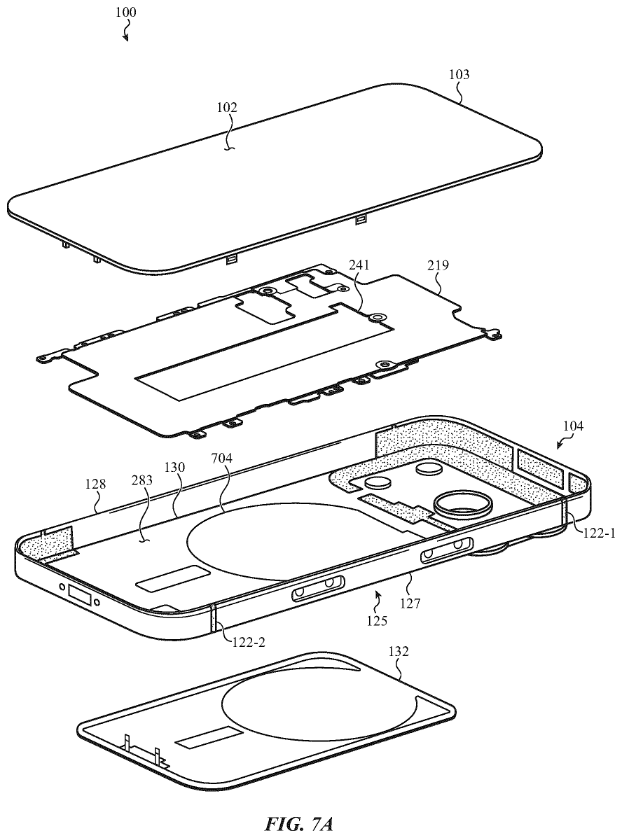

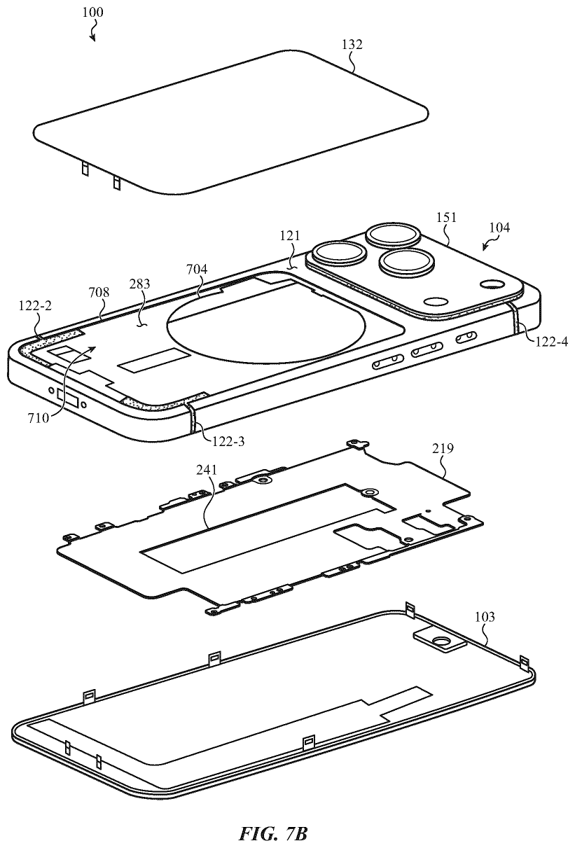

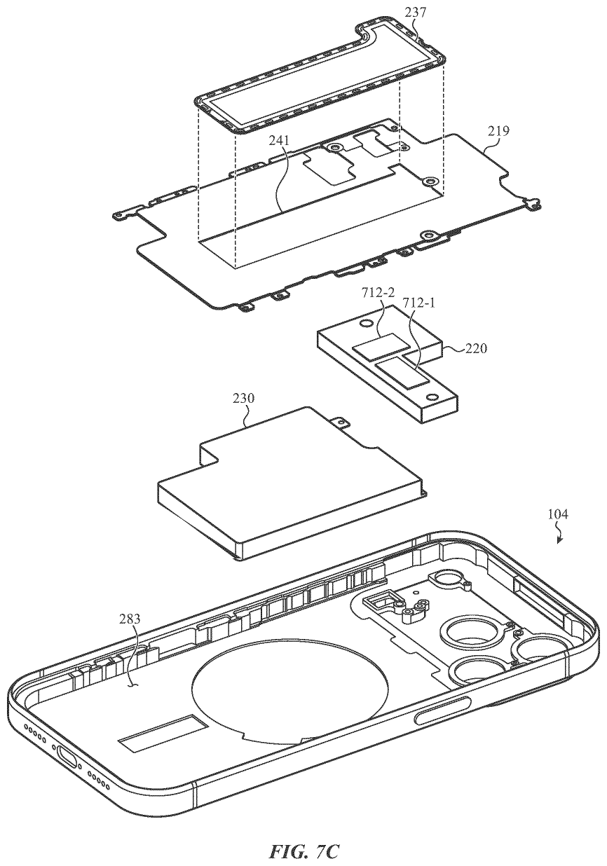

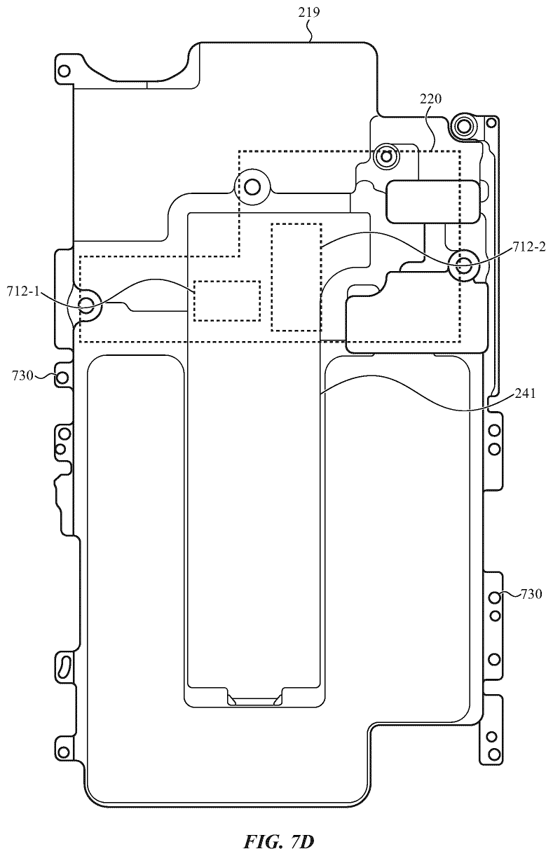

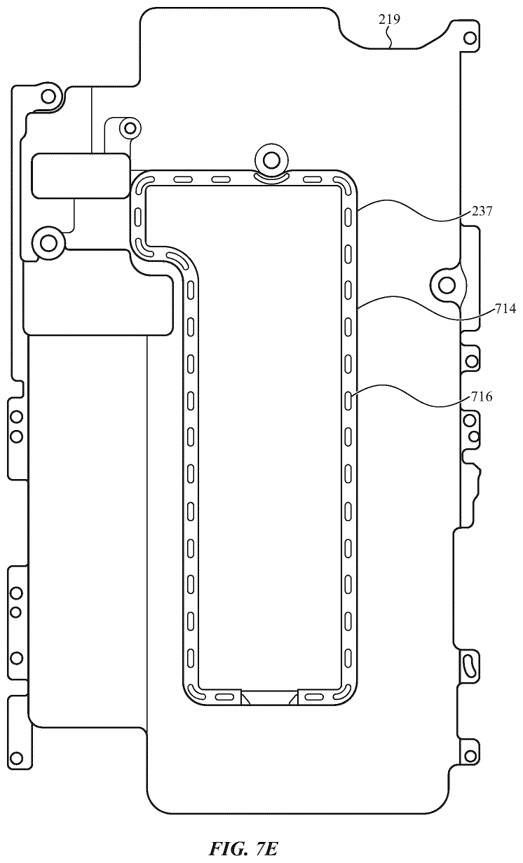

The housing structure, which may be defined at least in part by the housing components 124, 125, 126 and the joint structures 122, may define a protrusion 151 that defines a rear-facing sensor array 141. The protrusion 151 may have a metal surface defining a first portion of a rear exterior surface of the device 100. The housing structure may also define a bezel portion 121 defining at least a portion of an opening 708 (FIGS. 7A-7B) in the housing structure. The opening 708 may be positioned along a side of the protrusion 151, such as along a bottom side of the protrusion 151. The bezel portion 121 may extend at least partially around the opening 708, and may define a portion of the rear exterior surface of the device 100. As shown and described with respect to FIGS. 7A-7B, the opening 708 may at least partially define a recess 710 that is defined by the housing structure. The recess 710 may be defined at least in part by the opening 708 and a rear panel 283 (FIG. 2), and may receive a back or rear cover, as described herein. For example, the rear panel 283 may define a bottom surface of the recess 710.

As shown in FIGS. 1B and 7B, the opening 708 may be defined at least in part by the housing component 125 and by the housing component 126. Stated another way, the housing component 125 may define a first portion of the opening, and the housing component 126 may define a second portion of the opening.

The device 100 may also include a back or rear cover 132 coupled to the housing structure 104. For example, the rear cover 132 may be positioned at least partially in the opening 708 in the housing structure, and may define a second portion of the rear exterior surface of the device 100. The second portion of the rear exterior surface that is defined by the rear cover 132 may be substantially flush with a surface of the bezel portion 121 of the housing structure. For example, a thickness of the rear cover 132 may be equal to or less than the depth of the recess 710, such that the exterior surface of the rear cover 132 (with optional adhesive or other layers between the rear cover 132 and the bottom surface of the recess 710) is substantially flush with a surface of the bezel portion 121.

The rear cover 132 may be formed from or include a transparent or optically transmissive material. For example, the rear cover 132 may include a substrate formed of a glass material. The glass material may be a silicate-based material (e.g., a silicate-based glass material), an aluminosilicate glass, a boroaluminosilicate glass, an alkali metal aluminosilicate glass (e.g., a lithium aluminosilicate glass), or a chemically strengthened glass. Other example materials for the rear cover 132 include, without limitation, sapphire, ceramic, glass-ceramic, crystallizable glass materials, and plastic (e.g., polycarbonate). A glass-ceramic material may be a silicate-based glass-ceramic material, such as an aluminosilicate glass-ceramic material or a boroaluminosilicate glass-ceramic material. The glass-ceramic material may be chemically strengthened by ion exchange.

The device 100 may include a wireless charging system, whereby the device 100 can be powered and/or its battery recharged by an inductive (or other electromagnetic) coupling between a charger (e.g., a wireless charging accessory) and a wireless charging system within the device 100. In such cases, the rear cover 132 may be formed of a material that allows and/or facilitates the wireless coupling between the charger and the wireless charging system. More particularly, as shown in FIGS. 7A-7B, the housing component 125 may define a hole 704 through the rear frame 130, and a wireless charging coil may be positioned within or otherwise aligned with the hole 704. The rear cover 132 covers (and conceals) the hole 704 and the wireless charging coil, while also allowing the wireless charging coil to electromagnetically (or otherwise wirelessly) couple to a complementary charging coil external to the device 100. In some cases, other antennas and/or wireless communication systems may also be aligned with the hole 704 and may communicate through the rear cover 132. To facilitate wireless charging and, optionally, communications functions, the rear cover 132 may be formed from a dielectric material, a radio-frequency transmissive material, or otherwise configured to allow electromagnetic coupling therethrough (e.g., glass, sapphire, polymer, glass-ceramic, etc.).

As shown in FIGS. 2 and 7A-7B, the rear frame 130 may define the rear panel 283, and the hole 704 may be defined through the rear panel 283. The rear cover 132 may be coupled to the rear panel 283 (e.g., an exterior-facing surface of the rear panel 283). In some cases, the rear cover 132 is adhered to the rear panel 283. The rear panel 283 may also serve as a mounting structure or substrate for other components of the device (e.g., within the enclosure, opposite the rear cover 132). Further, the frame 130 may define a recess or pocket in which the rear cover 132 is received.

The rear cover 132 may be formed as a monolithic or unitary sheet. The rear cover 132 may also be formed as a composite of multiple layers of different materials, coatings, and other elements. The rear cover 132 may include one or more decorative layers on the exterior or interior surface of the substrate. For example, one or more coating layers may be applied to the interior surface of the substrate (or otherwise positioned along the interior surface of the substrate) to provide a particular appearance to the back side of the device 100. The coating layer(s) may include a sheet, ink, dye, or combinations of these (or other) layers, materials, or the like. In some cases, one or more of the coating layers have a color that substantially matches a color of the housing structure 104 (e.g., the exterior surfaces of the housing components and the joint structures). In some cases, the material of the substrate of the rear cover 132 may be colored, and may include one or more coatings that contribute to the colored appearance of the rear cover. Moreover, the rear cover 132 may be formed from or may include a dielectric material (e.g., the rear cover 132 may be a dielectric member, such as a glass member, sapphire member, polymer member, glass-ceramic member, etc.).

The device 100 may also include a sensor array 141 (e.g., a rear-facing sensor array in a rear-facing sensor array region) that includes a camera array, which may include three cameras 142, 144, 146. The sensor array 141 may be in a sensor array region that is defined by the protrusion 151 along a rear or back side of the device 100. The protrusion 151 may define a portion of the rear exterior surface of the device 100, and may at least partially define a raised sensor array region of the sensor array 141.

A first camera 142 (of the camera array) may include a 48-megapixel sensor and a telephoto lens with a 3× optical zoom and an aperture number of f/2.8. In some cases, the first camera 142 has a telephoto lens with a 5× optical zoom (and optionally an 8× digital zoom). A second camera 144 (of the camera array) may include a 48.8-megapixel sensor (optionally with a three-layer sensor arrangement) with sensor-shift image stabilization and a wide-angle lens having an aperture number of f/1.7. A third camera 146 (of the camera array) may include a 48-megapixel sensor and a super-wide camera with a wide field of view (FOV) (e.g., 120° FOV) and an aperture number of f/2.2. One or more of the cameras of the sensor array 141 may also include lens-based optical image stabilization, whereby the lens is dynamically moved relative to a fixed structure within the device 100 to reduce the effects of “camera shake” or other movements on images captured by the camera, and/or sensor-based image stabilization, whereby the image sensor is moved relative to a fixed lens or optical assembly. One or more of the cameras may include autofocus functionality, in which one or more lens elements (and/or sensors) are movable to focus an image on a sensor.

The first camera 142 may include an image sensor with a pixel size between about 0.8 microns and about 1.4 microns. The second camera 144 may include an image sensor with a pixel size between about 1.6 microns and about 2.3 microns. The third camera 146 may include an image sensor with a pixel size between about 0.8 microns and about 1.4 microns.

The first and second cameras 142, 144 may be oriented along the y-direction of the device (e.g., centered along a line that extends in the y-direction). Axes 101 (FIGS. 1A, 1B) illustrate exemplary device directions (e.g., x-direction, y-direction, and z-direction). It will be understood that the same relative directions may apply to other devices shown and described herein. The alignment of the first camera 142 and the second camera 144 along the y-direction may facilitate the capture of stereoscopic images and/or video, such as three-dimensional images and/or video. For example, the alignment of the cameras along the y-direction positions the cameras horizontally when the device 100 is held in a landscape or horizontal orientation during image capture. In such cases, the horizontal alignment of the cameras 142, 144 facilitates the capture of three-dimensional or stereoscopic images or video. Such images or video may be displayable in a head mounted display or via other three-dimensional display technologies. In the case of a head mounted display, images and/or video captured using the stereoscopic functionality of the cameras 142, 144 may be displayed as three-dimensional media. In some cases, the cameras 142, 144 may be used to capture three-dimensional scans of objects, and the device 100 may generate three-dimensional virtual models of the objects for display using a head-mounted display or other visualization technique. As used herein, the term stereoscopic may refer to a mode or operation of the device in which two or more cameras are used concurrently or simultaneously to capture an image or video.

The housing structure may include holes formed through the protrusion 151 in the rear-facing sensor array 141. The cameras 142, 144, 146 may include respective camera modules (e.g., rear-facing camera modules) that are positioned at least partially in respective holes formed through the protrusion 151. Additionally, a depth sensor module 149 (which may be a depth sensor system or part of a depth sensor system) may be positioned at least partially in another hole formed through the protrusion 151 in the rear-facing sensor array 141, and a flash module 148 (which may be or may be a part of the flash 148) may be positioned at least partially in another hole formed through the protrusion 151 in the rear-facing sensor array 141.

The sensor array 141, along with associated processors and software, may provide several image-capture features. For example, the sensor array 141 may be configured to capture full-resolution video clips of a certain duration each time a user captures a still image. As used herein, capturing full-resolution images (e.g., video images or still images) may refer to capturing images using all or substantially all of the pixels of an image sensor, or otherwise capturing images using the maximum resolution of the camera (regardless of whether the maximum resolution is limited by the hardware or software).

The captured video clips may be associated with the still image. In some cases, users may be able to select individual frames from the video clip as the representative still image associated with the video clip. In this way, when the user takes a snapshot of a scene, the camera will actually record a short video clip (e.g., 1 second, 2 seconds, or the like), and the user can select the exact frame from the video to use as the captured still image (in addition to simply viewing the video clip as a video).

The cameras of the sensor array 141 may also have or provide a high-dynamic-range (HDR) mode, in which the camera captures images having a dynamic range of luminosity that is greater than what is captured when the camera is not in the HDR mode. In some cases, the sensor array 141 automatically determines whether to capture images in an HDR or non-HDR mode. Such determinations may be based on various factors, such as the ambient light of the scene, detected ranges of luminosity, tone, or other optical parameters in the scene, or the like. HDR images may be produced by capturing multiple images, each using different exposure or other image-capture parameters, and producing a composite image from the multiple captured images.

The cameras of the sensor array 141 may also include software-based color balance correction. For example, when a flash (e.g., the flash 148) is used during image capture, the cameras (and/or associated processing functionality of the device 100) may adjust the image to compensate for differences in color temperature between the flash output and the ambient lighting in the image. Thus, for example, if a background of an image has a different color temperature than a foreground subject (e.g., because the foreground subject is illuminated by the flash output), the cameras may modify the background and/or the foreground of the image to produce a more consistent color temperature across the image.

The sensor array 141 may also include or be configured to operate in an object detection mode, in which a user can select (and/or the device 100 can automatically identify) objects within a scene to facilitate those objects being processed, displayed, or captured differently than other parts of the scene. For example, a user may select (or the device 100 may automatically identify) a person's face in a scene, and the device 100 may focus on the person's face while selectively blurring the portions of the scene other than the person's face. Notably, features such as the HDR mode and the object detection mode may be provided with a single camera (e.g., a single lens and sensor).

The sensor array 141 may also include a depth sensing system (e.g., the depth sensor module 149) that is configured to estimate a distance between the device and a separate object or target. The depth sensing system may estimate a distance between the device and a separate object or target using lasers and time-of-flight calculations, or using other types of depth sensing components or techniques. The depth sensing system may be used in conjunction with one or more cameras of the device 100 in order to facilitate functions such as autofocus, depth mapping of captured images (still and/or video), image processing, and the like.

The rear-facing depth sensor module 149 and the rear-facing cameras may be coupled to a device housing, such as the housing structure 104. In some cases, the housing may define respective holes for the depth sensor module 149 and the cameras, and the lens assemblies of the cameras and the depth sensor module 149 may be aligned with the respective holes (and optionally extend into the holes). In some cases, as shown in the example device 100, the holes may be formed through the housing structure 104 in the raised sensor array region of the device 100 (e.g., the protrusion 151 that defines the raised sensor array region of the device 100).

In some cases, the depth sensor module 149 (and its components, such as an image capture lens assembly and a projector lens assembly) is aimed at an angle (e.g., non-perpendicular to the rear exterior surface of the device) in order to achieve a target overlap between the field of view of the cameras and the illumination pattern (and generally the field of view) of the depth sensing system. For example, the depth sensor module 149 (and its lens assemblies) may be angled towards the cameras (e.g., towards the camera 142, or towards any one of the cameras individually or towards the grouping of cameras collectively) by between about 1 and about 5 degrees, such as about 1 degree, about 2 degrees, about 3 degrees, about 4 degrees, or about 5 degrees. This alignment angle results in a greater coincidence and/or overlap of the fields of view of the camera(s) and the depth sensing system (or otherwise causes the fields of view to overlap at a target distance from the device), and may result in improved imaging performance. For example, by angling the depth sensor module 149, the accuracy of autofocus functions of the camera may be improved (e.g., relative to a parallel alignment of the depth sensor module 149 and the cameras). As another example, angling the depth sensor module 149 may result in greater accuracy of depth maps generated by the depth sensing system (e.g., relative to a parallel alignment of the depth sensor module 149 and the cameras). Depth maps may allow users to selectively change parameters of an image based on depth values of the objects in the image. For example, a user may wish to blur or otherwise graphically distinguish a first portion of an image from a second portion of the image (e.g., to blur a background while leaving a foreground subject in focus). Information from the depth map may be used to distinguish elements in the image based on their distance from the camera (e.g., to distinguish foreground elements from background elements). Such image adjustments may also be performed automatically by the device 100. The depth sensing system may also provide spatial information (e.g., the depth map) that facilitates three-dimensional or spatial image capture (e.g., still and/or video images). For example, information from the depth sensing system may be used in conjunction with images from one or more cameras to produce three-dimensional or spatial images. Such images may be viewed using a three-dimensional display system, such as a head-mounted display with three-dimensional viewing capabilities.

The device 100 may also include a flash 148 (e.g., a rear-facing flash) that is configured to illuminate a scene to facilitate capturing images with the cameras of the sensor array 141 (e.g., to illuminate a subject during an image capture operation). The flash 148 may include one or more light sources, such as one or more light-emitting diodes (e.g., 1, 2, 3, 4, or more LEDs). In some cases, the light source(s) may be illuminable in multiple different illumination patterns, which, along with a lens positioned over the light source(s), can produce different fields of illumination on a subject or scene. For example, a light source may be segmented into a plurality of illuminable regions, with the illuminable regions positioned under different regions of the lens. When a first illumination pattern is active (e.g., one or more central illuminable regions), the emitted light may pass through a first region of the lens (e.g., a central region) and produce a first field of illumination on a subject or scene (e.g., a relatively narrow light distribution corresponding to a field of view of a telephoto lens). When a second illumination pattern is active (e.g., one or more peripheral illuminable regions), the emitted light may pass through a second region of the lens (e.g., a peripheral region) and produce a second field of illumination on a subject or scene (e.g., a relatively wider light distribution corresponding to a field of view of a wide angle lens). The flash 148 may be configured to produce two, three, or more different fields of illumination, each corresponding to a field of view of one of the cameras of the sensor array 141. Thus, for example, the flash 148 may produce a first field of illumination that corresponds to (e.g., is substantially equal to or greater than) a field of view of the first camera 142, a second field of illumination that corresponds to (e.g., is substantially equal to or greater than) a field of view of the second camera 144, and a third field of illumination that corresponds to (e.g., is substantially equal to or greater than) a field of view of the third camera 146.

The sensor array 141 may also include a microphone 150. The microphone 150 may be acoustically coupled to the exterior environment through a hole defined in the rear cover of the device 100 (e.g., through the portion of the rear cover that defines the protrusion 151).

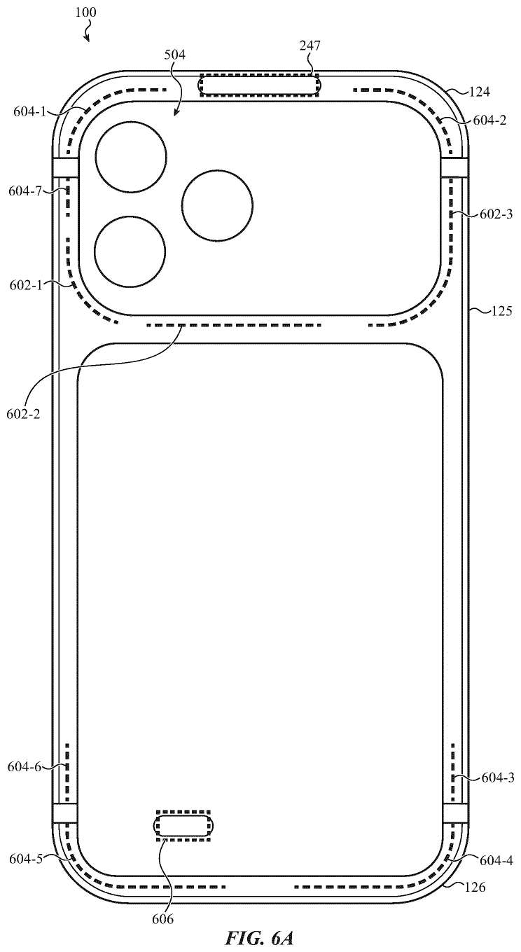

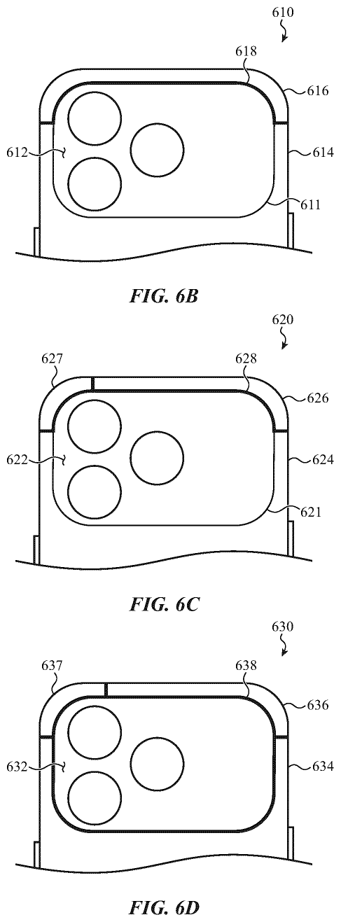

The protrusion 151 may serve multiple functions for the device 100. For example, as described above, the protrusion 151 may define a raised sensor array region of the device 100 that includes multiple audio and optical systems. Additionally, the protrusion 151 and the rear frame 130 may define multiple wireless communication antennas for the device 100, as described herein with respect to FIGS. 5B-6D.

FIGS. 1C and 1D show another example electronic device 140 embodied as a mobile phone. The electronic device 140 may have many of the same or similar outward-facing components as the electronic device 100. Accordingly, descriptions and details of such components from FIGS. 1A-1B (e.g., displays, buttons, switches, housings, covers, charging ports, joint structures, etc.) apply equally to the corresponding components shown in FIGS. 1C and 1D.

The device 140 may include a front-facing sensor region 113, which may generally correspond to the front-facing sensor region 111 in FIG. 1A. The front-facing sensor region 113 may be positioned in an island-like area of the front of the device 140, and may be surrounded by a display region (e.g., a main display region) of the device 140. In some cases, as described herein, the front-facing sensor region 113 may be positioned in or defined by one or more holes formed through a display. In such cases, the front-facing sensor region 113 may be bordered on all sides by active areas or regions of the display. Stated another way, the front-facing sensor region 113 may be completely surrounded by active display areas (e.g., an outer periphery of the front-facing sensor region 113 may be surrounded by active areas of the display). In some cases, the front-facing sensor region 113 includes or is defined by one or more masks or other visually opaque component(s) or treatment(s) that define openings for the sensors of the front-facing sensor region 113. The front-facing sensor region 113 may include components such as an infrared illuminator module (which may include a flood illuminator and a dot projector), an infrared image capture device, components of a proximity sensing system, and a front-facing camera.

While the device 100 in FIG. 1B is shown as including a rear-facing sensor array 141 with three cameras, the device 140 as shown in FIG. 1D includes a sensor array 134 (e.g., a rear-facing sensor array in a rear-facing sensor array region) that includes two cameras 138, 139. The sensor array 134 may be in a sensor array region that is defined by a protrusion 137 in a rear cover of the device 140. The protrusion 137 may define a raised sensor array region 158. Thus, the rear cover of the device may define a first portion of a rear exterior surface of the device 140, and the protrusion 137 defines a second portion of the rear exterior surface of the device (which is raised or protrudes relative to the first portion of the rear exterior surface). The protrusion 137 may be generally pill-shaped, and may accommodate the two cameras along the y-direction of the device 140. The two cameras may be oriented along the y-direction.

The alignment of the two cameras 138, 139 along the y-direction (e.g., centered on a line that extends along the y-direction) may facilitate the capture of stereoscopic images and/or video, such as three-dimensional images and/or video. For example, the alignment of the cameras along the y-direction positions the cameras horizontally when the device 140 is held in a landscape or horizontal orientation during image capture. In such cases, the horizontal alignment of the cameras 138, 139 facilitates the capture of three-dimensional or stereoscopic images or video. Such images or video may be displayable in a head mounted display or via other three-dimensional display technologies. In the case of a head mounted display, images and/or video captured using the stereoscopic functionality of the cameras 138, 139 may be displayed as three-dimensional media. In some cases, the cameras 138, 139 may be used to capture three-dimensional scans of objects, and the device 140 may generate three-dimensional virtual models of the objects for display using a head-mounted display or other visualization techniques.

The device 140 may also include, as part of the sensor array 134, one or more rear-facing devices, which may include an ambient light sensor (ALS), a microphone port 135, and/or a depth sensing system that is configured to estimate a distance between the device 140 and a separate object or target.

The sensor array 134 may also include multiple cameras, such as a first camera 138 and a second camera 139. Therefore, the sensor array 134 may include a camera array (which may include one or more cameras). The first camera 138 may include a super-wide camera having a 48-megapixel sensor and a wide field of view (e.g., 120° FOV) optical stack with an aperture number of f/2.2. The second camera 139 may include a wide view camera having a 48.8-megapixel sensor and an aperture number of f/1.6. In some cases, the sensor array 134 may include a telephoto lens having a 12-megapixel sensor with a 3× optical zoom having an aperture number ranging from f/2.0 to f/2.8 (e.g., in addition to the first and second cameras 138, 139, or in place of one of the first or second cameras). As noted above, the cameras (or the camera lenses) may be arranged along the y-direction of the device and positioned or set in the protrusion 137.

One or more of the cameras (e.g., cameras 138, 139) of the sensor array 134 may also include optical image stabilization, whereby the lens is dynamically moved relative to a fixed structure within the device 140 to reduce the effects of “camera shake” on images captured by the camera. The camera(s) may also perform optical image stabilization by moving the image sensor relative to a fixed lens or optical assembly. One or more of the cameras may include autofocus functionality, in which one or more lens elements (and/or sensors) are movable to focus an image on a sensor.

The second camera 139 may have an image sensor with a pixel size between about 1.5 microns and about 2.0 microns, and the first camera 138 may have an image sensor with a pixel size between about 0.8 microns and about 1.4 microns. If a camera with a telephoto lens is provided, it may have an image sensor with a pixel size between about 0.8 microns and about 1.4 microns.

The sensor array 134 may also include a flash 136 (e.g., a rear-facing flash). The flash 136 may include a multi-segment LED, or a single LED, or other light emitting component. The flash 136 may be positioned outside of the protrusion 137 (e.g., in a portion of the rear cover 154 that does not include the protrusion 137). In some cases, the flash 136 is positioned at a point that is midway (in the y-direction) between the first camera 138 and the second camera 139, and offset from the cameras 138, 139 in the x-direction. In other examples, the flash 136 may be positioned in line with and between the cameras 138, 139 (e.g., in the protrusion 137). Stated another way, in some cases, the first camera 138, the flash 136, and the second camera 139 may be centered on a line that extends along the y-direction.

The flash 136 and the microphone port 135 may be aligned with one another in the x-direction. For example, the flash 136 and the microphone port 135 may be centered on a line that extends along the x-direction (which may be midway between the first camera 138 and the second camera 139).

In some cases, the microphone port 135 is positioned on the protrusion 137, and the microphone module inside the device is positioned outside of the area that defines the protrusion 137. In such cases, an internal porting structure may port sound from the microphone port 135 on the protrusion to the microphone module within the device.

Other details about the sensor array, the individual cameras of the sensor array, and/or the flash described with respect to the device 100 may be applicable to the sensor array, the individual cameras, and/or the flash of the device 140, and such details will not be repeated here to avoid redundancy.

With reference to FIG. 1D, the device 140 may include a back or rear cover 154 coupled to a housing structure 153 and defining at least a portion of the exterior rear surface of the device 140. The rear cover 154 may be formed from or include an optically transmissive material. The optically transmissive material may be colored and, in some cases, may be a colored glass material. The color of the optically transmissive material may be characterized by one or more color space coordinates, which in some cases may be a chroma value.

The rear cover 154 may include a substrate, alternately referred to herein as a rear cover member, formed of an optically transmissive glass material. The glass material may be a silicate-based material, such as an aluminosilicate glass, a boroaluminosilicate glass, an alkali metal aluminosilicate glass (e.g., a lithium aluminosilicate glass). Other examples of optically transmissive materials for the rear cover 154 include, without limitation, sapphire, ceramic, glass-ceramic, crystallizable glass materials, and plastic (e.g., polycarbonate). A glass-ceramic material may be a silicate-based glass-ceramic material, such as an aluminosilicate glass-ceramic material or a boroaluminosilicate glass-ceramic material. The glass or glass-ceramic material may be chemically strengthened by ion exchange. The rear cover 154 may be formed as a monolithic or unitary sheet. The rear cover 154 may also be formed as a composite of multiple layers of different materials, coatings, and other elements.

In some examples, an exterior surface of the rear cover may define different textures at different regions of the cover. In some cases, the different textures may produce different optical effects, such as a matte effect at a first region of the exterior surface and a glossy effect at a second region of the exterior surface. The difference between the matte and glossy effects may be used to define graphics, words, images, logos, or the like. For example, a visible logo may be defined by a glossy region (in the shape of the logo) surrounded by a matte region.

The rear cover 154 may include a coating on the exterior surface of the substrate, the interior surface of the substrate, or both. The coating may contribute to the appearance, such as the color, of the rear cover 154. For example, a coating along an interior surface of the substrate may include one or more color layers. The color layer may include a colorant such as a pigment or dye and may have a distinct hue or may be near neutral in color. In some examples, the color layer includes a polymeric binder, which may be polyester-based, epoxy-based, urethane-based, or based on another suitable type of polymer or copolymer. Alternately, or additionally, the coating may include one or more opaque layers applied to the interior surface of the substrate (or otherwise positioned along the interior side of the substrate) to provide a particular appearance to the back side of the device 140. The opaque layer(s) may include a sheet, ink, dye, or combinations of these (or other) layers, materials, or the like and in some cases may be optically dense. In some cases, the color of the coating along the interior surface of the substrate and the color of the substrate itself (e.g., the color of the optically transmissive material defining the rear cover substrate) together define the apparent color of the back side of the device 140.

In some cases, the coating on the rear cover and/or the material of the rear cover 154 itself present a color that substantially matches a color of the housing structure 153 (e.g., the exterior surfaces of the housing components and the joint structures). In such cases, the coating on the rear cover and the material of the rear cover may have substantially matching colors, or they may have different colors.

A coating along an exterior surface of the substrate may be a smudge-resistant (e.g., oleophobic) coating. The device 140 may include a wireless charging system, whereby the device 140 can be powered and/or its battery recharged by an inductive (or other electromagnetic) coupling between a charger (e.g., a wireless charging accessory) and a wireless charging system within the device 140. In such cases, the rear cover 154 may be formed of a material that allows and/or facilitates the wireless coupling between the charger and the wireless charging system (e.g., glass).

The housing structure 153 may have a similar construction as the housing structure 104. For example, the housing structure 104 may be a multi-piece housing formed from or including multiple housing components, which are structurally coupled together via one or more intermediate elements, such as joint structures. Together, the housing components and the joint structures may define a band-like housing structure that defines four side walls (and thus four exterior side surfaces) of the device 140. The four walls may include a top wall (e.g., proximate the front-facing sensor array 113), a bottom wall opposite the top wall (e.g., proximate the charging port), a first side wall (e.g., a first lateral side wall, visible in FIG. 1C), and a second side wall opposite the first side wall (e.g., a second lateral side wall, visible in FIG. 1D). Thus, both the housing components and the joint structures define portions of the exterior side surfaces of the device 140.

The housing components of the housing structure 153 may be formed of a conductive material (e.g., a metal), and the joint structures may be formed of one or more polymer materials (e.g., glass-reinforced polymer). The joint structures may include two or more molded elements, which may be formed of different materials. For example, an inner molded element may be formed of a first material (e.g., a polymer material), and an outer molded element may be formed of a second material that is different from the first (e.g., a different polymer material). The materials may have different properties, which may be selected based on the different functions of the inner and outer molded elements. For example, the inner molded element may be configured to make the main structural connection between housing components, and may have a higher mechanical strength and/or toughness than the outer molded element. On the other hand, the outer molded element may be configured to have a particular appearance, surface finish, chemical resistance, water-sealing function, or the like, and its composition may be selected to prioritize those functions over mechanical strength. The joint structures may be mechanically interlocked with the housing components to structurally couple the housing components and form a structural housing assembly.

The housing components of the housing structure 153 may be formed from single metal structures, or clad structures that include multiple materials. As an example single metal structure, the housing components may be formed from aluminum. As an example clad structure, the housing components may include a core portion formed from a first metal and a cladding portion formed from a second metal. The cladding portion may define exterior surfaces of the housing components. The exterior surface defined by the cladding portion may have a surface texture that produces a certain visual appearance and/or tactile feel. For example, the surface texture may have a texture that produces diffuse reflections. The surface texture may be produced by grinding, lapping, machining, ablation, blasting (e.g., sand blasting, bead blasting), etching (via mechanical etching, laser etching, chemical etching), or any other suitable texturing operation(s). The exterior surface of the housing components may also include a coating, such as a deposited coating. In some cases, the cladding portion is polished. A deposited coating may be deposited on the housing components via plasma vapor deposition (PVD), chemical vapor deposition (CVD), or the like.

In the case of clad structures, the core portions of the housing components may be aluminum (e.g., an aluminum alloy), and the cladding portions may be titanium (e.g., a titanium alloy). In some cases, the core portions of the housing components are aluminum, and the cladding portions are stainless steel. The cladding portions may have an average thickness of between about 0.1 mm and about 1.0 mm. The aluminum of the housing may include recycled aluminum (e.g., up to 70% recycled aluminum, up to 85% recycled aluminum, or another value).

The device 140 may also include one or more buttons (e.g., buttons 152 and 155 in FIG. 1C and buttons 156 and 157 in FIG. 1D), switches, and/or other physical input systems. Such input systems may be used to control power states (e.g., the button 152), control applications (e.g., the button 155), change speaker volume (e.g., the buttons 156), switch between “ring” and “silent” modes (e.g., the button 157), and the like. The buttons 152, 156, 155, and 157 may include strain-sensing systems that detect inputs to the buttons based on a detected strain. The buttons 152, 156, 155, and 157 may also be associated with haptic actuation systems that produce a tactile output in response to a detection of a strain that satisfies a condition. Thus, for example, upon detecting a strain or force that satisfies a condition (and/or an electrical parameter that is indicative of a strain satisfying the condition), a haptic actuation system may impart a force on a button to produce a tactile output (e.g., resembling a “click”). This tactile output or response may provide tactile feedback to the user to indicate that the input has been recognized by the device.

The buttons 152, 156, 155, and 157 may be embodiments of or otherwise correspond to the buttons 116, 117, 118, and 120 described above, and the description of those buttons will be understood to apply equally to the buttons 152, 156, 155, and 157. In some cases, one or more of the buttons 152, 156, 155, and 157 may use switch members, such as collapsible dome switches, to detect button presses. Such dome switches may be used in place of strain-based or other non-binary force-sensing systems. In some cases, however, dome switches or other collapsible or tactile switches may be used in addition to strain-based or non-binary force sensing systems in a given button. In such cases, the button may facilitate the detection of binary or momentary inputs, while also detecting a magnitude of a force being applied to the button. In such cases, the device 140 may perform different operations in response to detecting the binary or momentary input and in response to detecting a force that satisfies a condition. More particularly, a user may provide a partial actuation of the button, in which a force is applied but the switch is not collapsed. The device 140 may perform one or more operations in response to detecting the partial actuation of the button (e.g., in response to detecting a force that satisfies a condition). A user may subsequently provide a complete actuation of the button, in which the force is increased until the switch is actuated or otherwise registers an input (e.g., the dome switch collapses). The device 140 may perform one or more additional operations in response to detecting the switch actuation. As one nonlimiting example, the button may be used to provide inputs to the device 140 when the device 140 is operated in an image capture mode. In such cases, a partial actuation may cause the device 140 to initiate a focusing operation, or lock an exposure setting for image capture. When the complete actuation is detected (e.g., the binary or momentary switch is actuated), the device 140 may capture an image with one of the onboard cameras. Other functions may also be initiated in response to partial and/or complete actuation of the button, including other image-capture functions, or other device or application functions. For example, a partial actuation may initiate a scrolling operation (e.g., scrolling through items in a displayed list), and a complete actuation may initiate a selection of a selected item in the list. In some cases, the button 155 of the device 140 includes both a dome switch (or other binary or momentary type switch) and a strain-based sensing system. In some cases, one or more other buttons of the device 140 include both a dome switch (or other binary or momentary type switch) and a strain-based sensing system.

In some cases, one or more of the buttons 152, 156, 155, and 157 may use touch-sensing systems, such as capacitive touch-sensing systems, to detect inputs. For example, the button member of a button (e.g., the movable component that a user presses in order to actuate or provide an input to the button) may include a touch-sensing element positioned thereon. A button equipped with a touch-sensing element may detect various types of touch-based inputs, including static touch inputs (e.g., a finger touching the touch-sensitive button surface), dynamic touch inputs (e.g., a finger sliding along the touch-sensitive button surface, also referred to as gesture or swipe inputs), or the like.

In some cases, the button 155 may include a touch-sensing element 159 to detect such touch-based inputs. The device 140 may perform various operations in response to detecting touch-based inputs. Continuing the example above, when the device 140 is being operated in an image capture mode, a static touch input may initiate a focusing or exposure lock operation, while a dynamic or swipe touch input may initiate a zoom operation (e.g., swiping in one direction may initiate a zoom-in operation, and swiping in the opposite direction may initiate a zoom-out operation).

In some cases, the touch-sensing element 159 may detect the location of a touch input on the button 155 during a button actuation, and the device may perform different actions based on the location of the touch. For example, if the button 155 is actuated with a press input at a first location on the button 155 (e.g., at one end of the button 155, as detected by the touch-sensing element 159), the device may perform a first action (e.g., a zoom-in operation), and if the button 155 is actuated with a press input at a second location on the button 155 (e.g., at an opposite end of the button 155, as detected by the touch-sensing element 159), the device may perform a second action different from the first action (e.g., a zoom-out operation).

In some cases, the touch-sensing element 159 may detect whether an input to the button 155 is applied with a single finger or two fingers, and may perform different operations in response. For example, if the button 155 is actuated with a single finger (as detected by the touch-sensing element 159), the device may perform a first action (e.g., capture a single image), and if the button 155 is actuated with multiple fingers (as detected by the touch-sensing element 159), the device may perform a second action different from the first action (e.g., capture a sequence of images for the duration of the actuation, or initiate a video capture operation).

Other sensing techniques may also be used to detect inputs to the buttons. In some cases, a switch or other input device is used in place of one or more of the buttons.

As noted above, the button 155 may be force- and/or pressure-sensitive (e.g., able to detect variable force inputs) and can produce multiple controls or outputs based on amount of force input, presence of touch, location of touch, movement of touch (gesture). The particular operation that is initiated in response to any given button input may vary in accordance with (e.g., in proportion to) an amount of applied force. In some cases, a force-based input without a detected touch input at the touch-sensing element 159 may suppress an action or be ignored by the device. The button 155 may also be paired with one or more other buttons for designated operations or commands (e.g., the device may perform certain operations in response to detecting simultaneous inputs at multiple buttons or certain sequences of inputs at multiple buttons).

As described in several examples above, the button 155 may be operable to initiate or control image capture functions and operations. For example, a light touch of the button 155 (e.g., a sensed touch input without a force, or with a force that satisfies a first force condition corresponding to a slight deflection of the button) may initiate focus and light metering operations, and a larger force or deflection of the button (e.g., satisfying a second force condition) may initiate an image or video capture operation. Additionally, different haptic outputs may be produced in response to detecting different inputs at the button 155 and/or in response to the different operations that are initiated by the button inputs.

Other example image manipulation and/or camera function controls that can be initiated by inputs to the button 155 (force and/or touch inputs) may include: zooming in or zooming out in response to swipe inputs on the button surface in different directions; increasing or decreasing volume output in response to swipe inputs on the button surface in different directions; capturing a single image or a series of multiple images in response to different force inputs (e.g., single image for a light press, multiple images for a harder press). In such cases, different haptic outputs may be produced in response to detecting different inputs at the button 155 and/or in response to the different operations that are initiated by the button inputs.

The button 155 can also cause the device to perform other functions that are either tied to the operation of the device or set in response to operation of a particular application or use mode on the device. For example, inputs to the button 155 may cause the device to perform operations such as: selecting one or more alert suppression (mute) modes; verifying purchase or verify application command; controlling timer commands including watch-related operations; providing input to games such as throttle control or other continuously variable inputs; initiating hard and/or soft reset of the device; initiating user programmable operations; and launching or terminating applications. In some cases, the particular operation of the button may be user programmable or selectable. For example, a user may select what functions or operations are initiated in response to various force inputs, gesture inputs, and touch inputs. The user may also establish different input schemes for different device modes. For example, the user may map force, touch, and gesture inputs to a first set of functions when the device is operating in a first mode (e.g., when a first application is being executed), and may map force, touch, and gesture inputs to a second set of functions when the device is operating in a second mode (e.g., when a second application is being executed).

In some cases, the operation of the button 155 may change based on the orientation of the device. For example, if the device is being held in a vertical or “portrait” orientation, the force, touch, and gesture inputs may map to a first set of functions, and if the device is being held in a horizontal or “landscape” orientation, the force, touch, and gesture inputs may map to a second set of functions.

The button 155 may also be used to initiate stereoscopic image or video capture. In some cases, the selection of a stereoscopic image capture mode (or switching between stereoscopic and non stereoscopic image modes) may be controlled by operation of the button 155 or other device inputs (e.g., other buttons, touch-screen inputs, etc.). In some cases, the ability to select a stereoscopic image mode (or switch between a stereoscopic image mode and other image modes) with the button 155 may be dependent on the orientation of the device.

FIG. 1E depicts another example electronic device 160. The electronic device 160 may have many of the same or similar features and components as the devices 100, 140, and it will be understood that the descriptions of those features and components may apply equally to the device 160. The device 160 may include a cover 162 (e.g., a front cover) attached to a housing structure 164 (which may include a housing structure defined by one or more housing components). The housing structure 164 (and other device housings herein) may define a peripheral wall structure of the enclosure of the device.

The cover 162 may be positioned over a display 163. The cover 162 may be a sheet or sheet-like structure formed from or including a transparent or optically transmissive material. The cover 162 may define a front exterior surface of the device, and an interior surface opposite the exterior surface. In some cases, the cover 162 is formed from or includes a glass material and may therefore be referred to as a glass cover member. The glass material may be a silicate-based material, an aluminosilicate glass, a boroaluminosilicate glass, an alkali metal aluminosilicate glass (e.g., a lithium aluminosilicate glass), or a chemically strengthened glass. Other example materials for the cover 162 include, without limitation, sapphire, ceramic, glass-ceramic, crystallizable glass materials, or plastic (e.g., polycarbonate). A glass-ceramic material may be a silicate-based glass-ceramic material, such as an aluminosilicate glass-ceramic material or a boroaluminosilicate glass-ceramic material. The glass-ceramic material may be chemically strengthened by ion exchange. The cover 162 may be formed as a monolithic or unitary sheet. The cover 162 may also be formed as a composite of multiple layers of different materials, coatings, and other elements. The cover 162 may have a thickness between about 0.3 mm and about 0.7 mm, or between about 0.4 mm and about 0.6 mm.

The display 163 may be at least partially positioned within the interior volume of the housing structure 164. The display 163 may be coupled to the cover 162, such as via an adhesive or other coupling scheme. The display 163 may include a liquid-crystal display (LCD), a light-emitting diode (LED) display, an organic light-emitting diode (OLED) display, an active layer organic light-emitting diode (AMOLED) display, an organic electroluminescent (EL) display, an electrophoretic ink display, or the like. The display 163 may be configured to display graphical outputs, such as graphical user interfaces, that the user may view and interact with. Graphical outputs may be displayed in a graphically active region of the display 163 (e.g., an active display region). The active display region may be surrounded or defined by a border region, which may be defined by an opaque mask on the interior surface of the cover 162 (or using other components or techniques). In some cases, the borders are small (e.g., less than about 3 mm, less than about 2 mm, or less than about 1 mm). The display may have a display dimension (e.g., measured from corner to corner of the display) between about 6.25 inches and about 6.75 inches.

The display 163 may also define a primary display region, which may generally correspond to the main front-facing, contiguous display region, in which graphical user interfaces, images, videos, applications, and other graphical outputs may be displayed.

The device 160 may also include an ambient light sensor that can determine properties of the ambient light conditions surrounding the device 160. The device 160 may use information from the ambient light sensor to change, modify, adjust, or otherwise control the display 163 (e.g., by changing a hue, brightness, saturation, or other optical aspect of the display based on information from the ambient light sensor). The ambient light sensor may be positioned below an active area of the display 163 (e.g., below a portion of the display that produces graphical output). The ambient light sensor may transmit and/or receive light through the active area of the display 163 to perform sensing functions.

The display 163 may include or be associated with one or more touch- and/or force-sensing systems. In some cases, components of the touch- and/or force-sensing systems are integrated with the display stack. For example, touch-sensing components such as electrode layers of a touch and/or force sensor may be provided in a stack that includes display components (and is optionally attached to or at least viewable through the cover 162). The touch- and/or force-sensing systems may use any suitable type of sensing technology and touch-sensing components, including capacitive sensors, resistive sensors, surface acoustic wave sensors, piezoelectric sensors, strain gauges, or the like. The outer or exterior surface of the cover 162 may define an input surface (e.g., a touch- and/or force-sensitive input surface) of the device. While both touch- and force-sensing systems may be included, in some cases the device 160 includes a touch-sensing system and does not include a force-sensing system.

The housing structure 164 may be a multi-piece housing. For example, the housing structure 164 may be formed from multiple housing components, which are structurally coupled together via one or more intermediate elements, such as joint structures. The description of the housing structure 104, housing components, and joint structures provided with reference to the devices 100, 140 apply equally or by analogy to the device 160. In some cases, the housing components of the housing structure 164 may be formed from a clad structure that includes multiple materials. For example, the housing components may include a core portion formed from a first metal and a cladding portion formed from a second metal. The cladding portion may define exterior surfaces of the housing components. The exterior surface defined by the cladding portion may have a surface texture that produces a certain visual appearance and/or tactile feel. For example, the surface texture may have a texture that produces diffuse reflections. The surface texture may be produced by grinding, lapping, machining, ablation, blasting (e.g., sand blasting, bead blasting), etching (via mechanical etching, laser etching, chemical etching), or any other suitable texturing operation(s). The exterior surface of the housing components may also include a coating, such as a deposited coating. In some cases, the cladding portion is polished. A deposited coating may be deposited on the housing components via plasma vapor deposition (PVD), chemical vapor deposition (CVD), or the like.

In the case of a clad structure, the core portions of the housing components may be aluminum (e.g., an aluminum alloy), and the cladding portions may be titanium (e.g., a titanium alloy). Other metals may be used instead of aluminum and titanium for the core and cladding portions, such as an aluminum core with a stainless-steel cladding, or a nickel core with a titanium cladding, or a steel core with stainless steel cladding. Other metals and combinations of metals are also contemplated. In some cases, the core portions of the housing components are aluminum, and the cladding portions are stainless steel. The cladding portions may have an average thickness of between about 0.1 mm and about 1.0 mm. The aluminum of the housing may include recycled aluminum (e.g., up to 70% recycled aluminum, up to 85% recycled aluminum, or another value).

The device 160 includes a charging port 165, which may be defined at least in part by an opening formed directly through the housing structure 164 (e.g., an opening positioned along a bottom side surface) and providing access to a charging and/or communications connector therein. In some cases, the surface of the charging port 165 (e.g., the surface that is defined by the material of the housing structure 164) may define an inner surface of the charging port and may be configured to interface (e.g., contact) with a corresponding plug. This configuration may obviate the need for a separate charging port sleeve or shield member to be positioned within the charging port 165, and may facilitate a reduction in the overall thickness of the device (e.g., distance between the front and rear surfaces).

The device 160 may also include one or more buttons, switches, and/or other physical input systems. Such input systems may be used to control power states, control applications, change speaker volume, switch between “ring” and “silent” modes, and the like. The device 160 may have the same or similar configuration of buttons, switches, and/or other physical input systems as the devices 100, 140, and the discussion of those systems apply equally or by analogy to the device 160.

The device 160 may include a front-facing sensor region 169, which may generally correspond to the front-facing sensor regions 111, 113 in FIGS. 1A, 1C. The front-facing sensor region 169 may be positioned in an island-like area of the front of the device 160, and may be surrounded by a display region (e.g., a main display region) of the device 160. In some cases, as described herein, the front-facing sensor region 169 may be positioned in or defined by one or more holes formed through a display. In such cases, the front-facing sensor region 169 may be bordered on all sides by active areas or regions of the display. Stated another way, the front-facing sensor region 169 may be completely surrounded by active display areas (e.g., an outer periphery of the front-facing sensor region 169 may be surrounded by active areas of the display). In some cases, the front-facing sensor region 169 includes or is defined by one or more masks or other visually opaque component(s) or treatment(s) that define openings for the sensors of the front-facing sensor region 169. The front-facing sensor region 169 may include components such as an infrared illuminator module (which may include a flood illuminator and a dot projector), an infrared image capture device, components of a proximity sensing system, and a front-facing camera.

FIG. 1F illustrates a back or rear side of the device 160. As shown, the device 160 includes a rear cover 175 coupled to the housing structure 164. The rear cover 175 may define substantially all of the back or rear surface of the device 160. The rear cover 175 may be formed from or include a transparent or optically transmissive material. For example, the rear cover 175 may include a substrate formed of a glass material. The glass material may be a silicate-based material, an aluminosilicate glass, a boroaluminosilicate glass, an alkali metal aluminosilicate glass (e.g., a lithium aluminosilicate glass), or a chemically strengthened glass. Other example materials for the rear cover 175 include, without limitation, sapphire, ceramic, glass-ceramic, crystallizable glass materials, and plastic (e.g., polycarbonate). A glass-ceramic material may be a silicate-based glass-ceramic material, such as an aluminosilicate glass-ceramic material or a boroaluminosilicate glass-ceramic material. The glass-ceramic material may be chemically strengthened by ion exchange. As described herein, the rear cover 175 may be shaped from a single piece or billet of silicate-based materials to define a protrusion along the exterior side of the rear cover 175 and a corresponding recess along an interior side of the rear cover 175.

The device 160 may be thinner (e.g., the dimension extending from the front cover 162 to the rear cover 175) than the device 100. In some cases, the nominal thickness of the device (e.g., from the front cover 162 to the rear cover 175, at a location outside of the protrusion) is between about 4.0 mm and about 7.5 mm.

The device 160 may also include a sensor array 171 (e.g., a rear-facing sensor array in a rear-facing sensor array region) that includes a camera 172, a flash 173, and a microphone 170 (among other possible components). The camera 172 may include a 48-megapixel sensor (optionally with a three-layer sensor arrangement) with sensor-shift image stabilization and a wide-angle lens having an aperture number of f/1.6. The image sensor may have a pixel size between about 0.8 microns and about 1.4 microns. The flash 173 and the microphone 170 may be substantially similar to those described with respect to the devices 100, 140, and those descriptions will be understood to apply equally here.

The sensor array 171 may be in a sensor array region that is defined by a protrusion 174 in the rear cover 175 of the device 160. The protrusion 174 may define a portion of the rear exterior surface of the device 100, and may at least partially define a raised sensor array region of the sensor array 171.

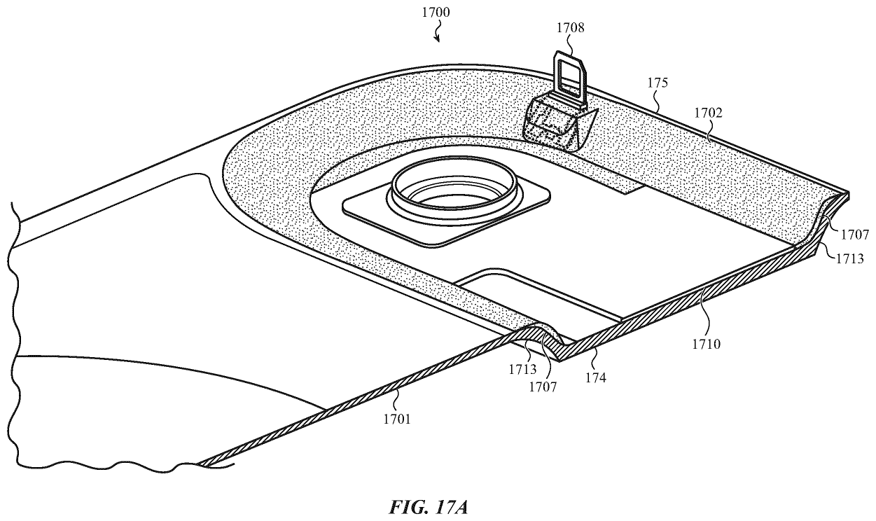

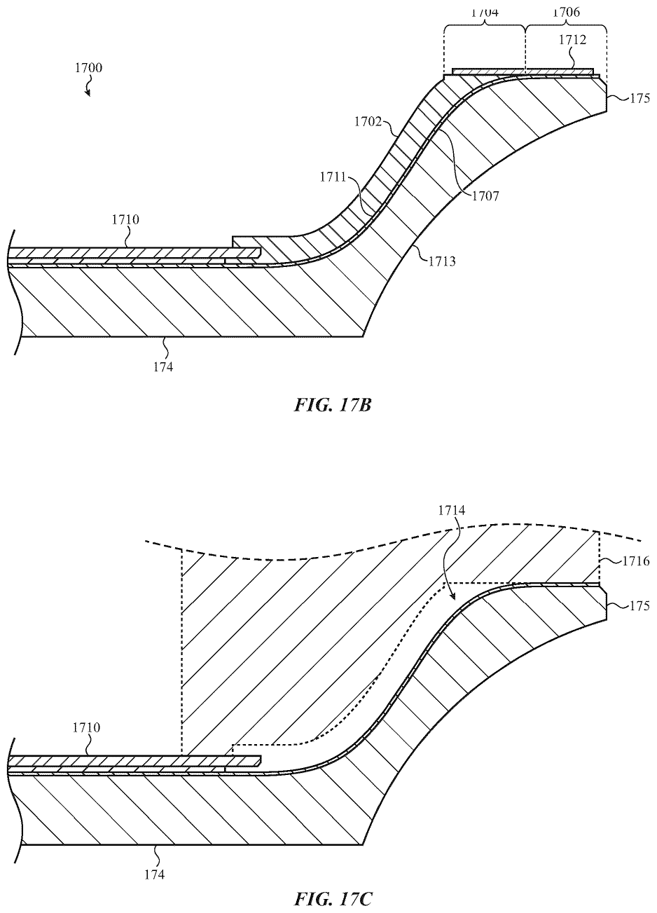

The rear cover 175, including the protrusion 174, may be formed from a single piece of material, such as glass (or a glass ceramic or other glass-like material). In such cases, the protrusion 174 may be formed by a machining operation in which material is removed from a precursor material (e.g., a blank) to form the surfaces and shapes of the rear cover 175 and the protrusion 174. In some cases, the rear cover 175 is formed and/or shaped by a combination of operations, such as a gross molding operation that generally defines the overall shape of the rear cover 175 (e.g., having a thicker or protruded region at one end), followed by a machining or other forming operation to produce the final shape. The gross molding operation may include a slumping operation. As another example, the rear cover 175 may be formed by adding a glass (or other material) sheet to a base sheet to define a precursor structure with an increased thickness region, from which the protrusion 174 (and the recess on the opposite side of the rear cover 175, as described with respect to FIG. 17A) is formed.

As shown and described, the rear cover 175 may have a recessed region opposite the protrusion 174 (e.g., a recess on the interior side of the rear cover 175 may correspond to and/or define a protrusion on the exterior side of the rear cover 175). By forming the recessed region opposite the protrusion 174, additional space may be provided in that region of the device 160 to contain components, including, without limitation, at least a portion of a circuit board assembly, the camera 172, the microphone 170, the flash 173, front-facing cameras and sensors, a speaker module (e.g., for providing sound output from one or more speaker openings), and the like.

The protrusion 174 may extend substantially entirely from one sidewall of the housing structure 164 to an opposite sidewall of the housing structure 164 (e.g., completely across the back of the device 160 from right to left), and may be centered (e.g., relative to a central longitudinal axis). The protrusion 174 may have a generally pill-shaped (or obround or stadium-shaped) profile, with a longitudinal axis extending generally from left to right across the rear of the device 160.

The components of the rear-facing sensor array 171 may be aligned on the longitudinal axis of the protrusion 174. Thus, for example, the camera 172, the microphone 170, and the flash 173 may be aligned on the longitudinal axis of the protrusion 174, though other configurations are also contemplated.

FIG. 2 depicts an exploded view of an example electronic device. In particular, FIG. 2 depicts an exploded view of the device 100, showing various components of the device 100 and example arrangements and configurations of the components.

As shown in FIG. 2, the device 100 includes a front cover assembly 201. The front cover assembly 201 may include the cover 102, the display 103, and optionally a molded frame. The front cover assembly 201 (and more particularly the cover 102 of the front cover assembly 201) may define a front exterior surface of the device. The cover 102 may also define an interior surface opposite the exterior surface.

The front cover assembly 201 may be assembled as a subassembly, which may then be attached to a housing component. For example, as described herein, the display 103 may be attached to the cover 102 (e.g., via a transparent adhesive), and a molded frame may be formed around a periphery of the display 103 and bonded to the cover 102 (e.g., via a low injection pressure molding operation). The front cover assembly 201 may then be attached to a housing component of the device 100 by mounting and adhering the molded frame to a ledge defined by the housing component.

In some cases, the cover 102 is formed from or includes a glass material and may therefore be referred to as a glass cover member. The cover 102 may be formed as a monolithic or unitary sheet. The cover 102 may also be formed as a composite of multiple layers of different materials, coatings, and other elements. In this example, the cover 102 may be formed from a glass-ceramic material. A glass-ceramic material may include both amorphous and crystalline or non-amorphous phases of one or more materials and may be formulated to improve strength or other properties of the cover 102. A glass-ceramic material may be a silicate-based glass-ceramic material, such as an aluminosilicate glass-ceramic material or a boroaluminosilicate glass-ceramic material. The glass-ceramic material may be chemically strengthened by ion exchange. In some cases, the cover 102 may include a sheet of chemically strengthened glass or glass-ceramic having one or more coatings including an anti-reflective (AR) coating, an oleophobic coating, or other type of coating or optical treatment. In some cases, the cover 102 includes a sheet of material that is less than 1 mm thick. In some cases, the sheet of material is less than 0.80 mm. In some cases, the sheet of material is approximately 0.60 mm or less. The cover 102 may be chemically strengthened using an ion exchange process to form a compressive stress layer along exterior surfaces of the cover 102.

The cover 102 extends over a substantial entirety of the front surface of the device and may be positioned within an opening defined by a housing structure 104. As described in more detail below, the edges or sides of the cover 102 may be surrounded by a protective flange or lip of the housing structure 104 without an interstitial component between the edges of the cover 102 and the respective flanges of the housing structure 104. This configuration may allow an impact or force applied to the housing structure 104 to be transferred to the cover 102 without directly transferring shear stress through the display 103 or a frame of the front cover assembly 201.

The display 103 is coupled to an internal surface of the cover 102. The display 103 may include an edge-to-edge organic light-emitting diode (OLED) display that measures about 6.86 inches corner-to-corner or about 6.27 inches corner-to-corner. The perimeter or non-active area of the display 103 may be reduced to allow for very thin device borders around the active area of the display 103. In some cases, the display 103 allows for border regions of 1.5 mm or less. In some cases, the display 103 allows for border regions of 1 mm or less. In one example implementation, the border region is approximately 0.9 mm. The display 103 may have a relatively high pixel density of approximately 460 pixels per inch (PPI) or greater. The display 103 may use a low temperature polycrystalline silicone (LTPS) or low temperature polycrystalline oxide (LTPO) backplane.

The display 103 may have an integrated (on-cell) touch-sensing system. For example, an array of electrodes (or other touch-sensing components) that are integrated into the OLED display may be time and/or frequency multiplexed in order to provide both display and touch-sensing functionality. The electrodes may be configured to detect a location of a touch, a gesture input, multi-touch input, or other types of touch input along the external surface of the cover 102. In some cases, the display 103 includes another type of display element, such as a liquid-crystal display (LCD) without an integrated touch-sensing system. That is, the device 100 may include one or more touch- and/or force-sensing components or layers that are positioned between the display 103 and the cover 102.

The display 103, also referred to as a display stack, may include always-on-display (AOD) functionality. For example, the display 103 may be configurable to allow designated regions or subsets of pixels to be displayed when the device 100 is powered on such that graphical content is visible to the user even when the device 100 is in a low-power or sleep mode. This may allow the time, date, battery status, recent notifications, and other graphical content to be displayed in a lower-power or sleep mode. This graphical content may be referred to as persistent or always-on graphical output. While some battery power may be consumed when displaying persistent or always-on graphical output, the power consumption is typically less than during normal or full-power operation of the display 103. This functionality may be enabled by only operating a subset of the display pixels and/or at a reduced resolution in order to reduce power consumption by the display 103.

The display 103 may include multiple layers, including touch-sensing layers or components, optional force-sensing layers or components, display layers, and the like. The display 103 may define a graphically active region in which graphical outputs may be displayed. In some cases, portions of the display 103 may include graphically inactive regions, such as portions of the display layers that do not include active display components (e.g., pixels) or are otherwise not configured to display graphical outputs. In some cases, graphically inactive regions may be located along the peripheral borders or other edges of the display stack 103.

The device 100 may also include a molded frame member that is positioned below the cover 102 and that extends around at least an outer periphery of the display 103. The molded frame may at least partially encapsulate the edges of the display 103, and may define a structural feature that provides strength and rigidity to the cover 102 and the display 103, and that serves as a mounting structure to couple the cover 102 to a housing (e.g., the housing structure 104). The molded frame may be produced by molding a moldable material onto a subassembly that includes the cover 102, the display 103, and optionally other structural components.

The molded frame may be attached to a lower or inner surface of the cover 102. A portion of the molded frame may extend below the display 103 and may attach the cover 102 to the housing structure 104. Because the display 103 is attached to a lower or inner surface of the cover 102, the molded frame may also be described as attaching both the display 103 and the cover 102 to the housing structure 104.

The device 100 also includes a speaker module 250 that is configured to output sound via a speaker port. The speaker port may be positioned in and/or at least partially defined by a recess of the cover 102. As described herein, a trim piece may be positioned at least partially in the recess to facilitate the output of sound while also inhibiting the ingress of debris, liquid, or other materials or contaminants into the device 100. Output from the speaker module 250 may pass through an audio passage or acoustic path defined at least in part by the speaker module 250 itself, and the trim piece. In some cases, part of the acoustic path (e.g., between the speaker module 250 and the trim piece) is defined by the housing structure 104 and/or a molded material that is coupled to the housing structure 104. For example, a molded material (e.g., a fiber-reinforced polymer) may be molded against a metal portion of the housing structure 104. The molded material may also form one or more intermediate elements, such as joint structures, that also structurally join housing components together (e.g., the joint structures 122-1, 122-2, 122-3, 122-4). A port or passage (e.g., a tube-like tunnel) may be defined through the molded material to acoustically couple the speaker module 250 to the trim piece and/or the recess more generally, thereby directing sound from the speaker module 250 to the exterior of the device 100.

As shown in FIG. 2, the device 100 also includes one or more cameras, optical emitters, and/or sensing elements that are configured to transmit signals, receive signals, or otherwise operate along the front surface of the device. In this example, the device 100 includes a front camera 206 that includes a high-resolution camera sensor. The front camera 206 may have a 12-megapixel resolution sensor with optical elements that provide an 85° field of view and an aperture number of f/1.9. The front camera 206 may include autofocus functionality in which one or more of the lens elements move (e.g., up to about 100 microns perpendicular to the cover) in order to focus an image on the camera's sensor. In some cases, the autofocusing front-facing camera is capable of providing continuous autofocus functionality during video capture. The device 100 also includes an optical facial recognition system 252 that includes an infrared light projector (for projecting light), and an infrared light sensor that is configured to sense an array of depth points or regions along the face of the user. The array of depth points may be characterized as a unique signature or bio-identifier, which may be used to identify and/or authenticate the user and unlock the device 100 (and/or authorize functionality on the device 100 like the purchase of software apps or the use of payment functionality provided by the device 100).

The device 100 may also include one or more other sensors or components. For example, the device 100 may include a front light illuminator element for providing a flash or illumination for the front camera 206. The device 100 may also include an ambient light sensor (ALS) that is used to detect ambient light conditions for setting exposure aspects of the front camera 206 and/or for controlling the operation of the display. The device 100 may also include a proximity sensing system for detecting the proximity of a user or other object to the device 100. In some cases, as described herein, the proximity sensing system detects proximity to other objects through an active region of the display. The proximity sensing system and the optical facial recognition system may be integrated in a common module. In some cases, information from both the proximity sensing system and the ambient light sensor is used to determine ambient light conditions and/or the proximity of objects to the device 100. For example, information from the proximity sensing system may be used to determine whether a detection by the ambient light sensor of low ambient lighting is due to low ambient lighting, or an object locally or temporarily covering the ambient light sensor (e.g., a finger providing a touch input or a palm during a typing input). Information from both sensing systems may be used to disambiguate between potentially ambiguous conditions, and generally improve the accuracy with which the device can sense or detect certain conditions.

The display 103 may include one or more holes extending through the display to accommodate the front camera 206, the facial recognition system 252, the proximity sensing system, and optionally other front-facing sensors or other components. In some cases, the display 103 includes two holes, including a first hole for the front camera 206 and a second hole for the facial recognition system 252 and the proximity sensing system. In some cases, the display 103 includes one hole (e.g., a single hole shared by the front camera 206 and the facial recognition system 252). In some cases, the display 103 includes three holes (e.g., a first hole for the front camera 206, a second hole for an emitter of the facial recognition system 252 and optionally the proximity sensing system, and a third hole for a receiver of the facial recognition system 252).

FIG. 2 also illustrates one or more cameras, optical emitters, and/or sensing elements that are configured to transmit signals, receive signals, or otherwise operate along the rear surface of the device. As depicted in FIG. 2, these elements may be integrated in a sensor array 141. In this example, the sensor array 141 (or camera array) includes the first camera 142, the second camera 144, and the third camera 146 (discussed with respect to FIG. 1B). The first, second, and third cameras may include lens-based or sensor-based image stabilization.

The sensor array 141 also includes a flash 148 that may be used as a flash for photography or as an auxiliary light source (e.g., a flashlight). In some cases, the sensor array 141 also includes a microphone, an ambient light sensor, and other sensors that are adapted to sense along the rear surface of the device 100.

The sensor array 141 may also include a depth sensing system (which may be or may include the depth sensor module 149) that is configured to estimate a distance to objects positioned behind the device 100. The depth sensing system may include an optical sensor that uses time-of-flight or other optical effect to measure a distance between the device 100 and an external object. The depth sensing system may include one or more optical emitters that are adapted to emit one or more beams of light, which may be used to estimate the distance. In some cases, the one or more beams of light are coherent light beams having a substantially uniform wavelength/frequency. A coherent light source may facilitate depth measurements using a time of flight, phase shift, or other optical effect. In some cases, the depth sensing system uses a sonic output, radio output, or other type of output that may be used to measure the distance between the device 100 and one or more external objects. The depth sensing system (e.g., the depth sensor module 149) may be positioned proximate a window (e.g., a hole or opening through the protrusion 151 of the device 100) through which the depth sensing system may send and/or receive signals (e.g., laser light, infrared light, visible light, etc.).

The cameras 142, 144, 146 may be aligned with camera covers, which are coupled to the protrusion 151 of the device 100. The covers may be formed from a glass or sapphire material and may provide a clear (e.g., transparent or optically transmissive) window through which the cameras 142, 144, 146 are able to capture a photographic image. In other cases, the covers are optical lenses that filter, magnify, or otherwise condition light received by the respective camera.

The device 100 also includes a battery 230. The battery 230 provides electrical power to the device 100 and its various systems and components. The battery 230 may include a 4.45 V lithium-ion battery that is encased in a rigid metal enclosure (or a flexible foil defining a pouch). The battery 230 may include a rolled electrode configuration, sometimes referred to as a “jelly roll” or a folded or stacked electrode configuration. In the case of a rigid metal enclosure, the enclosure may include a two-part enclosure, in which the two parts define an internal volume that encloses the electrodes and an electrolyte (e.g., a liquid), or another suitable battery formulation. The first and second parts of the enclosure may be attached together via welding, soldering, brazing, adhesive, or another suitable attachment technique. In some cases, the battery enclosure defines one or more pass-through terminals to allow conductive coupling to an internal electrode (e.g., a positive electrode). In some cases, the battery enclosure is conductively coupled to an internal electrode (e.g., a negative electrode), and the battery enclosure itself acts as a negative or “common” electrode for the power circuitry of the device 100.

The battery 230 may be attached to the device 100 (e.g., to a chassis member 219, which may also be referred to as a mid-chassis section or simply a chassis) with one or more adhesives and/or other attachment techniques. In one example, the battery 230 may be attached to the chassis member 219, or another structure of the device 100, with an electrically debondable adhesive (e.g., an adhesive whose adhesion strength can be selectively reduced in response to an electric charge). In such cases, the adhesive may include conductive terminals that conductively contact the electrically debondable adhesive. When an electric current is applied to the electrically debondable adhesive (EDA) (e.g., by a user during a battery replacement operation), the adhesion strength of the adhesive may be reduced until the battery releases from the adhesive and/or the chassis member 219, or until the adhesion strength is sufficiently low that the battery can be easily removed by a user (e.g., without damage to the battery or other device components).

The battery 230 may be recharged via a charging port 112 (e.g., from a charging cable plugged into the charging port 112), and/or via a wireless charging system 240. The battery 230 may be coupled to the charging port 112 and/or a wireless charging system 240 via battery control circuitry that controls the power provided to the battery and the power provided by the battery to the device 100. The battery 230 may include one or more lithium-ion battery cells or any other suitable type of rechargeable battery element. The charging port 112 may be or may include a connector module.

The wireless charging system 240 may include a coil that inductively couples to an output or transmitting coil of a wireless charger. The coil may provide current to the device 100 to charge the battery 230 and/or power the device. In this example, the wireless charging system 240 includes a coil assembly that includes multiple wraps of a conductive wire or other conduit that is configured to produce a (charging) current in response to being placed in an inductive charging electromagnetic field produced by a separate wireless charging device or accessory. The coil assembly also includes or is associated with an array of magnetic elements that are arranged in a circular or radial pattern. The magnetic elements may help to locate the device 100 with respect to a separate wireless charging device or other accessory. In some implementations, the array of magnets also help to radially locate, orient, or “clock” the device 100 with respect to the separate wireless charging device or other accessory. For example, the array of magnets may include multiple magnetic elements having alternated magnetic polarity that are arranged in a radial pattern. The magnetic elements may be arranged to provide a magnetic coupling to the separate charging device in a particular orientation or set of discrete orientations to help locate the device 100 with respect to the separate charging device or other accessory. This functionality may be described as self-aligning or self-locating wireless charging. As shown in FIG. 2, the device 100 also includes a magnetic fiducial 244 for helping to locate the separate wireless charging device or accessory. In one example, the magnetic fiducial 244 is adapted to magnetically couple to a separate wireless charging device or other accessory. By coupling to the separate wireless charging device/accessory, the rotational alignment of the device 100 and the separate wireless charging device/accessory may be maintained with respect to an absolute or single position. Also, by magnetically coupling the charging device/accessory to the rear surface of the device 100, the charging device or other accessory may be more securely coupled to the device 100.

In some implementations, the wireless charging system 240 includes an antenna or other element that detects the presence of a charging device or other accessory. In some cases, the charging system includes a near-field communications (NFC) antenna that is adapted to receive and/or send wireless communications between the device 100 and the wireless charger or other accessory. In some cases, the device 100 is adapted to perform wireless communications to detect or sense the presence of the wireless charger or other accessory without using a dedicated NFC antenna. The communications may also include information regarding the status of the device, the amount of charge held by the battery 230, and/or control signals to increase charging, decrease charging, start charging, and/or stop charging for a wireless charging operation.

The wireless charging system 240 may also include one or more graphite layers (or other thermally conductive layers) that improve the thermal performance of the wireless charging system 240 and/or the device itself. For example, the graphite layers on the wireless charging system 240 may diffuse and/or distribute heat from the coil during charging operations. In some cases, the graphite layers may absorb and diffuse heat from other components, such as the battery 230.

The device 100 may also include a speaker system 224. The speaker system 224 may be positioned in the device 100 so that one or more audio openings 114 are aligned with or otherwise proximate an audio output of the speaker system 224. Accordingly, sound that is output by the speaker system 224 exits the housing structure 104 via the audio openings 114. The speaker system 224 may include a speaker positioned in a housing that defines a speaker volume (e.g., an empty space in front of or behind a speaker diaphragm). The speaker volume may be used to tune the audio output from the speaker and optionally mitigate destructive interference of the sound produced by the speaker.

The device 100 may also include a haptic actuator 222. The haptic actuator 222 may include a movable mass and an actuation system that is configured to move the mass to produce a haptic output. The actuation system may include one or more coils and one or more magnets (e.g., permanent and/or electromagnets) that interact to produce motion. The magnets may be or may include recycled magnetic material.

When the coil(s) are energized, the coil(s) may cause the mass to move, which results in a force being imparted on the device 100. The motion of the mass may be configured to cause a vibration, pulse, tap, or other tactile output detectable via an exterior surface of the device 100. The haptic actuator 222 may be configured to move the mass linearly, though other movements (e.g., rotational) are also contemplated. The mass may move along the x-direction. Other types of haptic actuators may be used instead of or in addition to the haptic actuator 222.

In some cases, the haptic actuator 222 is configured to produce a first haptic output in response to the device detecting that a force input applied to a button (e.g., a button with a strain- or other force-sensing element) satisfies a force threshold, and is also configured to produce a second haptic output in response to a notification event (e.g., an event that is associated with a haptic notification, or for which the device produces a haptic output upon occurrence). Thus, the same haptic actuator 222 may be used to produce haptics for notifications, as well as to simulate button presses or otherwise indicate that an input satisfying a force threshold has been received.

The device 100 also includes a circuit board assembly 220. The circuit board assembly 220 may include a substrate, and processors, memory, and other circuit elements coupled to the substrate. The circuit board assembly 220 may include multiple circuit substrates that are stacked and coupled together in order to maximize the area available for electronic components and circuitry in a compact form factor. The circuit board assembly 220 may include provisions for a subscriber identity module (SIM). The circuit board assembly 220 may include electrical contacts and/or a SIM tray assembly for receiving a physical SIM card and/or the circuit board assembly 220 may include provisions for an electronic SIM. Where an electronic SIM is used, a SIM tray may be omitted from the device 100 (e.g., the device may not include openings, trays, slots, doors, or other mechanical means to insert or otherwise access a SIM card). The circuit board assembly 220 may be wholly or partially encapsulated to reduce the chance of damage due to ingress of water or other fluid. As described herein, thermal bridges may be applied to the circuit board assembly 220 to help transfer heat from the circuit board assembly 220 to other regions or components of the device 100 (e.g., to a thermal spreading module 237). The thermal bridges may include graphite-wrapped foams or graphite-coated loops, in which the loop or the foam structure maintains the graphite (which provides thermal conductivity) in contact with the circuit board assembly 220 and the other components.

The circuit board assembly 220 may also include wireless communication circuitry, which may be operably coupled to and/or otherwise use housing components as radiating members to provide wireless communications. The circuit board assembly 220 may also include components such as accelerometers, gyroscopes, near-field communications circuitry and/or antennas, compasses, and the like. In some implementations, the circuit board assembly 220 may include a magnetometer that is adapted to detect and/or locate an accessory. For example, the magnetometer may be adapted to detect a magnetic (or non-magnetic) signal produced by an accessory of the device 100 or other device. The output of the magnetometer may include a direction output that may be used to display a directional indicia or other navigational guidance on the display 103 in order to guide the user toward a location of the accessory or other device.

The circuit board assembly 220 may also include global positioning system (GPS) electronics that may be used to determine the location of the device 100 with respect to one or more satellites (e.g., a Global Navigation Satellite System (GNSS)) in order to estimate an absolute location of the device 100. In some implementations, the GPS electronics are operable to utilize dual frequency bands or ranges. For example, the GPS electronics may use L1 (LIC), L2 (L2C), L5, L1+L5, and other GPS signal bands in order to estimate the location of the device 100.

The device 100 may also include one or more pressure transducers that may be operable to detect changes in external pressure in order to determine changes in altitude or height. The pressure sensors may be externally ported and/or positioned within a water-sealed internal volume of the housing structure 104. The output of the pressure sensors may be used to track flights of stairs climbed, a location (e.g., a floor) of a multi-story structure, movement performed during an activity in order to estimate physical effort or calories burned, or other relative movement of the device 100. A pressure transducer may be in fluidic communication with the exterior environment through audio openings (e.g., ports) 114 in the housing structure 104.

As shown in FIG. 2, the housing may include a rear cover 132 that may define at least a portion of a rear exterior surface of the device 100. The rear cover 132 may be positioned in an opening of a recess defined along the rear of the device 100, and in particular, formed into the housing structure 104. The rear cover 132 may cover or be positioned over the wireless charging system 240, and may be configured to allow electromagnetic coupling between the wireless charging system 240 and external chargers and/or power sources. The rear cover 132 may have portions that are less than 1 mm thick. In some cases, the rear cover 132 has portions that are less than 0.80 mm. In some cases, the rear cover 132 has portions that are approximately 0.40 mm or less. The rear cover 132 may have a uniform thickness.

The rear cover 132 may be formed of a colored optically transmissive material, and may include a coating along an interior side of the rear cover 132 that, together with the color (or lack of color) of the optically transmissive material, define the color of a portion of the rear side of the device. For example, a coating along an interior surface of the rear cover 132 may include one or more color layers. The color layer may include a colorant such as a pigment or dye and may have a distinct hue or may be near neutral in color. Alternately, or additionally, the coating may include one or more opaque layers applied to the interior surface of the substrate (or otherwise positioned along the interior side of the substrate) to provide a particular appearance to the back side of the device. The opaque layer(s) may include a sheet, ink, dye, or combinations of these (or other) layers, materials, or the like and in some cases may be optically dense.

The housing structure 104 may include a housing component 125. The housing component 125 may include a first metal segment 214 that defines a first wall and a second metal segment 216 that defines a second wall. The housing component 125 may also include a metal segment 282 that defines a rear panel 283 that extends between the first and second walls. The housing structure 104 may also include a metal segment that defines the protrusion 151, as described herein. In some cases, the housing component 125 is a unitary metal structure, which may be formed by attaching two or more separate metal structures (e.g., separate metal segments) together (e.g., via welding), or by forming the segments from a single piece of material (e.g., forging or machining the housing component 125). The first metal segment 214 and the second metal segment 216 may define first and second side exterior surfaces, respectively, of the device 100. The housing component 125 may also be referred to as or considered a segment (e.g., a metal segment) of a housing structure.

The housing structure 104 may also include housing components 124 and 126, which may be metal segments. The housing component (or metal segment) 126 may define a bottom side exterior surface of the device 100, as well as first and second corner surfaces of the device 100, and the housing component (or metal segment) 124 may define a top side exterior surface of the device 100, as well as third and fourth corner surfaces of the device 100. The housing components 124, 126 may be structurally coupled to the housing component 125 via the joint structures 122 (FIG. 1A).

The device 100 includes a chassis member 219. The chassis member 219 may be a separate component from the housing structure 104, and may be coupled to the housing structure 104, as described herein. The chassis member 219 may be set apart from the rear panel 283 by a gap. Various components of the device 100 may be positioned in the gap and coupled to the chassis member 219, while other components of the device 100 may be positioned in the gap and coupled to the rear panel 283. Thus, the housing configuration with the chassis member 219 and the rear panel 283 provides an interior device cavity with multiple parallel structural mounting surfaces or structures to which components may be coupled. The chassis member 219 may be coupled to the housing structure 104, as described herein, via fasteners (e.g., screws, bolts) to facilitate installation of various components and overall device manufacturing, and to facilitate removal of the chassis member 219 for service or other reasons. Thus, the chassis member 219 defines a load-bearing mounting structure (along with the rear panel 283), but is not permanently attached to the housing structure 104. As described herein, the battery 230 and the circuit board assembly 220 may be coupled to the chassis member 219, and may be set apart from the rear panel 283 by a gap. Since the chassis member 219 is not part of a unitary structure that also defines exterior surfaces of the device 100, the chassis member 219 may also be used to inhibit the spread of heat from heat-generating components to the exterior surfaces of the device. For example, heat-generating components, such as the battery 230 and circuit board assembly 220, may be coupled to the chassis member 219 (and set apart from the rear panel 283 by a gap). Thus, heat generated by those components may be preferentially transferred to the chassis member 219 (and the thermal spreading module 237, as described herein), rather than to the housing structure 104.

While the battery 230 and the circuit board assembly 220 may be coupled to the chassis member 219, other components may be coupled to the rear panel 283. For example, components such as the sensor array 141, speaker module 250, speaker system 224, haptic actuator 222, flash 148, depth sensor module 149, and the like, may be coupled to the rear panel 283 (e.g., along an inside or interior-facing surface of the rear panel 283).

In some cases, instead of being formed from multiple separate housing components attached together (e.g., a housing subassembly), the housing component 125 may be a unitary structure formed from a single piece of material. For example, the unitary structure of the housing component 125 may be a metal, such as aluminum, steel, titanium, or the like, and may be formed by extrusion, machining, and/or combinations of these and other forming processes. Thus, the housing segments 216 and 214 (which define side exterior surfaces of the device 100) and the chassis 219 may be different portions of a single piece of material. In some cases, the housing component 125 may be formed from separate components or segments that are attached to one another. For example, the housing segments 216, 214 may be formed as separate components from the chassis 219, and then the housing segments 216, 214 may be welded, brazed, soldered, adhered, or otherwise attached to the chassis 219 to form the housing component 125. As described herein, the housing segments 216, 214 may be bi-metal clad structures (e.g., a titanium cladding over an aluminum core), and the chassis 219 may be aluminum. The aluminum core portions of the clad structures may be welded to the aluminum chassis 219. In some cases, a structure defined by or including the housing segments 216, 214, 219 may be referred to as a housing segment.

As described above, the housing structure 104 may include housing components (e.g., metal segments) 124, 126, structurally joined together (and/or structurally joined to the housing component 125) via joint structures 122. The joint structures 122 (e.g., the material of the joint structures) may extend over inner surfaces of the housing components. More particularly, a portion of the joint structures 122 may contact, cover, encapsulate, and/or engage with retention features of the housing components that extend from the inner surfaces of the housing components. When coupled via the joint structures 122, the housing components 124, 125, 126 and the joint structures 122 may define a main housing assembly that defines the exterior side surfaces of the device 100 as well as the rear panel 283 of the device.

The chassis member 219 may define a hole 241 that is configured to receive a thermal spreading module 237. The thermal spreading module 237 may be thermally and structurally coupled to the chassis member 219, such as via welds along a flange portion of the thermal spreading module 237. The thermal spreading module 237 may be a vapor chamber. Components that are coupled to the chassis member 219, such as the circuit board assembly 220 and the battery 230, may also be thermally coupled to the thermal spreading module 237. The thermal spreading module 237 may be configured to distribute heat received from the circuit board assembly 220 and/or the battery 230. For example, the thermal spreading module 237 may receive heat from the circuit board assembly 220 and transfer the heat to other areas of the device, including the chassis member 219 itself, other areas of the thermal spreading module 237, in some cases the battery, and the like. The thermal spreading module 237 and the chassis member 219 may ultimately serve to extract heat from the circuit board assembly 220 (and optionally the battery 230), thereby improving the operation and/or longevity of the circuit board assembly 220 and/or its components (e.g., by allowing the circuit board assembly 220 (and its processors and other circuitry) to operate at a lower temperature, more efficiently, at a higher power level, etc.).

The device 100 may also include a button 117 that incorporates a touch sensor on an exterior surface. For example, the button 117 may detect force (or translational or press) inputs, and may also detect touch inputs applied to a button surface. Force inputs may be detected by a strain-sensing system, a switch member, or any other suitable force and/or translation sensor (and/or combinations of sensors, such as a collapsible dome switch in combination with a force sensor). Touch inputs may be detected by a touch-sensing system, such as capacitive touch-sensing systems. For example, the button member of the button 117 (e.g., the movable component that a user presses in order to actuate or provide an input to the button) may include a touch-sensing element positioned thereon. A button equipped with a touch-sensing element may detect various types of touch-based inputs, including static touch inputs (e.g., a finger touching the touch-sensitive button surface), dynamic touch inputs (e.g., a finger sliding along the touch-sensitive button surface, also referred to as gesture or swipe inputs), or the like. In some cases, the button 117 may include a touch-sensing element to detect such touch-based inputs. As described herein, the button 117 may operate in conjunction with a haptic actuation system, such as the haptic actuator 222, to produce tactile outputs in response to a detection of an input at the button 117 (e.g., force inputs, touch inputs, etc.).

As shown in FIG. 2, the device 100 includes one or more antennas that may be adapted to conduct wireless communication using a 5G communication protocol. For example, the device 100 may include an antenna module 247 that may include one or more antenna arrays that may be configured to transmit and receive wireless communication signals through an opening in a housing component, as described herein (e.g., through a top side of the device 100).

The antenna modules may include multiple antenna arrays. For example, the antenna modules may include one or more millimeter-wave antenna arrays. In the case where the antenna modules include multiple millimeter-wave antenna arrays (each of which may include one or more radiating elements), the multiple millimeter-wave antenna arrays may be configured to operate according to a diversity scheme (e.g., spatial diversity, pattern diversity, polarization diversity, or the like). The antenna modules may also include one or more ultra-wideband antennas.

The antenna arrays may be adapted to conduct millimeter-wave 5G communications and may be adapted to use or be used with beam-forming or other techniques to adapt signal reception depending on the use case. The device 100 may also include multiple antennas for conducting multiple-in multiple-out (MIMO) wireless communication schemes, including 4G, 4G LTE, and/or 5G MIMO communication protocols. As described herein, one or more of the housing components (or portions thereof) may be adapted to operate as antennas for a MIMO wireless communication scheme (or other wireless communication scheme).

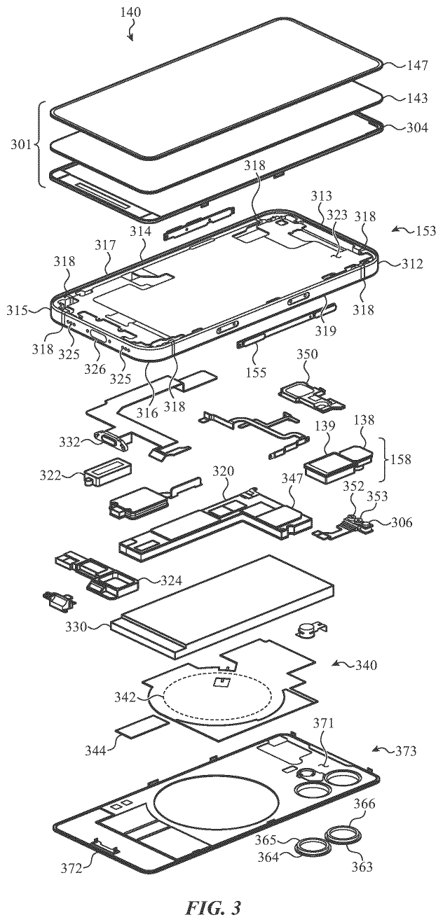

FIG. 3 depicts an exploded view of an example electronic device. In particular, FIG. 3 depicts an exploded view of the device 140, showing various components of the device 140 and example arrangements and configurations of the components.

As shown in FIG. 3, the device 140 includes a cover 147 (e.g., a front cover), which may be formed from or include a transparent or optically transmissive material. In some cases, the cover 147 is formed from or includes a glass material or other suitable transparent or optically transmissive material (e.g., a silicate-based material, an aluminosilicate glass, a boroaluminosilicate glass, an alkali metal aluminosilicate glass, a chemically strengthened glass, sapphire, ceramic, glass-ceramic, crystallizable glass materials, or plastic). In this example, the cover 147 may be formed from a glass-ceramic material. A glass-ceramic material may include both amorphous and crystalline or non-amorphous phases of one or more materials and may be formulated to improve strength or other properties of the cover 147. A glass-ceramic material may be a silicate-based glass-ceramic material, such as an aluminosilicate glass-ceramic material or a boroaluminosilicate glass-ceramic material. The glass-ceramic material may be chemically strengthened by ion exchange. In some cases, the cover 147 may include a sheet of chemically strengthened material having one or more coatings including an anti-reflective (AR) coating, an oleophobic coating, or other type of coating or optical treatment. In some cases, the cover 147 includes a sheet of material that is less than 1 mm thick. In some cases, the sheet of material is less than 0.80 mm. In some cases, the sheet of material is approximately 0.60 mm or less, or approximately 0.50 mm or less. The cover 147 may be chemically strengthened using an ion exchange process to form a compressive stress layer along exterior surfaces of the cover 147.

The cover 147 extends over a substantial entirety of the front surface of the device and may be positioned within an opening defined by the housing structure 153. In some cases, the edges or sides of the cover 147 may be surrounded by a protective flange or lip of the housing structure 153 without an interstitial component between the edges of the cover 147 and the respective flanges of the housing structure 153. This configuration may allow an impact or force applied to the housing structure 153 to be transferred to the cover 147 without directly transferring shear stress through the display 143 or frame 304.

As shown in FIG. 3, the display 143 is attached to an internal surface of the cover 147. The display 143 may include an edge-to-edge organic light-emitting diode (OLED) display that measures about 15.4 cm (6.1 inches) corner-to-corner. The perimeter or non-active area of the display 143 may be reduced to allow for very thin device borders around the active area of the display 143. In some cases, the display 143 allows for border regions of 1.5 mm or less. In some cases, the display 143 allows for border regions of 1 mm or less. In one example implementation, the border region is approximately 0.9 mm. The display 143 may have a relatively high pixel density of approximately 460 pixels per inch (PPI) or greater. In some cases, the display 143 has a pixel density of approximately 475 PPI. The display 143 may use a low temperature polycrystalline silicon (LTPS) or low temperature polycrystalline oxide (LTPO) backplane.

The display 143 may have an integrated (on-cell) touch-sensing system. For example, an array of electrodes (or other touch-sensing components) that are integrated into the OLED display may be time and/or frequency multiplexed in order to provide both display and touch-sensing functionality. The electrodes may be configured to detect a location of a touch, a gesture input, multi-touch input, or other types of touch input along the external surface of the cover 147. In some cases, the display 143 includes another type of display element, such as a liquid-crystal display (LCD) without an integrated touch-sensing system. That is, the device 140 may include one or more touch- and/or force-sensing components or layers that are positioned between the display 143 and the cover 147.

The display 143, also referred to as a display stack, may include always-on-display (AOD) functionality. For example, the display 143 may be configurable to allow designated regions or subsets of pixels to be displayed when the device 140 is powered on such that graphical content is visible to the user even when the device 140 is in a low-power or sleep mode. This may allow the time, date, battery status, recent notifications, and other graphical content to be displayed in a lower-power or sleep mode. This graphical content may be referred to as persistent or always-on graphical output. While some battery power may be consumed when displaying persistent or always-on graphical output, the power consumption is typically less than during normal or full-power operation of the display 143. This functionality may be enabled by only operating a subset of the display pixels and/or at a reduced resolution in order to reduce power consumption by the display 143.

The display 143 may include multiple layers, including touch-sensing layers or components, optional force-sensing layers or components, display layers, and the like. The display 143 may define a graphically active region in which graphical outputs may be displayed. In some cases, portions of the display 143 may include graphically inactive regions, such as portions of the display layers that do not include active display components (e.g., pixels) or are otherwise not configured to display graphical outputs. In some cases, graphically inactive regions may be located along the peripheral borders or other edges of the display 143.

As shown in FIG. 3, the device 140 may also include a frame member 304, also referred to simply as a frame 304, that is positioned below the cover 147 and that extends around an outer periphery of the display 143. The frame 304 may be attached to a lower or inner surface of the cover 147. A portion of the frame 304 may extend below the display 143 and may attach the cover 147 to the housing structure 153. Because the display 143 is attached to a lower or inner surface of the cover 147, the frame 304 may also be described as attaching both the display 143 and the cover 147 to the housing structure 153. The frame 304 may be formed of a polymer material, a metal material, or a combination of polymer and metal materials. The frame 304 may support elements of the display stack, provide anchor points for flexible circuits, and/or be used to mount other components and device elements. In some cases, the frame 304 includes one or more metal or conductive elements that provide shielding between device components, such as between the display stack (including display components and touch sensor components) and other components like the haptic actuator 322, the speaker system 324, and the like.

The cover 147, display or display stack 303, and frame member 304 may be part of a front cover assembly 301 of the device 140. The front cover assembly 301 (e.g., a front cover of the front cover assembly) may define a front exterior surface of the device. The cover 147 may define an interior surface opposite the exterior surface. The front cover assembly 301 may be assembled as a subassembly, which may then be attached to a housing component. For example, as described herein, the display 143 may be attached to the cover 147 (e.g., via a transparent adhesive), and the frame member 304 may be attached (e.g., via adhesive) to the cover around a periphery of the display stack 143. The front cover assembly 301 may then be attached to a housing component of the device 140 by mounting and adhering the frame member 304 to a ledge defined by the housing component.

The device 140 also includes a speaker module 350 that is configured to output sound via a speaker port. The speaker port may be positioned in and/or at least partially defined by a recess or notch formed along a side of the cover 147. As described herein, a trim piece may be positioned at least partially in the recess or notch to facilitate the output of sound while also inhibiting the ingress of debris, liquid, or other materials or contaminants into the device 140. Output from the speaker module 350 may pass through an audio passage or acoustic path defined at least in part by the speaker module 350 itself and the trim piece. In some cases, part of the acoustic path (e.g., between the speaker module 350 and the trim piece) is defined by the housing structure 153 and/or a molded material that is coupled to the housing structure 153. For example, a molded material (e.g., a fiber-reinforced polymer) may be molded against a metal portion of the housing structure 153 (e.g., the housing component 313, described herein). The molded material may also form one or more intermediate elements, such as joint structures, that also structurally join housing components together (e.g., the joint structures 318). A port or passage (e.g., a tube-like tunnel) may be defined through the molded material to acoustically couple the speaker module 350 to the trim piece and/or the recess more generally, thereby directing sound from the speaker module 350 to the exterior of the device 140.

As shown in FIG. 3, the device 140 also includes one or more cameras, optical emitters, and/or sensing elements that are configured to transmit signals, receive signals, or otherwise operate along the front surface of the device. In this example, the device 140 includes a front camera 306 that includes a high-resolution camera sensor. The front camera 306 may have a 12-megapixel resolution sensor with optical elements that provide an 85° field of view. The front camera 306 may have an aperture number of f/1.9. The front camera 306 may include autofocus functionality in which one or more of the lens elements move (e.g., up to about 100 microns perpendicular to the cover) in order to focus an image on the camera's sensor. In some cases, the autofocusing front-facing camera is capable of providing continuous autofocus functionality during video capture. The device 140 also includes an optical facial recognition system 352 that includes an infrared light projector (for projecting light) and an infrared light sensor that is configured to sense an array of depth points or regions along the face of the user. The array of depth points may be characterized as a unique signature or bio-identifier, which may be used to identify and/or authenticate the user and unlock the device 140 (and/or authorize functionality on the device 140 like the purchase of software apps or the use of payment functionality provided by the device 140).

The device 140 may also include one or more other sensors or components. For example, the device 140 may include a front light illuminator element for providing a flash or illumination for the front camera 306. The device 140 may also include an ambient light sensor (ALS) that is used to detect ambient light conditions for setting exposure aspects of the front camera 306 and/or for controlling the operation of the display. The device 140 may also include a proximity sensing system 353 for detecting the proximity of a user or other object to the device 140. In some cases, as described herein, the proximity sensing system 353 detects proximity to other objects through an active region of the display. The proximity sensing system 353 and the optical facial recognition system 352 may be integrated in a common module. In some cases, information from both the proximity sensing system and the ambient light sensor is used to determine ambient light conditions and/or the proximity of objects to the device 140. For example, information from the proximity sensing system may be used to determine whether a detection by the ambient light sensor of low ambient lighting is due to low ambient lighting, or an object locally or temporarily covering the ambient light sensor (e.g., a finger providing a touch input or a palm during a typing input). Information from both sensing systems may be used to disambiguate between potentially ambiguous conditions, and generally improve the accuracy with which the device can sense or detect certain conditions.

FIG. 3 also illustrates one or more cameras, optical emitters, and/or sensing elements that are configured to transmit signals, receive signals, or otherwise operate along the rear surface of the device. As depicted in FIG. 3, these elements may be part of the raised sensor array region 158 (which may also be referred to simply as a sensor array). In this example, the sensor array 158 includes a first camera 138 having a 48.8-megapixel image sensor (optionally with a three-layer sensor arrangement) and a wide-angle lens with an aperture number of f/1.6. The sensor array 158 may also include a second camera 139 having a 48-megapixel image sensor and a super-wide-angle lens (120° FOV) with an aperture number of f/2.2. The sensor array 158 also includes a light illuminator that may be used as a flash for photography or as an auxiliary light source (e.g., a flashlight). In some cases, the sensor array 158 also includes a microphone, an ambient light sensor, a depth sensing system, and/or other sensors that are adapted to sense along the rear surface of the device 140. The first and second cameras 138, 139 (and/or the camera lenses of the first and second cameras 138, 139) may be arranged (e.g., centered) on a line that extends along the y-direction of the device.

As shown in FIG. 3, the cameras 138 and 139 may be aligned with camera covers 363 and 364, respectively. The covers 363, 364 may be formed from a glass, glass-ceramic, or sapphire material and may provide a clear (e.g., transparent or optically transmissive) window through which the cameras 138 and 139 are able to capture a photographic image. In other cases, the covers 363, 364 are optical lenses that filter, magnify, or otherwise condition light received by the respective camera 138, 139. The other sensing or transmitting elements of the sensor array 158 may transmit and/or receive signals through a region of the rear or rear cover 372 or through a separate cover that is coupled to the rear cover 372. As shown in FIG. 3, the covers 363, 364 may extend beyond the exterior surface of the rear cover 372, and may define a recess along the interior side of the rear cover 372, such that the lenses or other elements of the cameras 138, 139 can extend into the respective recesses. In this way, the device 140 may accommodate a larger lens or other elements of the cameras 138, 139 than would be possible if the recess were not provided. In some cases, trim assemblies 365, 366 may be coupled to the rear cover 372 and may support the covers 363, 364.

The device 140 also includes a battery 330. The battery 330 provides electrical power to the device 140 and its various systems and components. The battery 330 may include a 4.40 V lithium-ion battery that is encased in a foil or other enclosing element (e.g., a rigid metal enclosure, as described with respect to the battery 230). The battery 330 may include a rolled electrode configuration, sometimes referred to as a “jelly roll” or a folded or stacked electrode configuration.

The battery 330 may be attached to the device 140 (e.g., to a chassis section 323) with one or more adhesives and/or other attachment techniques. In one example, the battery 330 may be attached to the chassis section 323, or another structure of the device 140, with an electrically debondable adhesive (e.g., an adhesive whose adhesion strength can be selectively reduced in response to an electric charge). In such cases, the adhesive may include conductive terminals that conductively contact the electrically debondable adhesive. When an electric current is applied to the electrically debondable adhesive (EDA) (e.g., by a user during a battery replacement operation), the adhesion strength of the adhesive may be reduced until the battery releases from the adhesive and/or the chassis section 323, or until the adhesion strength is sufficiently low that the battery can be easily removed by a user (e.g., without damage to the battery or other device components).

The battery 330 may be recharged via a charging port 332 (e.g., from a charging cable plugged into the charging port 332 through a charging access opening 326), and/or via a wireless charging system 340. The charging port 332 may be or may include a connector module. The battery 330 may be coupled to the charging port 332 and/or the wireless charging system 340 via battery control circuitry that controls the power provided to the battery and the power provided by the battery to the device 140. The battery 330 may include one or more lithium-ion battery cells or any other suitable type of rechargeable battery element.

The wireless charging system 340 may include a coil that inductively couples to an output or transmitting coil of a wireless charging accessory. The coil may provide current to the device 140 to charge the battery 330 and/or power the device. In this example, the wireless charging system 340 includes a coil assembly 342 that includes multiple wraps of a conductive wire or other conduit that is configured to produce a (charging) current in response to being placed in an inductive charging electromagnetic field produced by a separate wireless charging device or accessory. The coil assembly 342 also includes an array of magnetic elements that are arranged in a circular or radial pattern. The magnetic elements may help to locate the device 140 with respect to a separate wireless charging accessory or other device. In some implementations, the array of magnets also help to radially locate, orient, or “clock” the device 140 with respect to the separate wireless charging device or other accessory. For example, the array of magnets may include multiple magnetic elements having alternated magnetic polarity that are arranged in a radial pattern. The magnetic elements may be arranged to provide a magnetic coupling to the separate charging device in a particular orientation or set of discrete orientations to help locate the device 140 with respect to the separate charging device or other accessory. This functionality may be described as self-aligning or self-locating wireless charging. As shown in FIG. 3, the device 140 also includes a magnetic fiducial 344 for helping to locate the separate wireless charging device or accessory.

In one example, the magnetic fiducial 344 is adapted to magnetically couple to a separate wireless charging device or other accessory. By coupling to the separate wireless charging device/accessory, the rotational alignment of the device 140 and the separate wireless charging device/accessory may be maintained with respect to an absolute or single position. Also, by magnetically coupling the charging device/accessory to the rear surface of the device 140, the charging device or other accessory may be more securely coupled to the device 140.

In some implementations, the wireless charging system 340 includes an antenna or other element that detects the presence of a charging device or other accessory. In some cases, the charging system includes a near-field communications (NFC) antenna that is adapted to receive and/or send wireless communications between the device 140 and the wireless charger or other accessory. In some cases, the device 140 is adapted to perform wireless communications to detect or sense the presence of the wireless charger or other accessory without using a dedicated NFC antenna. The communications may also include information regarding the status of the device, the amount of charge held by the battery 330, and/or control signals to increase charging, decrease charging, start charging and/or stop charging for a wireless charging operation.

The wireless charging system 340 may also include one or more graphite layers (or other thermally conductive layers) that improve the thermal performance of the wireless charging system 340 and/or the device itself. For example, the graphite layers on the wireless charging system 340 may diffuse and/or distribute heat from the coil during charging operations. In some cases, the graphite layers may absorb and diffuse heat from other components, such as the battery 330.

The device 140 may also include a speaker system 324. The speaker system 324 may be positioned in the device 140 so that respective ports 325 are aligned with or otherwise proximate an audio output of the speaker system 324. Accordingly, sound that is output by the speaker system 324 exits the housing structure 153 via the respective ports 325. The speaker system 324 may include a speaker positioned in a housing that defines a speaker volume (e.g., an empty space in front of or behind a speaker diaphragm). The speaker volume may be used to tune the audio output from the speaker and optionally mitigate destructive interference of the sound produced by the speaker.

The device 140 may also include a haptic actuator 322. The haptic actuator 322 may include a movable mass and an actuation system that is configured to move the mass to produce a haptic output. The actuation system may include one or more coils and one or more magnets (e.g., permanent and/or electromagnets) that interact to produce motion. The magnets may be or may include recycled magnetic material.

When the coil(s) are energized, the coil(s) may cause the mass to move, which results in a force being imparted on the device 140. The motion of the mass may be configured to cause a vibration, pulse, tap, or other tactile output detectable via an exterior surface of the device 140. The haptic actuator 322 may be configured to move the mass linearly, though other movements (e.g., rotational) are also contemplated. Other types of haptic actuators may be used instead of or in addition to the haptic actuator 322.

The haptic actuator 322 may be configured such that the mass moves along the y-direction to produce a haptic output. In some cases, the particular movement of the mass along the y-direction is tuned to produce a tactile output that is perceptibly similar to a haptic actuator configured to move along the x-direction. Configuring the haptic actuator 322 so that the mass moves along the y-direction (instead of the x-direction, for example), may allow the haptic actuator 322 to be oriented primarily along the y-direction (e.g., the long axis of the haptic actuator 322 extends along the y-direction), which may allow greater packing efficiency of the components inside the device 140.

In some cases, the haptic actuator 322 is configured to produce a first haptic output in response to the device detecting that a force input applied to a button (e.g., a button with a strain- or other force-sensing element) satisfies a force threshold, and is also configured to produce a second haptic output in response to a notification event (e.g., an event that is associated with a haptic notification, or for which the device produces a haptic output upon occurrence). Thus, the same haptic actuator 322 may be used to produce haptics for notifications, as well as to simulate button presses or otherwise indicate that an input satisfying a force threshold has been received.

The device 140 also includes a circuit board assembly 320. The circuit board assembly 320 may include a substrate, and processors, memory, and other circuit elements coupled to the substrate. The circuit board assembly 320 may include multiple circuit substrates that are stacked and coupled together in order to maximize the area available for electronic components and circuitry in a compact form factor. The circuit board assembly 320 may include provisions for a subscriber identity module (SIM). The circuit board assembly 320 may include electrical contacts and/or a SIM tray assembly for receiving a physical SIM card and/or the circuit board assembly 320 may include provisions for an electronic SIM. Where an electronic SIM is used, a SIM tray may be omitted from the device 140 (e.g., the device may not include openings, trays, slots, doors, or other mechanical means to insert or otherwise access a SIM card). The circuit board assembly 320 may be wholly or partially encapsulated to reduce the chance of damage due to ingress of water or other fluid.

The circuit board assembly 320 may be thermally coupled to a chassis section 323 of the housing structure 153. As described herein, the chassis section 323, also referred to simply as a chassis 323, may be part of a housing segment 314 (e.g., a middle housing component) that is formed from a unitary structure and that defines the chassis 323 as well as a first wall section 317 that defines a first side exterior surface of the device 140, and a second wall section 319 that defines a second side exterior surface of the device 140. The circuit board assembly 320 may be thermally coupled to the chassis 323 via one or more thermal bridges, such as a graphite structure, a graphite-wrapped foam, or other thermally conductive structure(s). Heat from the circuit board assembly may be transferred to the chassis 323 via the thermal bridges, thereby removing heat from the circuit board assembly 320 (where heat may be detrimental to durability, performance, or the like), and also drawing heat away from exterior surfaces and/or components of the device 140 that come into contact with a user (e.g., the wall sections 317, 319, which define exterior side surfaces of the device and which may be held by a user when the device 140 is in use).

The circuit board assembly 320 may also include wireless communication circuitry, which may be operably coupled to and/or otherwise use the wall sections and/or housing components 312, 313, 317, 315, 316, or 319 (or portions thereof) as radiating members or structures to provide wireless communications. The circuit board assembly 320 may also include components such as accelerometers, gyroscopes, near-field communications circuitry and/or antennas, compasses, and the like. In some implementations, the circuit board assembly 320 may include a magnetometer that is adapted to detect and/or locate an accessory. For example, the magnetometer may be adapted to detect a magnetic (or non-magnetic) signal produced by an accessory of the device 140 or other device. The output of the magnetometer may include a direction output that may be used to display a directional indicia or other navigational guidance on the display 143 in order to guide the user toward a location of the accessory or other device.

The device 140 may also include one or more pressure transducers that may be operable to detect changes in external pressure in order to determine changes in altitude or height. The pressure sensors may be externally ported and/or positioned within a water-sealed internal volume of the housing structure 153. The output of the pressure sensors may be used to track flights of stairs climbed, a location (e.g., a floor) of a multi-story structure, movement performed during an activity in order to estimate physical effort or calories burned, or other relative movement of the device 140.

The circuit board assembly 320 may also include global positioning system (GPS) electronics that may be used to determine the location of the device 140 with respect to one or more satellites (e.g., a Global Navigation Satellite System (GNSS)) in order to estimate an absolute location of the device 140. In some implementations, the GPS electronics are operable to utilize dual frequency bands or ranges. For example, the GPS electronics may use L1 (L1C), L2 (L2C), L5, L1+L5, and other GPS signal bands in order to estimate the location of the device 140.

As shown in FIG. 3, the housing may include a cover 372 (e.g., rear or rear cover) that may define a substantial entirety of the rear surface of the device 140. The rear cover 372, the front cover 147, and the housing structure 153 may at least partially define an enclosure of the device 140, which may define an internal volume in which components of the device 140 are positioned. The cover 372 may be formed from or include a transparent or optically transmissive material. For example, the cover 372 may include a substrate formed from or including a glass material or other suitable material (e.g., a silicate-based material, an aluminosilicate glass, a boroaluminosilicate glass, an alkali metal aluminosilicate glass, a chemically strengthened glass, sapphire, ceramic, glass-ceramic, crystallizable glass materials, or plastic). A glass-ceramic material may be a silicate-based glass-ceramic material, such as an aluminosilicate glass-ceramic material or a boroaluminosilicate glass-ceramic material. The glass-ceramic material may be chemically strengthened by ion exchange. The substrate may have portions that are less than 1 mm thick. In some cases, the substrate has portions that are less than 0.80 mm. In some cases, the substrate has portions that are approximately 0.60 mm or less. The cover 372 may have a uniform thickness or, in some cases, may have a thickened or raised portion that surrounds the camera covers 363, 364. The rear cover 372 may be machined (e.g., ground) into a final shape before being polished and/or textured to provide the desired surface finish. The texture may be specially configured to provide a matte appearance while also being resistant to collecting a buildup of skin, lint, or other debris.

The cover 372 may be formed of a colored optically transmissive material, and may include a coating along an interior side of the cover 372 that, together with the color (or lack of color) of the optically transmissive material, defines the color of the rear side of the device. For example, a coating along an interior surface of the cover may include one or more color layers. The color layer may include a colorant such as a pigment or dye and may have a distinct hue or may be near neutral in color. Alternately, or additionally, the coating may include one or more opaque layers applied to the interior surface of the substrate (or otherwise positioned along the interior side of the substrate) to provide a particular appearance to the back side of the device. The opaque layer(s) may include a sheet, ink, dye, or combinations of these (or other) layers, materials, or the like and in some cases may be optically dense.

The cover 372 may be part of a rear cover assembly 373. The rear cover assembly 373 may be coupled to the housing structure 153. In some cases, the rear cover assembly 373 includes components such as camera covers 363 and 364, trim assemblies 365, 366, components of a wireless charging system, structural components (e.g., frames), other trim assemblies, mounting clips, and/or other components, systems, subsystems, and/or materials.

The rear cover assembly 373 may include a support plate 371 coupled to an interior surface of the rear cover 372. The support plate 371 may be coupled to the interior surface of the rear cover via an adhesive.

The support plate 371 may be formed of metal (e.g., aluminum), and may define a structural mounting surface for components of the rear cover assembly 373 (e.g., a wireless charging system). In some cases, the trim assemblies 365, 366 are secured to the support plate 371, such as via welding, soldering, brazing, or other suitable attachment means. The support plate 371 may be a unitary metal structure that spans substantially an entire interior surface of the rear cover 372 (e.g., including a wireless charger region and a rear-facing camera region). In other examples, the support plate 371 may be defined by multiple separate metal components. Where the support plate 371 is formed from multiple separate metal components, the metal components may be the same metal (e.g., all aluminum, or all stainless steel), or they may be different materials.

The support plate 371 may be thermally coupled to other device components, such as via thermal bridges, as described herein. Example thermal bridges include graphite wrapped foam (e.g., a graphite layer wrapped around a foam or other compliant material), conductive loops (e.g., a graphite or other thermally conductive layer on a loop structure formed by a substrate), direct metal-to-metal contacts, thermal paste or thermal gel, or the like. Thermal bridges may thermally couple the support plate 371 to components such as the circuit board assembly 320, the battery 330, and the sensor array 158. The support plate 371 may be formed of a thermally conductive material, such as a metal (e.g., aluminum), and heat from the other components may be transferred to the support plate 371. The support plate 371 may therefore act as a heat sink, and may also generally distribute the heat throughout the support plate 371, which may help reduce peak device or component temperatures.

Similar to the description above with respect to cover 147, the cover 372 may be positioned at least partially within an opening defined in the housing structure 153. Also similar to the description above with respect to cover 147, the edges or sides of the cover 372 may be surrounded by a protective flange or lip of the housing structure 153 without an interstitial component between the edges of the cover 372 and the respective flanges of the housing structure 153. The cover 372 may be chemically strengthened using an ion exchange process to form a compressive stress layer along exterior surfaces of the cover 372. In some cases, the (rear) cover 372 is formed from the same or a similar material as the (front) cover 147.

The rear cover 372 may be removably coupled to the rest of the housing structure 153 such that the rear cover 372 can be removed and/or replaced quickly and efficiently. In some cases, the wireless charging system 340 is the only component that is attached to the rear cover 372 that needs to be electrically coupled to the circuit board assembly 320 (which is coupled to the housing segment 314). Accordingly, the rear cover 372 may be completely removed from the device by unfastening the rear cover 372 from the remainder of the housing (e.g., from the housing segment 314) and decoupling the wireless charging system's electrical connector(s). In this way, the device 140 may provide improved reparability.

The housing structure 153 may include a housing segment 314 (e.g., a middle housing segment 314) that includes the wall sections 317 and 319 and the chassis section 323 (e.g., a metal plate-like structure that extends between the wall sections 317 and 319). The chassis 323 may define a mounting structure for components of the device 140. For example, as described herein, components such as the circuit board assembly 320, battery 330, sensor array 158, speaker module 350, speaker system 324, haptic actuator 322, and the like, may be coupled to the chassis 323 (e.g., along a rear-facing side of the chassis 323). By coupling components to the chassis 323 instead of the front cover assembly 301 and/or the rear cover 372, the cost and complexity of the front cover assembly 301 and rear cover assembly 373 may be reduced, and removal and/or replacement of the front cover assembly 301 and/or rear cover 372 may be simplified. The chassis 323 may also define one or more holes extending therethrough to facilitate the coupling of components on one side of the chassis 323 (e.g., the display 143 and/or sensors of the front cover assembly 301) to components on the other side of the chassis 323 (e.g., the circuit board assembly 320). Additionally, as noted above, the chassis 323 may also be thermally coupled to components of the device 140, such as the circuit board assembly 320, to conduct heat away from the thermally coupled components.

The housing segment 314 may be a unitary structure formed from a single piece of material. For example, the unitary structure of the housing segment 314 may be a metal, such as aluminum, steel, titanium, or the like, and may be formed by extrusion, machining, and/or combinations of these and other forming processes. Thus, the wall sections 317 and 319 (which define side exterior surfaces of the device 140) and the chassis 323 may be different portions of a single piece of material. In some cases, the housing segment 314 is formed of a polymer material, reinforced polymer material (e.g., fiber reinforced), carbon fiber, or other suitable material. In some cases, the wall sections 317, 319 may be separate housing components that are attached to the chassis 323.

As described above, the housing structure 153 may include housing components 312, 313, 315, and 316 structurally joined together and/or to the housing segment 314 (the middle housing segment 314) via joint structures 318. The joint structures 318 (e.g., the material of the joint structures) may extend over inner surfaces of the housing components. More particularly, a portion of the joint structures 318 may contact, cover, encapsulate, and/or engage with retention features of the housing components that extend from the inner surfaces of the housing components (including, for example, from the wall sections of the middle housing segment 314). As the wall sections 317 and 319 are part of a single unitary structure, the joint structures 318 may also function to structurally join the housing components 312, 313, 315, and 316 to the housing segment 314. When coupled via the joint structures 318, the housing segment 314, the housing components 312, 313, 315, and 316, and the joint structures 318 may define a main housing assembly that defines the exterior side surfaces of the device 140 as well as the chassis 323 within the device.

Housing components 312, 313, 315, and 316 may be formed from aluminum, stainless steel, or another metal. The housing components may also be formed from a clad structure that includes multiple materials (as described above).

In some cases, where holes are formed through the cladding and core portions of a clad housing component (e.g., for buttons, audio ports, charging ports, etc.), a seam between the cladding portion and the core portion may exist within the hole (e.g., along the hole surface). In some cases, the seam may be covered with another material, such as a paint, adhesive, polymer layer, or the like. Covering the seam may help prevent galvanic corrosion from occurring at the seam due to contact with water or another liquid.

In some cases, a metal deposition process is used to produce holes, through a clad housing component, that do not include seams along the hole surface. For example, a hole through the housing may be formed by first forming a hole only through the core material. Additional cladding material is then added into the hole (such as via a direct metal deposition process), such that the cladding material substantially fills the hole through the core portion. A final hole is then formed through the cladding material as well as the additional cladding material (which was added by the metal deposition process), such that the entire hole surface through the housing component is formed from cladding material (e.g., the core material does not define the hole surface). In this way, no seam between different metals exists in the hole, thereby mitigating the risk of galvanic corrosion within the hole.

As described herein, the housing components 312, 313, 315, and 316, and the wall sections 317, 319, may provide a robust and impact resistant sidewall for the device 140. In the present example, the housing components 312, 313, 315, and 316 and the wall sections 317, 319 define a flat sidewall that extends around the perimeter of the device 140. The flat sidewall may include rounded or chamfered edges that define the upper and lower edges of the sidewall of the housing structure 153. The housing components 312, 313, 315, and 316 and the wall sections 317, 319 may each have a flange portion or lip that extends around and at least partially covers a respective side of the front and rear covers 147, 372. There may be no interstitial material or elements between the flange portion or lip and the respective side surface of the front and rear covers 147, 372. This may allow forces or impacts that are applied to the housing structure 153 to be transferred to the front and rear covers 147, 372 without affecting the display or other internal structural elements, which may improve the drop performance of the device 140.

The device 140 may also include a button 155 that incorporates a touch sensor on an exterior surface. For example, the button 155 may detect force (or translational or press) inputs, and may also detect touch inputs applied to a button surface. Force inputs may be detected by a strain-sensing system, a switch member, or any other suitable force and/or translation sensor (and/or combinations of sensors, such as a collapsible dome switch in combination with a force sensor). Touch inputs may be detected by a touch-sensing system, such as capacitive touch-sensing systems. For example, the button member of the button 155 (e.g., the movable component that a user presses in order to actuate or provide an input to the button) may include a touch-sensing element positioned thereon. A button equipped with a touch-sensing element may detect various types of touch-based inputs, including static touch inputs (e.g., a finger touching the touch-sensitive button surface), dynamic touch inputs (e.g., a finger sliding along the touch-sensitive button surface, also referred to as gesture or swipe inputs), or the like. In some cases, the button 155 may include a touch-sensing element to detect such touch-based inputs. As described herein, the button 155 may operate in conjunction with a haptic actuation system, such as the haptic actuator 322, to produce tactile outputs in response to a detection of an input at the button 155 (e.g., force inputs, touch inputs, etc.).

As shown in FIG. 3, the device 140 includes multiple antennas that may be adapted to conduct wireless communication using a 5G communication protocol. For example, the device 140 may include an antenna module 347 that may include one or more antenna arrays that may be configured to transmit and receive wireless communication signals through the rear cover 372 and/or through another housing component of the device (e.g., a radio-frequency transmissive component of the device or housing). The antenna module may be attached to a back or bottom surface of the circuit board assembly 320.

The antenna modules may include multiple antenna arrays. For example, the antenna modules may include one or more millimeter-wave antenna arrays. In the case where the antenna modules include multiple millimeter-wave antenna arrays (each of which may include one or more radiating elements), the multiple millimeter-wave antenna arrays may be configured to operate according to a diversity scheme (e.g., spatial diversity, pattern diversity, polarization diversity, or the like). The antenna modules may also include one or more ultra-wideband antennas.

Each of the antenna arrays (e.g., the antenna array and the millimeter-wave arrays of the antenna module) may be adapted to conduct millimeter-wave 5G communications and may be adapted to use or be used with beam-forming or other techniques to adapt signal reception depending on the use case. The device 140 may also include multiple antennas for conducting multiple-in multiple-out (MIMO) wireless communication schemes, including 4G, 4G LTE, and/or 5G MIMO communication protocols. As described herein, one or more of the housing components 312, 313, 315, and 316 and the wall sections 317, 319 (or portions thereof) may be adapted to operate as antennas for a MIMO wireless communication scheme (or other wireless communication scheme).

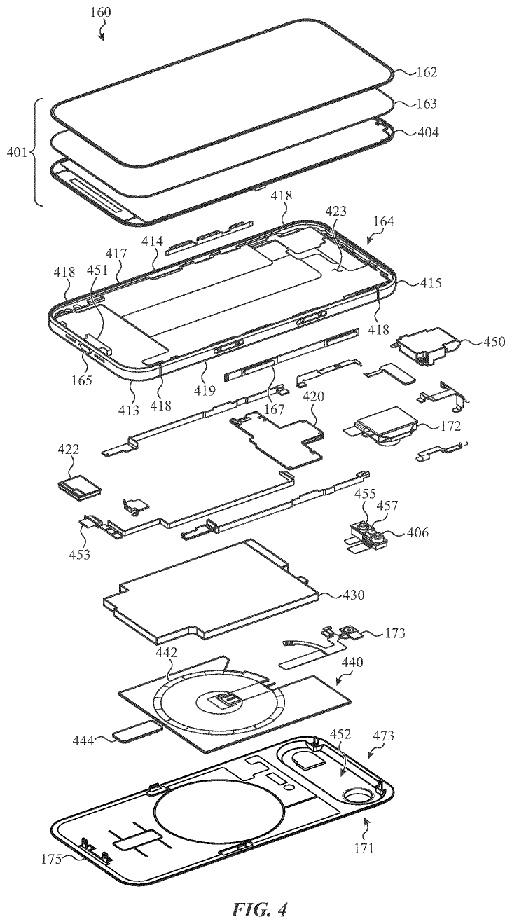

FIG. 4 depicts an exploded view of an example electronic device. In particular, FIG. 4 depicts an exploded view of a device 160, showing various components of the device 160 and example arrangements and configurations of the components.

As shown in FIG. 4, the device 160 includes a cover 162 (e.g., a front cover), which may be formed from or include a transparent or optically transmissive material. In some cases, the cover 162 is formed from or includes a glass material or other suitable transparent or optically transmissive material (e.g., a silicate-based material, an aluminosilicate glass, a boroaluminosilicate glass, an alkali metal aluminosilicate glass, a chemically strengthened glass, sapphire, ceramic, glass-ceramic, crystallizable glass materials, or plastic). In this example, the cover 162 may be formed from a glass-ceramic material. A glass-ceramic material may include both amorphous and crystalline or non-amorphous phases of one or more materials and may be formulated to improve strength or other properties of the cover 162. A glass-ceramic material may be a silicate-based glass-ceramic material, such as an aluminosilicate glass-ceramic material or a boroaluminosilicate glass-ceramic material. The glass-ceramic material may be chemically strengthened by ion exchange. In some cases, the cover 162 may include a sheet of chemically strengthened material having one or more coatings including an anti-reflective (AR) coating, an oleophobic coating, or other type of coating or optical treatment. In some cases, the cover 162 includes a sheet of material that is less than 1 mm thick. In some cases, the sheet of material is less than 0.80 mm. In some cases, the sheet of material is approximately 0.60 mm or less, or approximately 0.50 mm or less. The cover 162 may be chemically strengthened using an ion exchange process to form a compressive stress layer along exterior surfaces of the cover 162.

The cover 162 extends over a substantial entirety of the front surface of the device and may be positioned within an opening defined by the housing structure 164. In some cases, the edges or sides of the cover 162 may be surrounded by a protective flange or lip of the housing structure 164 without an interstitial component between the edges of the cover 162 and the respective flanges of the housing structure 164. This configuration may allow an impact or force applied to the housing structure 164 to be transferred to the cover 162 without directly transferring shear stress through the display 163 or frame 404.

As shown in FIG. 4, the display 163 is attached to an internal surface of the cover 162. The display 163 may include an edge-to-edge organic light-emitting diode (OLED) display that measures about 15.4 cm (6.1 inches) corner-to-corner. The perimeter or non-active area of the display 163 may be reduced to allow for very thin device borders around the active area of the display 163. In some cases, the display 163 allows for border regions of 1.5 mm or less. In some cases, the display 163 allows for border regions of 1 mm or less. In one example implementation, the border region is approximately 0.9 mm. The display 163 may have a relatively high pixel density of approximately 460 pixels per inch (PPI) or greater. In some cases, the display 163 has a pixel density of approximately 475 PPI. The display 163 may use a low temperature polycrystalline silicon (LTPS) or low temperature polycrystalline oxide (LTPO) backplane.

The display 163 may have an integrated (on-cell) touch-sensing system. For example, an array of electrodes (or other touch-sensing components) that are integrated into the OLED display may be time and/or frequency multiplexed in order to provide both display and touch-sensing functionality. The electrodes may be configured to detect a location of a touch, a gesture input, multi-touch input, or other types of touch input along the external surface of the cover 162. In some cases, the display 163 includes another type of display element, such as a liquid-crystal display (LCD) without an integrated touch-sensing system. That is, the device 160 may include one or more touch- and/or force-sensing components or layers that are positioned between the display 163 and the cover 162.

The display 163, also referred to as a display stack, may include always-on-display (AOD) functionality. For example, the display 163 may be configurable to allow designated regions or subsets of pixels to be displayed when the device 160 is powered on such that graphical content is visible to the user even when the device 160 is in a low-power or sleep mode. This may allow the time, date, battery status, recent notifications, and other graphical content to be displayed in a lower-power or sleep mode. This graphical content may be referred to as persistent or always-on graphical output. While some battery power may be consumed when displaying persistent or always-on graphical output, the power consumption is typically less than during normal or full-power operation of the display 163. This functionality may be enabled by only operating a subset of the display pixels and/or at a reduced resolution in order to reduce power consumption by the display 163.

The display 163 may include multiple layers, including touch-sensing layers or components, optional force-sensing layers or components, display layers, and the like. The display 163 may define a graphically active region in which graphical outputs may be displayed. In some cases, portions of the display 163 may include graphically inactive regions, such as portions of the display layers that do not include active display components (e.g., pixels) or are otherwise not configured to display graphical outputs. In some cases, graphically inactive regions may be located along the peripheral borders or other edges of the display 163.

As shown in FIG. 4, the device 160 may also include a frame member 404, also referred to simply as a frame 404, that is positioned below the cover 162 and that extends around an outer periphery of the display 163. The frame 404 may be attached to a lower or inner surface of the cover 162. A portion of the frame 404 may extend below the display 163 and may attach the cover 162 to the housing structure 164. Because the display 163 is attached to a lower or inner surface of the cover 162, the frame 404 may also be described as attaching both the display 163 and the cover 162 to the housing structure 164. The frame 404 may be formed of a polymer material, a metal material, or a combination of polymer and metal materials. The frame 404 may support elements of the display stack, provide anchor points for flexible circuits, and/or be used to mount other components and device elements. In some cases, the frame 404 includes one or more metal or conductive elements that provide shielding between device components, such as between the display stack (including display components and touch sensor components) and other components like the haptic actuator 422, a speaker system, and the like.

The cover 162, display or display stack 163, and frame member 404 may be part of a front cover assembly 401 of the device 160. The front cover assembly 401 (e.g., a front cover of the front cover assembly) may define a front exterior surface of the device. The cover 162 may define an interior surface opposite the exterior surface. The front cover assembly 401 may be assembled as a subassembly, which may then be attached to a housing component. For example, as described herein, the display 163 may be attached to the cover 162 (e.g., via a transparent adhesive), and the frame member 404 may be attached (e.g., via adhesive) to the cover around a periphery of the display stack 163. The front cover assembly 401 may then be attached to a housing component of the device 160 by mounting and adhering the frame member 404 to a ledge defined by the housing component.

The device 160 also includes a speaker module 450 that is configured to output sound via a speaker port. The speaker port may be positioned in and/or at least partially defined by a recess or notch formed along a side of the cover 162. As described herein, a trim piece may be positioned at least partially in the recess or notch to facilitate the output of sound while also inhibiting the ingress of debris, liquid, or other materials or contaminants into the device 160. Output from the speaker module 450 may pass through an audio passage or acoustic path defined at least in part by the speaker module 450 itself and the trim piece. In some cases, part of the acoustic path (e.g., between the speaker module 450 and the trim piece) is defined by the housing structure 164 and/or a molded material that is coupled to the housing structure 164. For example, a molded material (e.g., a fiber-reinforced polymer) may be molded against a metal portion of the housing structure 164 (e.g., the housing component 415, described herein). The molded material may also form one or more intermediate elements, such as joint structures, that also structurally join housing components together (e.g., the joint structures 418). A port or passage (e.g., a tube-like tunnel) may be defined through the molded material to acoustically couple the speaker module 450 to the trim piece and/or the recess more generally, thereby directing sound from the speaker module 450 to the exterior of the device 160.

As shown in FIG. 4, the device 160 also includes one or more cameras, optical emitters, and/or sensing elements that are configured to transmit signals, receive signals, or otherwise operate along the front surface of the device. In this example, the device 160 includes a front camera 406 that includes a high-resolution camera sensor. The front camera 406 may have a 24-megapixel resolution sensor with optical elements that provide an 95° field of view. The front camera 406 may have an aperture number of f/1.9. The front camera 406 may include autofocus functionality in which one or more of the lens elements move (e.g., up to about 100 microns perpendicular to the cover) in order to focus an image on the camera's sensor. In some cases, the autofocusing front-facing camera is capable of providing continuous autofocus functionality during video capture. The device 160 also includes an optical facial recognition system 455 that includes an infrared light projector (for projecting light) and an infrared light sensor that is configured to sense an array of depth points or regions along the face of the user. The array of depth points may be characterized as a unique signature or bio-identifier, which may be used to identify and/or authenticate the user and unlock the device 160 (and/or authorize functionality on the device 160 like the purchase of software apps or the use of payment functionality provided by the device 160).

The device 160 may also include one or more other sensors or components. For example, the device 160 may include a front light illuminator element for providing a flash or illumination for the front camera 406. The device 160 may also include an ambient light sensor (ALS) that is used to detect ambient light conditions for setting exposure aspects of the front camera 406 and/or for controlling the operation of the display. The device 160 may also include a proximity sensing system 457 for detecting the proximity of a user or other object to the device 160. In some cases, as described herein, the proximity sensing system 457 detects proximity to other objects through an active region of the display. The proximity sensing system 457 and the optical facial recognition system 455 may be integrated in a common module. In some cases, information from both the proximity sensing system and the ambient light sensor is used to determine ambient light conditions and/or the proximity of objects to the device 160. For example, information from the proximity sensing system may be used to determine whether a detection by the ambient light sensor of low ambient lighting is due to low ambient lighting, or an object locally or temporarily covering the ambient light sensor (e.g., a finger providing a touch input or a palm during a typing input). Information from both sensing systems may be used to disambiguate between potentially ambiguous conditions, and generally improve the accuracy with which the device can sense or detect certain conditions.

FIG. 4 also illustrates one or more cameras, optical emitters, and/or sensing elements that are configured to transmit signals, receive signals, or otherwise operate along the rear surface of the device. As depicted in FIG. 4, these elements may be part of the sensor array 171. In this example, the sensor array 171 includes a camera 172 having a 48-megapixel image sensor (optionally with a three-layer sensor arrangement) and a lens with an aperture number of f/1.6. The lens may be a wide angle lens, with a field of view of about 120°, about 110°, about 100°, about 90°, or another suitable field of view. The sensor array 171 also includes a light illuminator (e.g., flash 173) that may be used as a flash for photography or as an auxiliary light source (e.g., a flashlight). In some cases, the sensor array 171 also includes a microphone 170, an ambient light sensor, a depth sensing system, and/or other sensors that are adapted to sense along the rear surface of the device 160.

As shown in FIG. 4, the camera 172 may be aligned with a camera cover, which may be formed from a glass, glass-ceramic, or sapphire material and may provide a clear (e.g., transparent or optically transmissive) window through which the camera 172 is able to capture a photographic image.

The device 160 also includes a battery 430. The battery 430 provides electrical power to the device 160 and its various systems and components. The battery 430 may include a 4.40 V lithium-ion battery that is encased in a foil or other enclosing element (e.g., a rigid metal enclosure, as described with respect to the battery 230). The battery 430 may include a rolled electrode configuration, sometimes referred to as a “jelly roll” or a folded or stacked electrode configuration.

The battery 430 may be attached to the device 160 (e.g., to a chassis section 423) with one or more adhesives and/or other attachment techniques. In one example, the battery 430 may be attached to the chassis section 423, or another structure of the device 160, with an electrically debondable adhesive (e.g., an adhesive whose adhesion strength can be selectively reduced in response to an electric charge). In such cases, the adhesive may include conductive terminals that conductively contact the electrically debondable adhesive. When an electric current is applied to the electrically debondable adhesive (EDA) (e.g., by a user during a battery replacement operation), the adhesion strength of the adhesive may be reduced until the battery releases from the adhesive and/or the chassis section 423, or until the adhesion strength is sufficiently low that the battery can be easily removed by a user (e.g., without damage to the battery or other device components).

The battery 430 may be recharged via a charging port 165 (e.g., from a charging cable plugged into the charging port 165 through a charging access opening through the housing structure 164), and/or via a wireless charging system 440. The charging port 165 may be positioned along a bottom side of the device 160. A port structure 451 may extend from an interior side of the metal segment and define at least a portion of an interior wall of the charging port 165, while a charging cable connector 453 may be coupled to the housing structure and may include a connection member extending into the charging port 165. The port structure 451 may be integrally formed with the housing structure 164, and may define the wall structure of the charging port 165, into which a charging connector extends to charge the device (and/or transfer data to/from the device). The port structure 451 may be a metal port structure, and may be formed from the same material (e.g., metal) as the portion of the housing segment to which it is coupled (or integrally formed).

The battery 430 may be coupled to the charging port 165 and/or the wireless charging system 440 via battery control circuitry that controls the power provided to the battery and the power provided by the battery to the device 160. The battery 430 may include one or more lithium-ion battery cells or any other suitable type of rechargeable battery element.

The wireless charging system 440 may include a coil that inductively couples to an output or transmitting coil of a wireless charging accessory. The coil may provide current to the device 160 to charge the battery 430 and/or power the device. In this example, the wireless charging system 440 includes a coil assembly 442 that includes multiple wraps of a conductive wire or other conduit that is configured to produce a (charging) current in response to being placed in an inductive charging electromagnetic field produced by a separate wireless charging device or accessory. The coil assembly 442 also includes an array of magnetic elements that are arranged in a circular or radial pattern. The magnetic elements may help to locate the device 160 with respect to a separate wireless charging accessory or other device. In some implementations, the array of magnets also help to radially locate, orient, or “clock” the device 160 with respect to the separate wireless charging device or other accessory. For example, the array of magnets may include multiple magnetic elements having alternated magnetic polarity that are arranged in a radial pattern. The magnetic elements may be arranged to provide a magnetic coupling to the separate charging device in a particular orientation or set of discrete orientations to help locate the device 160 with respect to the separate charging device or other accessory. This functionality may be described as self-aligning or self-locating wireless charging. As shown in FIG. 4, the device 160 also includes a magnetic fiducial 444 for helping to locate the separate wireless charging device or accessory.

In one example, the magnetic fiducial 444 is adapted to magnetically couple to a separate wireless charging device or other accessory. By coupling to the separate wireless charging device/accessory, the rotational alignment of the device 160 and the separate wireless charging device/accessory may be maintained with respect to an absolute or single position. Also, by magnetically coupling the charging device/accessory to the rear surface of the device 160, the charging device or other accessory may be more securely coupled to the device 160.

In some implementations, the wireless charging system 440 includes an antenna or other element that detects the presence of a charging device or other accessory. In some cases, the charging system includes a near-field communications (NFC) antenna that is adapted to receive and/or send wireless communications between the device 160 and the wireless charger or other accessory. In some cases, the device 160 is adapted to perform wireless communications to detect or sense the presence of the wireless charger or other accessory without using a dedicated NFC antenna. The communications may also include information regarding the status of the device, the amount of charge held by the battery 430, and/or control signals to increase charging, decrease charging, start charging and/or stop charging for a wireless charging operation.

The wireless charging system 440 may also include one or more graphite layers (or other thermally conductive layers) that improve the thermal performance of the wireless charging system 440 and/or the device itself. For example, the graphite layers on the wireless charging system 440 may diffuse and/or distribute heat from the coil during charging operations. In some cases, the graphite layers may absorb and diffuse heat from other components, such as the battery 430.

The device 160 may also include a haptic actuator 422. The haptic actuator 422 may include a movable mass and an actuation system that is configured to move the mass to produce a haptic output. The actuation system may include one or more coils and one or more magnets (e.g., permanent and/or electromagnets) that interact to produce motion. The magnets may be or may include recycled magnetic material.

When the coil(s) are energized, the coil(s) may cause the mass to move, which results in a force being imparted on the device 160. The motion of the mass may be configured to cause a vibration, pulse, tap, or other tactile output detectable via an exterior surface of the device 160. The haptic actuator 422 may be configured to move the mass linearly, though other movements (e.g., rotational) are also contemplated. Other types of haptic actuators may be used instead of or in addition to the haptic actuator 422.

The haptic actuator 422 may be configured such that the mass moves along the y-direction to produce a haptic output. In some cases, the particular movement of the mass along the y-direction is tuned to produce a tactile output that is perceptibly similar to a haptic actuator configured to move along the x-direction.

In some cases, the haptic actuator 422 is configured to produce a first haptic output in response to the device detecting that a force input applied to a button (e.g., a button with a strain- or other force-sensing element) satisfies a force threshold, and is also configured to produce a second haptic output in response to a notification event (e.g., an event that is associated with a haptic notification, or for which the device produces a haptic output upon occurrence). Thus, the same haptic actuator 422 may be used to produce haptics for notifications, as well as to simulate button presses or otherwise indicate that an input satisfying a force threshold has been received.

The device 160 also includes a circuit board assembly 420. The circuit board assembly 420 may include a substrate, and processors, memory, and other circuit elements coupled to the substrate. The circuit board assembly 420 may include multiple circuit substrates that are stacked and coupled together in order to maximize the area available for electronic components and circuitry in a compact form factor. In some cases, the circuit board assembly 420 includes a bi-level structure, in which a first portion of the circuit board assembly 420 has two substrates in a stacked configuration, and a second portion of the circuit board assembly 420 has a single substrate configuration. A shielding structure may be coupled to the circuit board assembly 420 to cover an opening of the stacked portion of the circuit board assembly 420, as described herein. The bi-level structure may be configured so that the stacked portion extends into a recess 452 formed along an interior side of the rear cover 175, while the single-substrate portion fits in the smaller space outside of the recess 452, as described herein.

The circuit board assembly 420 may include provisions for a subscriber identity module (SIM). The circuit board assembly 420 may include provisions for an electronic SIM. The circuit board assembly 420 may be wholly or partially encapsulated to reduce the chance of damage due to ingress of water or other fluid.

The circuit board assembly 420 may be thermally (and structurally) coupled to a chassis section 423 of the housing structure 164. As described herein, the chassis section 423, also referred to simply as a chassis 423, may be part of a housing segment 414 (e.g., a middle housing component) that is formed from a unitary structure and that defines the chassis 423 as well as a first wall section 417 that defines a first side exterior surface of the device 160, and a second wall section 419 that defines a second side exterior surface of the device 160. The circuit board assembly 420 may be thermally coupled to the chassis 423 via one or more thermal bridges, such as a graphite structure, a graphite-wrapped foam, or other thermally conductive structure(s). Heat from the circuit board assembly may be transferred to the chassis 423 via the thermal bridges, thereby removing heat from the circuit board assembly 420 (where heat may be detrimental to durability, performance, or the like), and also drawing heat away from exterior surfaces and/or components of the device 160 that come into contact with a user (e.g., the wall sections 417, 419, which define exterior side surfaces of the device and which may be held by a user when the device 160 is in use).

The circuit board assembly 420 may also include wireless communication circuitry, which may be operably coupled to and/or otherwise use the wall sections and/or housing components 413, 415, 417, or 419 (or portions thereof) as radiating members or structures to provide wireless communications. The circuit board assembly 420 may also include components such as accelerometers, gyroscopes, near-field communications circuitry and/or antennas, compasses, and the like. In some implementations, the circuit board assembly 420 may include a magnetometer that is adapted to detect and/or locate an accessory. For example, the magnetometer may be adapted to detect a magnetic (or non-magnetic) signal produced by an accessory of the device 160 or other device. The output of the magnetometer may include a direction output that may be used to display a directional indicia or other navigational guidance on the display 163 in order to guide the user toward a location of the accessory or other device.

The device 160 may also include one or more pressure transducers that may be operable to detect changes in external pressure in order to determine changes in altitude or height. The pressure sensors may be externally ported and/or positioned within a water-sealed internal volume of the housing structure 164. The output of the pressure sensors may be used to track flights of stairs climbed, a location (e.g., a floor) of a multi-story structure, movement performed during an activity in order to estimate physical effort or calories burned, or other relative movement of the device 160.

The circuit board assembly 420 may also include global positioning system (GPS) electronics that may be used to determine the location of the device 160 with respect to one or more satellites (e.g., a Global Navigation Satellite System (GNSS)) in order to estimate an absolute location of the device 160. In some implementations, the GPS electronics are operable to utilize dual frequency bands or ranges. For example, the GPS electronics may use L1 (L1C), L2 (L2C), L5, L1+L5, and other GPS signal bands in order to estimate the location of the device 160.

As shown in FIG. 4, the housing may include a cover 175 (e.g., rear or rear cover) that may define a substantial entirety of the rear surface of the device 160. The rear cover 175, the front cover 162, and the housing structure 164 may at least partially define an enclosure of the device 160, which may define an internal volume in which components of the device 160 are positioned. The cover 175 may be formed from or include a transparent or optically transmissive material. For example, the cover 175 may include a substrate formed from or including a glass material or other suitable material (e.g., a silicate-based material, an aluminosilicate glass, a boroaluminosilicate glass, an alkali metal aluminosilicate glass, a chemically strengthened glass, sapphire, ceramic, glass-ceramic, crystallizable glass materials, or plastic). A glass-ceramic material may be a silicate-based glass-ceramic material, such as an aluminosilicate glass-ceramic material or a boroaluminosilicate glass-ceramic material. The glass-ceramic material may be chemically strengthened by ion exchange. The substrate may have portions that are less than 1 mm thick. In some cases, the substrate has portions that are less than 0.80 mm. In some cases, the substrate has portions that are approximately 0.60 mm or less. The cover 175 may have a uniform thickness or, in some cases, may have a different thickness at the recess 452 than at the surrounding portion of the cover 175. The rear cover 175 may be machined (e.g., ground) into a final shape before being polished and/or textured to provide the desired surface finish. The texture may be specially configured to provide a matte appearance while also being resistant to collecting a buildup of skin, lint, or other debris.

The cover 175 may be formed of a colored optically transmissive material, and may include a coating along an interior side of the cover 175 that, together with the color (or lack of color) of the optically transmissive material, defines the color of the rear side of the device. For example, a coating along an interior surface of the cover may include one or more color layers. The color layer may include a colorant such as a pigment or dye and may have a distinct hue or may be near neutral in color. Alternately, or additionally, the coating may include one or more opaque layers applied to the interior surface of the substrate (or otherwise positioned along the interior side of the substrate) to provide a particular appearance to the back side of the device. The opaque layer(s) may include a sheet, ink, dye, or combinations of these (or other) layers, materials, or the like and in some cases may be optically dense.

The cover 175 may be part of a rear cover assembly 473. The rear cover assembly 473 may be coupled to the housing structure 164. In some cases, the rear cover assembly 473 includes components such as a camera cover, a camera trim assembly, components of a wireless charging system, structural components (e.g., frames), other trim assemblies, mounting clips, and/or other components, systems, subsystems, and/or materials.

Similar to the description above with respect to cover 162, the cover 175 may be positioned at least partially within an opening defined in the housing structure 164. Also similar to the description above with respect to cover 162, the edges or sides of the cover 175 may be surrounded by a protective flange or lip of the housing structure 164 without an interstitial component between the edges of the cover 175 and the respective flanges of the housing structure 164. The cover 175 may be chemically strengthened using an ion exchange process to form a compressive stress layer along exterior surfaces of the cover 175. In some cases, the (rear) cover 175 is formed from the same or a similar material as the (front) cover 162.

The housing structure 164 may include a housing segment 414 (e.g., a middle housing segment 414) that includes the wall sections 417 and 419 and the chassis section 423 (e.g., a metal plate-like structure that extends between the wall sections 417 and 419). The chassis 423 may define a mounting structure for components of the device 160. For example, as described herein, components such as the circuit board assembly 420, battery 430, sensor array 171, speaker module 450, haptic actuator 422, and the like, may be coupled to the chassis 423 (e.g., along a rear-facing side of the chassis 423). By coupling components to the chassis 423 instead of the front cover assembly 401 and/or the rear cover assembly 473, the cost and complexity of the front cover assembly 401 and rear cover assembly 473 may be reduced, and removal and/or replacement of the front cover assembly 401 and/or rear cover assembly 473 may be simplified. The chassis 423 may also define one or more holes extending therethrough to facilitate the coupling of components on one side of the chassis 423 (e.g., the display 163 and/or sensors of the front cover assembly 401) to components on the other side of the chassis 423 (e.g., the circuit board assembly 420). Additionally, as noted above, the chassis 423 may also be thermally coupled to components of the device 160, such as the circuit board assembly 420, to conduct heat away from the thermally coupled components.

The housing segment 414 may be a unitary structure formed from a single piece of material. For example, the unitary structure of the housing segment 414 may be a metal, such as aluminum, steel, titanium, or the like, and may be formed by extrusion, machining, and/or combinations of these and other forming processes. Thus, the wall sections 417 and 419 (which define side exterior surfaces of the device 160) and the chassis 423 may be different portions of a single piece of material. In some cases, the housing segment 414 is formed of a polymer material, reinforced polymer material (e.g., fiber reinforced), carbon fiber, or other suitable material. In some cases, the wall sections 417, 419 may be separate housing components that are attached to the chassis 423, similar to the construction of the housing segment 314 described above. In some cases, the housing segment 414 may be formed from separate components that are attached to one another. For example, the housing components 417, 419 (e.g., the wall sections) may be formed as separate components from the chassis 423, and then the housing components 417, 419 may be welded, brazed, soldered, adhered, or otherwise attached to the chassis 426 to form the housing segment 414. The housing components 417, 419 may be bi-metal clad structures (e.g., a titanium cladding over an aluminum core), and the chassis 423 may be aluminum. The aluminum core portions of the clad structures may be welded to the aluminum chassis 423.

The housing structure 164 may also include metal segments 413 and 415. The metal segment 413 may define a bottom side exterior surface of the device 160, as well as first and second corner surfaces of the device 160, and the metal segment 415 may define a top side exterior surface of the device 160, as well as third and fourth corner surfaces of the device 160. The metal segments 413, 415 may be structurally coupled to the housing segment 414 (e.g., the wall sections 417, 419, and or the chassis 423) via the joint structures 418.

The joint structures 418 (e.g., the material of the joint structures) may extend over inner surfaces of the housing components. More particularly, a portion of the joint structures 418 may contact, cover, encapsulate, and/or engage with retention features of the housing components that extend from the inner surfaces of the housing components (including, for example, from the wall sections of the middle housing segment 414). The joint structures 418 may also function to structurally join the housing components 413, 415 to the housing segment 414. When coupled via the joint structures 418, the housing segment 414, the housing components 413, 415, and the joint structures 418 may define a main housing assembly that defines the exterior side surfaces of the device 160 as well as the chassis 423 within the device.

In some cases, where holes are formed through the cladding and core portions of a clad housing component (e.g., for buttons, audio ports, charging ports, etc.), a seam between the cladding portion and the core portion may exist within the hole (e.g., along the hole surface). In some cases, the seam may be covered with another material, such as a paint, adhesive, polymer layer, or the like. Covering the seam may help prevent galvanic corrosion from occurring at the seam due to contact with water or another liquid. Such construction may be used in any clad housing components described herein.

In some cases, a metal deposition process is used to produce holes, through a clad housing component, that do not include seams along the hole surface. For example, a hole through the housing may be formed by first forming a hole only through the core material. Additional cladding material is then added into the hole (such as via a direct metal deposition process), such that the cladding material substantially fills the hole through the core portion. A final hole is then formed through the cladding material as well as the additional cladding material (which was added by the metal deposition process), such that the entire hole surface through the housing component is formed from cladding material (e.g., the core material does not define the hole surface). In this way, no seam between different metals exists in the hole, thereby mitigating the risk of galvanic corrosion within the hole. Such construction may be used in any clad housing components described herein.

As described herein, the housing components 413, 415 and the wall sections 417, 419, may provide a robust and impact resistant sidewall for the device 160. In the present example, the housing components 413, 415 and the wall sections 417, 419 define a flat sidewall that extends around the perimeter of the device 160. The flat sidewall may include rounded or chamfered edges that define the upper and lower edges of the sidewall of the housing structure 164. The housing components 413, 415 and the wall sections 417, 419 may each have a flange portion or lip that extends around and at least partially covers a respective side of the front and rear covers 162, 175. There may be no interstitial material or elements between the flange portion or lip and the respective side surface of the front and rear covers 162, 175. This may allow forces or impacts that are applied to the housing structure 164 to be transferred to the front and rear covers 162, 175 without affecting the display or other internal structural elements, which may improve the drop performance of the device 160.

The device 160 may also include a button 167 that incorporates a touch sensor on an exterior surface. For example, the button 167 may detect force (or translational or press) inputs, and may also detect touch inputs applied to a button surface. Force inputs may be detected by a strain-sensing system, a switch member, or any other suitable force and/or translation sensor (and/or combinations of sensors, such as a collapsible dome switch in combination with a force sensor). Touch inputs may be detected by a touch-sensing system, such as capacitive touch-sensing systems. For example, the button member of the button 167 (e.g., the movable component that a user presses in order to actuate or provide an input to the button) may include a touch-sensing element positioned thereon. A button equipped with a touch-sensing element may detect various types of touch-based inputs, including static touch inputs (e.g., a finger touching the touch-sensitive button surface), dynamic touch inputs (e.g., a finger sliding along the touch-sensitive button surface, also referred to as gesture or swipe inputs), or the like. In some cases, the button 167 may include a touch-sensing element to detect such touch-based inputs. As described herein, the button 167 may operate in conjunction with a haptic actuation system, such as the haptic actuator 422, to produce tactile outputs in response to a detection of an input at the button 167 (e.g., force inputs, touch inputs, etc.).

As shown in FIG. 4, the device 160 includes multiple antennas that may be adapted to conduct wireless communication using a 5G communication protocol. For example, the device 160 may include an antenna module that may include one or more antenna arrays that may be configured to transmit and receive wireless communication signals through the rear cover 175 and/or through another housing component of the device (e.g., a radio-frequency transmissive component of the device or housing). The antenna module may be attached to a back or bottom surface of the circuit board assembly 420.

The antenna modules may include multiple antenna arrays. For example, the antenna modules may include one or more millimeter-wave antenna arrays. In the case where the antenna modules include multiple millimeter-wave antenna arrays (each of which may include one or more radiating elements), the multiple millimeter-wave antenna arrays may be configured to operate according to a diversity scheme (e.g., spatial diversity, pattern diversity, polarization diversity, or the like). The antenna modules may also include one or more ultra-wideband antennas.

Each of the antenna arrays (e.g., the antenna array and the millimeter-wave arrays of the antenna module) may be adapted to conduct millimeter-wave 5G communications and may be adapted to use or be used with beam-forming or other techniques to adapt signal reception depending on the use case. The device 160 may also include multiple antennas for conducting multiple-in multiple-out (MIMO) wireless communications schemes, including 4G, 4G LTE, and/or 5G MIMO communication protocols. As described herein, one or more of the housing components 413, 415, and the wall sections 417, 419 (or portions thereof) may be adapted to operate as antennas for a MIMO wireless communication scheme (or other wireless communication scheme).

FIGS. 5A-5B illustrate front and rear views, respectively, of the device 100. With respect to FIG. 5B, the protrusion 151 may serve multiple functions for the device 100. For example, as described above, the protrusion 151 may define a raised sensor array region 141 of the device 100 that includes multiple audio and optical systems. Additionally, the protrusion 151 and the rear frame 130 may define multiple wireless communication antennas for the device 100. More particularly, the protrusion 151 may be defined at least in part by a metal or conductive plateau structure 504. A gap 501 may be defined between the plateau structure 504 (e.g., a first metal segment of the housing structure) and the rear frame 130 (e.g., a second metal segment of the housing structure). The gap 501 may extend substantially continuously around the periphery of the protrusion 151, and may be substantially filled with a joint structure 502 (e.g., a nonconductive joint structure). The joint structure 502 (shown in FIG. 5C) may be contiguous with the joint structures 122-1, 122-2, and may define at least a portion of the exterior (rear) surface of the device 100.

In some cases, the housing structure 104 may define a curved transition surface 507 (FIG. 5C) that extends from the bezel 121 to the top surface of the plateau structure 504. The joint structure 502 (e.g., the dielectric and/or nonconductive material of the joint structure 502) may define a portion of the curved transition surface 507. Thus, the exterior surface of the joint structure 502 may define a curvature (e.g., a concave curvature). The other portions of the curved transition surface 507 (e.g., above and below the joint structure 502) may be defined by different metal segments. For example, as described herein, the protrusion 151 may be defined by a first metal segment, and the bezel 121 may be defined by a second metal segment. Thus, the lower portion of the transition surface may be defined by the same metal segment that defines the bezel 121, and the upper portion of the transition surface (e.g., above the joint structure 502) may be defined by the same metal segment that defines the protrusion 151. It will be understood that the structure that defines the protrusion 1551 and the structure that defines the bezel 121 may be coupled to one another at various points along the gap 501, such as to define slot antennas, provide structural support, and the like. Thus, the gap 501 does not require complete severance of the housing structures. However, the gap 501 (or a portion thereof) may extend continuously around the periphery of the protrusion 151, as shown, such that the nonconductive joint structure 502 may define a continuous ring structure that is positioned in the gap and defines a portion of the rear exterior surface of the device 100.

The plateau structure 504 may be conductively coupled to the rear frame 130 at various locations along the gap 501, thereby defining one or more slot antennas in the gap 501. The slot antennas may be conductively coupled to wireless communication circuitry so that they can be used as wireless communications antennas for various frequency bands, ranges, and/or protocols. For example, as shown in FIG. 5B, first and second slot antennas 115-1, 115-2 may be defined at locations along the gap 501. The slot antennas may be defined by conductive couplings that join the plateau structure 504 and the rear frame 130, and conductively define the ends of the slot antennas. The conductive couplings may be achieved in various ways. As one example, the conductive couplings may be formed by welding, soldering, or otherwise attaching a conductive member, across the gap 501, to the plateau structure 504 and to the rear frame 130. As another example, the plateau structure 504 and the rear frame 130 may be different portions of a single, monolithic metal structure (e.g., a forged component), and the conductive couplings may be formed by segments of the same monolithic structure (e.g., segments of metal that remain after a machining or other forming operation). In some cases, different conductive couplings may be formed with different techniques (e.g., some may be residual conductive material, some may be conductive straps or bars affixed to the plateau structure 504 and the rear frame 130 with fasteners, some may be welded to the plateau structure 504 and the rear frame).

While FIG. 5B illustrates two slot antennas defined by the plateau structure 504 and the rear frame 130, this is merely an example configuration, and more (or fewer) slot antennas may be defined along and/or by the gap 501. FIG. 5C illustrates another example configuration of slot antennas 531 defined along the gap 501. For simplicity, the length and/or position of the slot antennas are illustrated as dashed lines within the protrusion 151, though it will be understood that the slot antennas are ultimately defined by the slot, and that the lengths and/or positions of the slot antennas are examples, and are not meant to be limiting. In this example, the device 100 includes a first slot antenna 531-1 for communications in a first frequency range (e.g., about 3 GHz to about 5 GHz), a second slot antenna 531-2 for communications in a second frequency range (e.g., about 7.5 GHz to about 8.5 GHZ, about 6 GHz to about 9 GHz, or another suitable band or range), a third slot antenna 531-3 for communications in a third frequency range (e.g., Wi-Fi communications, such as 5 GHz, 6 GHz Wi-Fi communications), and a fourth slot antenna 531-4 for communications in a fourth frequency range (e.g., GPS communications, such as using the GPS L5 signal specifications, or another GPS signal specification). In some cases, the first slot antenna 531-1 may be configured as a different type of antenna, such as a dipole or monopole antenna.

As noted, some of these antennas may be used in conjunction with other device antennas (either slot antennas or other antennas) in a multiple-antenna communication scheme or mode, such as a diversity mode, MIMO mode, or the like. For example, the ultra high band communication antenna may be used in conjunction with one or more ultra high band communication antennas defined by the housing components 124, 126 to operate in a MIMO mode. As described herein, the slot antennas may be conductively coupled to wireless communication circuitry (e.g., the same or different circuitry) so that they can be used as wireless communications antennas for various frequency bands, ranges, and/or protocols.

As noted above, the gap 501 between the plateau structure 504 and the rear frame 130 may be at least partially filled with a joint structure 502. As described with respect to other joint structures, the joint structure 502 may be a dielectric or otherwise substantially nonconductive material that maintains conductive isolation between the plateau structure 504 and the rear frame 130 in the portions of the gap 501 between the conductive couplings (e.g., in the slot region of the slot antenna). The joint structure 502 may also couple to both the plateau structure 504 and the rear frame 130 to form a rigid structure that includes the plateau structure 504 and the rear frame 130. For example, the plateau structure 504 and the rear frame 130 may each define interlock features (e.g., recesses, protrusions, undercuts, dovetail features, etc.) that the joint structure 502 engages with in order to form a secure coupling to the plateau structure 504 and to the rear frame 130. For example, the joint structure 502 may be formed by flowing a material (e.g., a polymer) into the gap 501 and into engagement with the interlock features. Thus, the joint structure material may extend into recesses, at least partially encapsulate protrusions, or otherwise mold or conform to the interlock features. Once cured or otherwise hardened, the engagement between the joint structure 502 and the interlock features results in a rigid, secure mechanical coupling. In some cases, the joint structure 502 forms an adhesive bond to the plateau structure 504 and the rear frame 130 as well.

In some example constructions, the joint structure 502 is the primary structural coupling between the plateau structure 504 and the rear frame 130. For example, the plateau structure 504 and the rear frame 130 may be entirely separate components except for the conductive couplings therebetween to define slot antennas (and which may not provide significant structural coupling strength). In other examples the plateau structure 504 and the rear frame 130 are coupled with additional structural couplings, such as metal (or other material) struts or bands that are coupled to the plateau structure 504 and the rear frame 130 and extend across the gap 501. As noted, in some cases, such additional structural couplings may also serve as conductive couplings that define the slot antennas.

Ultimately, the housing components 124, 125, 126 (including the rear frame 130 of the housing component 125) and the plateau structure 504 may be coupled to form a housing subassembly. As noted, in some cases, the plateau structure 504 and the rear frame 130 are a monolithic structure. For example, the plateau structure 504 and the rear frame 130 may be machined from a single solid piece of material, and may include structural couplings (e.g., bridges) that extend between the plateau structure 504 and the rear frame 130 to structurally couple them together (and optionally define slot antennas, as described herein). The single solid piece of material may be an extrusion from which the housing component 125 (including the plateau structure 504 and the rear frame 130) are ultimately formed. The extrusion may generally define the overall shape of the housing component 125, including the side walls 127, 128 and a span that generally defines the rear frame 130 and the plateau structure 504. The extrusion may then be machined or otherwise processed to define the final shape of the housing component 125, including the plateau structure 504 and the rear frame 130. In some cases, one or more optional forging operations are performed as well (e.g., prior to machining) to define the overall shape and configuration of the housing component 125.

As another example, the precursors for the plateau structure 504 and the rear frame 130 may initially be separate components (e.g., separate extrusions), and may then be coupled together via welding or another process (including welding structural couplings or bridges to the plateau structure 504 and/or the rear frame 130 to couple them). Once the precursor for the plateau structure 504 and the rear frame 130 are coupled together, they may be subjected to further machining, welding, or other forming operations, such as to define the gap 501, add (or remove) conductive and/or structural couplings between the plateau structure 504 and the rear frame 130, and the like. In some cases, welds between the plateau structure 504 and the rear frame 130 that were used to couple the plateau structure 504 and the rear frame 130 are removed after the joint structures are formed. More particularly, the joint structure 502 may provide a structural coupling between the plateau structure 504 and the rear frame 130 such that at least some of the welds between those components can be removed.

While multiple slot antennas may be defined using the gap 501 between the plateau structure 504 and the rear frame 130, the device 100 may include additional antennas as well. For example, the device 100 may include an antenna module within the enclosure, and the device 100 may include an antenna window 119 in one or more of the housing components (e.g., a hole formed through the housing component). As shown in FIG. 5C, the antenna window 119 is located in the housing component 124 along a top side surface of the enclosure. The antenna window 119 may be formed of or include a radio-frequency transmissive material (e.g., a dielectric or nonconductive window element) to allow the internal antenna to transmit and receive wireless communications through the window 119. In some cases the window 119 (or window element) is formed of one or more polymer materials (including fiber-reinforced polymer materials), glass, sapphire, ceramic, or another suitable radio-frequency transmissive material. The window 119 may be formed from or include multiple different components or members to facilitate the antenna functions. The antenna that communicates through the antenna window 119 may be a millimeter wave antenna. The antenna may include multiple antenna elements, such as to provide communications at different wavelengths and/or frequency bands or ranges.

In some cases, portions of the housing components 124, 125, 126 may also be used as radiating elements for antennas of the device 100. For example, portions of the housing components (e.g., portions of the housing components that are proximate the joint structures) may be coupled to communications circuitry to act as radiating elements.

As described herein, the device 100 may include multiple types of antennas, and multiple types of antenna integrations. For example, the device 100 may include one or more slot antennas defined along the gap 501 between the plateau structure 504 and the rear frame 130, one or more antennas within the device that communicate through antenna windows in the housing components, one or more antennas defined by segments of the housing components, and optionally internal antennas that communicate through the front or rear covers of the device. The device 100 may be configured to operate the antennas according to various communication schemes, and in various antenna groups or arrays. For example, the device 100 may use certain groups of the antennas for conducting multiple-in multiple-out (MIMO) wireless communications schemes, including 4G, 4G LTE, and/or 5G MIMO communication protocols. In some cases, the device operates the antennas according to a diversity scheme (e.g., spatial diversity, pattern diversity, polarization diversity, or the like). As noted, the various antennas of the device may be configured to communicate via one or more spectrums, protocols, or the like. Where the antennas are operated in antenna arrays, various different combinations of antennas may be employed for different operations. In one example, an antenna array may include four antenna elements, including two slot antennas in the gap 501 between the plateau structure 504 and the rear frame 130, an antenna defined by the housing component 124, and an antenna defined by the housing component 126. Other groupings of antennas are also contemplated.

FIG. 6A is a rear view of the device 100, illustrating an example arrangement of antennas, radiating elements, and/or radiating structures that may be used to facilitate wireless communications. As described herein, the terms antennas, radiating elements, and/or radiating structures may refer to structures that are configured to send and/or receive signals via electromagnetic radiation. Antennas may be defined by various structures of a housing structure, including slots or gaps that are defined in a housing structure, lengths of conductive material of the housing structure, and the like. Antennas may also be included in separate modules that are within the housing structure.

As shown in FIG. 6A, the device 100 includes first antennas 602 (e.g., 602-1-602-3). The first antennas 602 may be slot antennas that are defined at least in part by the gap between the plateau structure and the rear frame, as described herein, for example, with respect to FIGS. 5A-5C. The device 100 also includes second antennas 604 (e.g., 604-1-604-7). The second antennas 604 may be defined at least in part by conductive (e.g., metal) segments of the housing structure. For example, the housing structure may be defined at least in part by metal segments, such as housing components 124, 125, 126, or portions thereof. In the example shown, the antennas 604-1, 604-2, 604-4, and 604-5 are defined by portions of the housing components that define the corners of the housing structure 104. The housing component 124 (e.g., a single metal structure) may define first and second corners of the device 100 (e.g., top corners), as well as the antennas 604-1 and 604-2, while the housing component 126 (e.g., a single metal structure) may define third and fourth corners of the device 100 (e.g., bottom corners), as well as the antennas 604-4, 604-5.

In some cases, the portions of the metal segments that define the antennas 604 may be conductively separated from other metal structures by gaps, which may be at least partially filled by nonconductive joint structures. While the antennas 604-1, 604-2 are shown as extending at least partially around the plateau structure 504 and may generally follow the perimeter or periphery of the plateau structure 504, these antennas may not be slot antennas, but instead may be defined by the housing component 124. In some example constructions, however, the antennas 604-1, 604-2 may be configured as slot antennas. FIG. 6A illustrates example antenna locations relative to various housing components, and are not necessarily indicative of exact dimensions of the antennas.

The device 100 may further include antennas that are not defined by the housing structure, including antennas 247 and 606. The antenna 247 (which may be or may be part of an antenna module) may be positioned at least partially within the housing and may transmit and receive wireless signals through a hole formed through the housing component 124, and through the antenna window 119 (FIG. 5C). The antenna 247 may be a directional antenna (e.g., a high gain antenna). The antenna 606 may be positioned at least partially within the housing and may transmit and receive wireless signals through a rear cover 132 (FIG. 5C) and/or a front cover of the device 100.

The antennas may be configured to operate at various frequencies and/or frequency bands or ranges, and may be operated together in various modes, as described herein (including, for example 2×2 MIMO modes, 4×4 MIMO modes, and the like). In some cases, the antenna 604-7 (which may correspond to the first slot antenna 531-1, or may be another type of antenna) may be configured for communications in a first frequency range (e.g., about 3 GHz to about 5 GHz), the antenna 602-1 (which may correspond to the second slot antenna 531-2) may be configured for communications in a second frequency range (e.g., about 7.5 GHz to about 8.5 GHz, about 6 GHz to about 9 GHz, or another suitable band or range), the antenna 602-2 (which may correspond to the third slot antenna 531-3) may be configured for communications in a third frequency range (e.g., Wi-Fi communications, such as 5 GHz, 6 GHz Wi-Fi communications), and the antenna 602-3 (which may correspond to the fourth slot antenna 531-4) may be configured for communications in a fourth frequency range (e.g., GPS communications, such as using the GPS L5 signal specifications, or another GPS signal specification). The antenna 606 may also be configured for Wi-Fi communications (e.g., 5 GHZ, 6 GHZ), and may be used in conjunction with the antenna 602-2 (e.g., in a MIMO mode). The antenna 247 may be configured for millimeter wave communications (e.g., between about 24 GHz and about 40 GHZ, or between about 30 GHz and about 300 GHz).

The other antennas, including the antennas 604-1-604-7 may be configured for various combinations of wireless communications, including various frequency bands, ranges, communications protocols and/or standards, and the like. For example, the antennas 604-5, 604-2, and 604-4 may be configured for communications in a frequency range between about 600 MHz to about 1000 MHz, for communications in a frequency range between about 1400 MHz to about 1500 MHz, for communications in a frequency range between about 1700 MHz to about 2200 MHz, and for communications in a frequency range between about 2300 MHz to about 2700 MHz. The antenna 604-1 may be configured for communications in a frequency range between about 1700 MHz to about 2200 MHz, for communications in a frequency range between about 2300 MHz to about 2700 MHz, and for communications in a frequency range between about 3400 MHz and about 5000 MHz. In some cases, the antenna 604-2 may also be configured for communications in a frequency range between about 3400 MHz and about 5000 MHz. In some cases, the antennas 604-6 and 604-3 may be configured for communications in a frequency range between about 3400 MHz and about 5000 MHz. Tuning circuitry or other wireless communications circuitry may operate the same antenna (e.g., the same conductive portion of the housing) in different modes and/or for different frequencies. For example, the antennas may be switchable between operation in different frequency ranges or bands.

As described herein, one or more of the antennas 604 may be configured for use in multiple frequency ranges and/or communications protocols. For example, the antennas 604-2 and 604-4 (among others) may be switchable to operate in different frequency bands or ranges (e.g., switching between high band and low band communications, or between or among other frequency bands or ranges). Tuning circuitry and/or grounding circuitry may be used to configure a particular antenna or portion of a housing structure for operation in a particular band or range. It will be understood that an antenna being configured for communications relating to a certain frequency band or range includes the antenna being used to send and/or receive wireless signals within or around those frequency bands or ranges. It will be understood that the example frequency ranges or bands of the antennas described herein are merely examples, and the various antenna elements or radiators may be tuned for different frequency ranges or bands, and/or different combinations of frequency ranges or bands, in various implementations.

The various antennas and antenna modules may be adapted to use or be used with beam-forming or other techniques to adapt signal reception depending on the use case. For example, groups of antennas may be used for conducting MIMO wireless communications schemes, including 4G, 4G LTE, and/or 5G MIMO communication protocols.

The device 100 may include wireless communication circuitry, which may be conductively coupled to the housing components, in order to facilitate the use of the housing components as antennas. For example, the device 100 may include first wireless communication circuitry conductively coupled to the housing component 125 to cause a slot antenna to radiate to produce a wireless signal, and may include second wireless communication circuitry conductively coupled to the housing component 124 to operate a portion of the housing component 124 as an antenna, and third wireless communication circuitry conductively coupled to the housing component 126 to operate a portion of the housing component 126 as an antenna. It will be understood that any housing component (e.g., a metal segment of a housing structure) may be conductively coupled to wireless communication circuitry to facilitate its use as an antenna. Further, wireless communication circuitry, or portions thereof, may be shared among multiple antennas. As used herein wireless communication circuitry may refer to a set of device resources that may facilitate wireless communications using antennas.

FIGS. 6B-6D illustrate other example configurations of devices with plateau structures and multi-segment housing structures, in which the housing structures may operate as antennas (including portions of the housing structures that are along the sides of the plateau structure and/or across a gap from the plateau structure). FIG. 6B, for example, illustrates a device 610 with a plateau structure 612. The device 610 may include a first housing structure 614 and a second housing structure 616, and a nonconductive joint structure 618. The second housing structure 616 may include a single continuous structure (e.g., a continuous metal member that defines a portion of two corners of the device 610 and a top side of the device 610), and may define one or more antennas (as described with respect to FIG. 6A, for example). In this example, the housing does not define a slot along the bottom portion 611 of the plateau structure 612. As such, no antennas may be configured along the bottom portion 611 of the plateau structure 612. Other portions of the first and second housing structures 614, 616 may define antennas, as described herein.

FIG. 6C illustrates a device 620 with a plateau structure 622. The device 620 may include a first housing structure 624, a second housing structure 626, a third housing structure 627, and a nonconductive joint structure 628. The nonconductive joint structure 628 may be positioned between the first, second, and third housing structures, as depicted. In this example, the device 620 may include multiple housing structures to define the top side and corners. For example, the second housing structure 626 may define at least a portion of a first corner and a first portion of the top side of the device 620, while the third housing structure 627 may define a second portion of the top side of the device 620 and at least a portion of a second corner of the device 620. Each of the first, second, and third housing structures may define one or more antennas. In this example, the housing does not define a slot along the bottom portion 621 of the plateau structure 622. As such, no antennas may be configured along the bottom portion 621 of the plateau structure 622.

FIG. 6D illustrates a device 630 with a plateau structure 632. The device 630 may include a first housing structure 634, a second housing structure 636, a third housing structure 637, and a nonconductive joint structure 638. In this example, a gap may be defined around the plateau structure 632, and the nonconductive joint structure 638 may extend around the plateau structure 632 and be positioned between the first, second, and third housing structures, as depicted. In this example, the device 630 may include multiple housing structures to define the top side and corners. For example, the second housing structure 636 may define at least a portion of a first corner and a first portion of the top side of the device 630, while the third housing structure 637 may define a second portion of the top side of the device 630 and at least a portion of a second corner of the device 630. Each of the first, second, and third housing structures may define one or more antennas. Additionally, slot antennas may be defined along the bottom side of the plateau structure 632 (or along any portion of the gap between the plateau structure 632 and other housing components).

FIGS. 7A-7B are partial exploded views of the device 100, with FIG. 7A showing the front of the device 100 facing up, and FIG. 7B showing the rear of the device 100 facing up. As shown in FIGS. 7A-7B, the device 100 includes a chassis member 219 (referred to herein simply as a chassis). The chassis 219 is coupled to the housing component 125 and generally extends between the first and second lateral side walls 127, 128. As described herein, the housing component 125 defines a rear panel 283 extending between the first and second lateral side wall. The rear panel 283 may define an interior surface (e.g., the surface facing the interior of the device, visible in FIG. 7A) and an exterior rear surface opposite the interior surface (visible in FIG. 7B).

In the assembled state, the chassis member 219 may be set apart from the rear panel 283 by a gap. Various components may be positioned within the gap defined between the rear panel 283 and the chassis member 219, including a battery, a circuit board assembly, camera modules, haptic actuators, speakers, and the like, as described with respect to FIG. 7C. The chassis 219 may define a mounting structure for components of the device 100, such as the battery and the circuit board assembly.

The chassis 219 may define a first side, which faces the rear panel 283 and may define a mounting surface for various components. The chassis 219 may also define a second side opposite the first side. A display 103 may be positioned over the second side of the chassis 219 and a front cover 102 may be positioned over the display. The front cover may be coupled to the housing component 125 (which, as described herein, may be a unitary metal housing segment that defines a first lateral side wall and a second lateral side wall of the device, as well as the rear panel 283).

As shown in FIGS. 7A-7B, the housing component 125 may define a hole 704 through the rear frame 130. A wireless charging coil may be positioned within or otherwise aligned with the hole 704. The rear cover 132 covers (and conceals) the hole 704 and the wireless charging coil, while also allowing the wireless charging coil to electromagnetically (or otherwise wirelessly) couple to a complementary charging coil external to the device 100. In some cases, other antennas and/or wireless communication systems may also be aligned with the hole 704 and may communicate through the rear cover 132.

As described herein, the chassis member 219 may be a separate component from the housing structure 104, and may be set apart from the rear panel 283 by a gap. Various components of the device 100 may be positioned in the gap and coupled to the chassis member 219, while other components of the device 100 may be positioned in the gap and coupled to the rear panel 283. Thus, the housing configuration with the chassis member 219 and the rear panel 283 provides an interior device cavity with multiple parallel structural mounting surfaces or structures to which components may be coupled. The chassis member 219 may be coupled to the housing structure 104, as described herein, via fasteners (e.g., screws, bolts) to facilitate installation of various components and overall device manufacturing, and to facilitate removal of the chassis member 219 for service or other reasons. Thus, the chassis member 219 defines a load-bearing mounting structure (along with the rear panel 283), but is not permanently attached to the housing structure 104. As described herein, the battery 230 and the circuit board assembly 220 may be coupled to the chassis member 219, and may be set apart from the rear panel 283 by a gap.

The chassis 219 may also provide thermal performance functionality. For example, various device components and systems may be thermally coupled to the chassis 219 to allow heat to be distributed through the chassis 219. For example, in some cases, the display (coupled to the front cover 102), a circuit board assembly, a battery, as well as other components, are thermally coupled to the chassis 219. The chassis 219 may receive the heat from such components, and the thermally conductive nature of the chassis 219 may result in the heat spreading through the chassis 219. By receiving and spreading heat, the chassis 219 may reduce the peak temperatures experienced by the device and/or the device components, and may allow for greater device performance (e.g., by lowering the peak operating temperatures of components).

In some cases, the chassis 219 includes a thermal spreading module that receives and distributes heat throughout the thermal spreading module and the chassis 219. The thermal spreading module may be positioned at least partially in a hole 241 defined through the chassis member 219.

FIG. 7C illustrates a partial exploded view of the device 100, showing an example configuration of the chassis 219, the thermal spreading module 237, the circuit board assembly 220, and the battery 230. As described herein, the circuit board assembly 220 and the battery 230 may be coupled to a first side of the chassis 219 (e.g., a side facing the rear panel 283) and positioned in a gap between the chassis 219 and the rear panel 283. For example, as described herein, the circuit board assembly 220 and the battery 230 may be structurally coupled to the chassis 219 with fasteners, such as screws and/or bolts, and aligned with alignment pins or features. The circuit board assembly 220 and the battery 230 may also be set apart from the rear panel 283 (e.g., an interior surface of the rear panel) by a clearance distance.

The circuit board assembly 220 and the battery 230 may be thermally coupled to the chassis 219 and/or the thermal spreading module 237. For example, the circuit board assembly 220 and the battery 230 may contact the chassis 219 and/or the thermal spreading module 237. In some cases, thermal bridges 712 may be used to thermally couple the circuit board assembly 220 and/or the battery 230 to the chassis 219 and/or the thermal spreading module 237. For example, thermal bridges 712-1, 712-2 may contact the circuit board assembly 220 and the thermal spreading module 237 (and/or the chassis 219) in order to preferentially transfer heat from the circuit board assembly 220 to the thermal spreading module 237 and/or the chassis 219. In some cases, the thermal bridges 712-1, 712-2 may contact the thermal spreading module 237 and not the chassis 219, though it will be understood that this results in thermal coupling of the circuit board assembly 220 to the chassis 219 via the coupling between the thermal spreading module 237 and the chassis 219. Moreover, a similar configuration of thermal bridges may be applied to the battery 230 to conductively couple the battery 230 to the thermal spreading module 237 and the chassis 219. The thermal bridges 712 may include graphite-wrapped foams or graphite-coated loops, in which the loop or the foam structure maintains the graphite (which provides thermal conductivity) in contact with the components that are to be thermally coupled. Other thermally conductive materials or structures may also be used.

FIG. 7D is a plan view of the chassis 219, viewing a rear-facing surface (e.g., the surface of the chassis 219 that is facing the rear panel 283). The circuit board assembly 220 and the thermal bridges 712-1, 712-2 are shown in broken lines to illustrate an example positioning relative to the chassis 219. As shown, the thermal bridges 712 are positioned such that they will contact the thermal spreading module 237 (which is positioned in the hole 241 when assembled). As shown, the thermal bridges 712 are generally positioned at or proximate the center of the device, such that heat is preferentially drawn into the chassis 219 away from the exterior surfaces of the device, where excess heating may be undesirable or produce inconsistent external device temperatures. Other shapes, positions, and overall configurations of thermal bridges are also contemplated in order to draw heat from the circuit board assembly 220 to the chassis 219.

FIG. 7E is a plan view of the chassis 219, viewing a front-facing surface (e.g., the surface of the chassis 219 that faces the front cover assembly of the device), with the thermal spreading module 237 coupled thereto. As shown, the thermal spreading module 237 is positioned in the hole 241. The thermal spreading module 237 defines a flange 714 extending about a periphery of the thermal spreading module 237. The flange 714 may be thermally and structurally coupled to the chassis 219, such that the thermal spreading module 237 remains secured to the chassis 219, and so that heat can be transferred between the chassis 219 and the thermal spreading module 237.

The flange 714 may be thermally and structurally coupled to the chassis 219 in various ways. For example, the thermal spreading module 237 (and/or the flange 714 of the thermal spreading module 237) may be metal, and may be welded to the chassis 219 (as illustrated by welds 716 extending along the flange 714). Where the flange 714 is welded, the flange 714 and the portion of the chassis 219 to which the flange 714 is welded may be the same or different metal materials. For example, the flange 714 may be copper while the chassis 219 may be aluminum. In such cases, dissimilar metal welding may be used to weld the flange 714 to the chassis 219. In other examples, the flange 714 may be adhered to the chassis 219 with a thermally conductive adhesive, or coupled to the chassis 219 with fasteners (e.g., screws, bolts, pins, etc.). The flange 714 may also be soldered or brazed to the chassis 219. The attachment of the flange to the chassis 219 may facilitate heat transfer from the thermal spreading module 237 to the chassis 219 through the flange (and optionally welds, solder joints, brazed joints, fasteners, adhesives, or any other thermal coupling between the flange and the chassis).

In some cases, the thermal spreading module 237 is a vapor chamber module. The vapor chamber module may include a sealed chamber that houses a heat-spreading medium (which may be fluid and/or a material that changes phases within the sealed chamber to transfer heat). The heat-spreading medium of the vapor chamber module (also referred to simply as a vapor chamber) may be allowed to move within the sealed chamber to distribute heat throughout the vapor chamber. The vapor chamber may operate on a two-phase cycle, where heat from a heat source (e.g., the circuit board assembly, and/or components thereon) causes a liquid heat-spreading medium to vaporize. The vapor may then move to a cooler area of the vapor chamber, where it condenses back to a liquid. This cycle may continue, thereby drawing heat away from a heat source and transferring it to a heat sink (e.g., a cooler area of the chassis 219). In some cases, the thermal spreading module 237 may be or may include one or more heat pipes, thermal straps, thermally conductive layers (e.g., graphite), or the like.

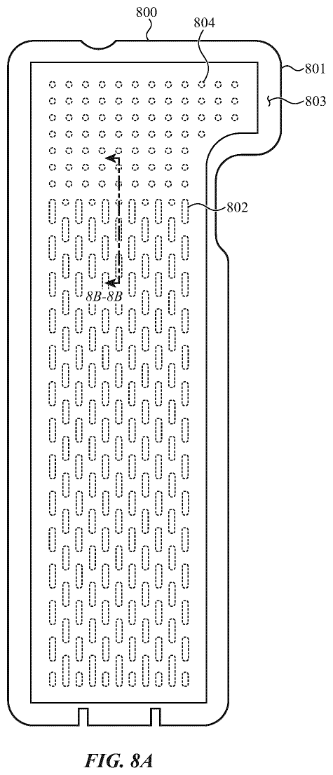

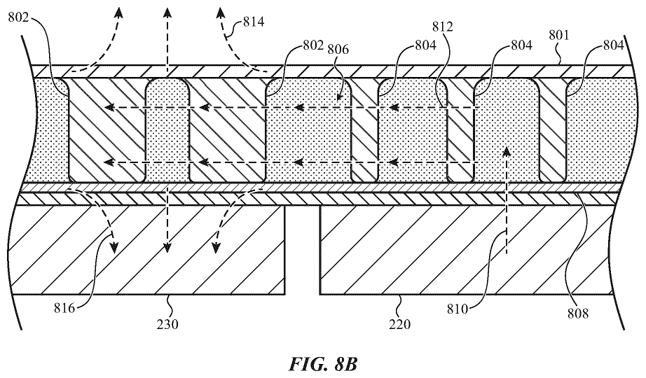

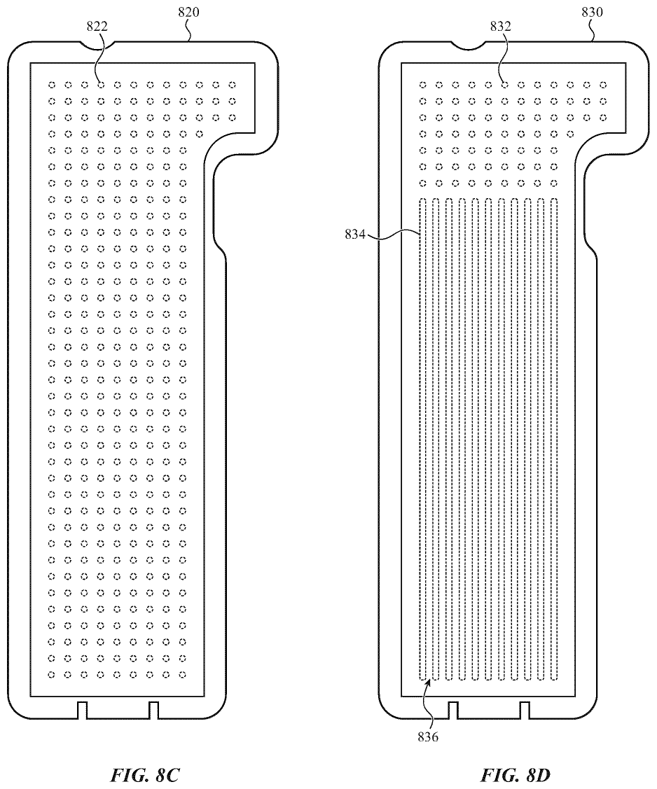

FIG. 8A is a plan view of an example vapor chamber 800, which is an example of the thermal spreading module 237. The vapor chamber 800 includes an outer housing 801 defining a flange 803, as described with respect to the thermal spreading module 237. The vapor chamber 800 may include sets of pillars 802, 804 inside the outer housing 801. The pillars 802, 804 may provide numerous advantages to the construction and operation of the vapor chamber 800. For example, as shown in FIG. 8B, which is a cross-sectional view of the vapor chamber 800 viewed along line 8B-8B in FIG. 8A, the pillars 802, 804 may extend between and support opposite walls of the outer housing 801, thus inhibiting crushing, denting, or other damage to the vapor chamber 800. The pillars 802, 804 may also be shaped to aid in the movement of the fluid 806 (e.g., the heat spreading medium) within the internal volume of the vapor chamber 800. For example, the pillars 804, which may have a substantially circular cross-section (e.g., generally cylindrical shaped) may be positioned over a heat source, such as the circuit board assembly 220. At this location, the pillars 804 may allow and/or facilitate heat transfer into the fluid 806. For example, the substantially cylindrical pillars 804 may provide a low cross-sectional area in a direction perpendicular to a target heat flow (relative to other cross-sectional shapes, such as rectangles, ovals, or other elongated shapes). Stated another way, the cylindrical pillars 804 may allow relatively more of the fluid 806 to contact the portion of the outer housing 801 that is directly over the heat source (as compared to other shaped pillars), while also providing structural integrity and rigidity. Arrow 810 in FIG. 8B illustrates heat entering the fluid 806 from the circuit board assembly 220 in the area of the pillars 804.

The pillars 802 may have an elongated shape, with a longitudinal (e.g., long) axis along a direction of advantageous heat flow. The elongated shape and orientation of the pillars 802 may preferentially direct the fluid along a preferred direction. For example, the fluid 806 (e.g., in vapor form) may be directed generally downwards (based on the orientation in FIG. 8A), away from the heat source and towards cooler areas of the device. Arrows 812 in FIG. 8B illustrate example heat flow direction (and optionally a general vapor flow direction) within the vapor chamber 800, showing heat drawn away from the heat source. Arrows 814 and 816 illustrate example heat transfer out of the vapor chamber 800. Of course, these are merely examples of heat transfer, and any heat transfer from the vapor chamber 800 will occur where there is a cooler temperature outside the vapor chamber 800. Thus, for example, if the battery 230 is not cooler than the vapor chamber 800, then heat may not be transferred into the battery 230.

The vapor chamber 800 may also include a wicking structure 808. The wicking structure 808 may be configured to collect and/or guide the fluid in the liquid state towards a particular location. For example, the wicking structure 808 may collect the liquid against the surface of the vapor chamber 800 that is thermally coupled to the circuit board assembly 220. This positions the liquid (e.g., the heat-absorbing phase of the fluid) in close thermal proximity to the heat source of the circuit board assembly 220. The wicking structure 808 may draw the liquid from other areas of the vapor chamber 800 towards the location of the heat source (e.g., as the liquid is converted to vapor over the circuit board assembly 220, the wicking structure 808 wicks or draws additional liquid towards the area of the vaporization).

FIGS. 8C and 8D illustrate additional example pillar configurations for vapor chambers. For example, FIG. 8C illustrates a vapor chamber 820 with a set of pillars 822 having substantially the same shape. In the illustrated example, the pillars 822 may be substantially cylindrical, but they may be other shapes as well (e.g., square, elongated shapes, etc.). FIG. 8D illustrates a vapor chamber 830 with a first set of pillars 832 having a first shape, and a second set of pillars 834 having a different shape. In this example, the second set of pillars 834 extend continuously along a length to define multiple elongated channels 836 between the pillars 834. These pillars 834 (and the resulting channels 836) may tend to induce fluid (e.g., vapor) flow along a particular direction (e.g., vertical, relative to the orientation of FIG. 8D). It will be understood that the particular shapes and arrangements of the pillars in a vapor chamber may be selected in order to achieve certain thermal performance parameters, fluid flow paradigms, structural criteria, and the like.

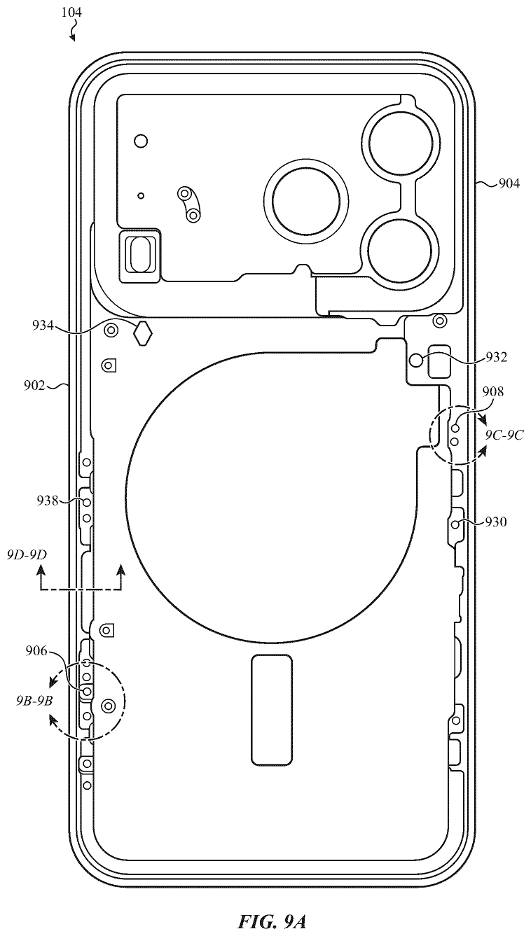

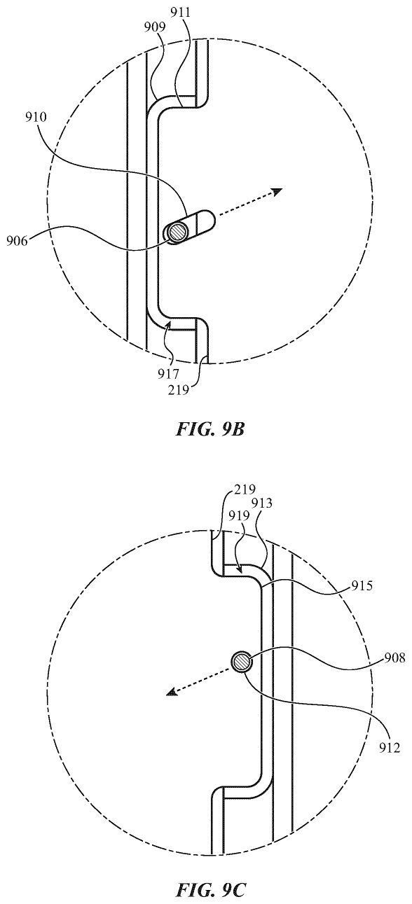

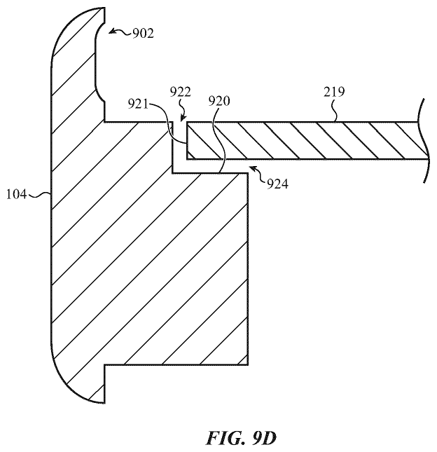

FIG. 9A is a plan view of the housing structure 104, illustrating example mounting features for aligning and coupling the chassis 219 (FIG. 2) to the housing structure 104. In particular, as described herein, the chassis 219 may be formed as a separate structure from the housing structure 104, and may be aligned and coupled to the housing structure 104 to form a rigid structure. For example, with reference to FIG. 9A, the housing structure 104 may include a metal segment, as described herein, that defines a first side wall 902 and a second side wall 904. The first side wall 902 defines a first exterior surface of the device, and the second side wall 904 defines a second exterior surface of the device. The first and second side walls may also define chassis alignment features that engage with the chassis 219 to align the chassis 219 to the housing structure 104. For example, the first side wall 902 may define a first chassis alignment pin 906, and the second side wall 904 may define a second chassis alignment pin 908.

The chassis 219 may define features that engage the chassis alignment pins to align the chassis 219 to the housing structure 104. For example, as shown in FIGS. 9B and 9C, respectively, the chassis 219 may define an alignment slot 910 and an alignment hole 912. The alignment slot 910 may receive the first chassis alignment pin 906, and the alignment hole may receive the second chassis alignment pin 908. The alignment slot 910 may extend along a line defined by the first and second alignment pins 906, 908. In this configuration, the interface between the second chassis alignment pin 908 and the hole 912 constrains translational movement of the chassis 219, while the interface between the first chassis alignment pin 906 and the slot 910 constrains rotational movement of the chassis 219 about the second chassis alignment pin 908. The shape and direction of the slot 910 reduces the interfacing or interfering surfaces between the pin 906 and the slot 910 (e.g., as compared to a cylindrical pin in a cylindrical hole), thereby reducing the likelihood of binding, misalignments, or other undesirable interferences (e.g., due to manufacturing tolerances of the various alignment features).

The alignment slot 910 and the alignment hole 912 may be defined on tab features 911, 915, respectively, of the chassis 219. The tab features 911, 915 may be received at least partially in recesses 909, 913, respectively, of the housing structure 104. More particularly, the first side wall 902 may define a recess 909 that receives the tab feature 911, and the second side wall 904 may define a recess 913 that receives the tab feature 915. The recesses 909, 913 may be machined in the side walls, or formed via other operations. As described herein, the peripheral sides of the chassis 219 may be set apart from the side walls of the housing structure, at least at some locations. For example, as shown in FIGS. 9B-9C, the peripheral sides of the tabs of the chassis 219 are set apart from the side walls of the housing structure 104 by gaps 917, 919. The gaps may define thermal breaks between the chassis 219 and the housing structure 104 to inhibit heat transfer from the chassis 219 to the housing structure 104, and in particular to the side walls 902, 904.

FIG. 9D is a partial cross-sectional view of the housing structure 104 and the chassis 219, viewed along line 9D-9D in FIG. 9A. FIG. 9B illustrates gaps (e.g., thermal breaks) between the chassis 219 and the housing structure 104. FIG. 9D illustrates gaps between a tab feature of the chassis 219 and a recess 920 of the side wall 902, though it will be understood that similar gaps may be present elsewhere. For example, a gap 922 may be defined between the peripheral side surface 921 of the chassis 219 and the side wall 902 (e.g., in the recess 920), and a gap 924 may be defined between the bottom (e.g., rear-facing) surface of the chassis 219 and the side wall 902.

In some cases, similar gaps may be present around the entire periphery of the chassis 219. More particularly, in some cases, the entire peripheral side 921 of the chassis 219 may be set apart from the housing structure by one or more gaps (e.g., the peripheral side surface of the chassis may not contact the housing structure). In some cases, the bottom surface of the chassis 219 is set apart from the housing structure at all locations except at an interface surface proximate fastening features. For example, one or more screws or bolts may extend through holes in the chassis 219 and couple to holes defined by the housing structure 104 (e.g., threaded mounting bosses). At those locations, the chassis 219 and the housing structure may be in contact, such as to facilitate secure fastening of the chassis 219 to the housing structure 104. At other locations, a gap, such as the gap 924, may be defined between the bottom (e.g., rear-facing) surface of the chassis 219 and the housing structure 104. As described herein, the gaps between the chassis 219 and the side walls and/or housing structure may define thermal breaks between the chassis 219 and the side walls and/or housing structure.

With reference to FIGS. 7D and 9A, the chassis 219 and the housing structure 104 may define a set of holes (e.g., holes 730, 930) that accept fasteners in order to couple the chassis 219 to the housing structure 104. In some cases, the chassis 219 is coupled to the housing structure 104 (e.g., a metal segment that defines or is part of the housing structure 104) via a plurality of threaded fasteners (e.g., extending through the holes 730, 930).

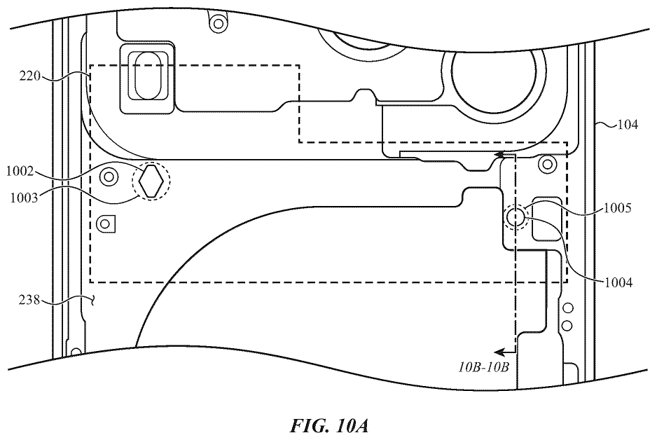

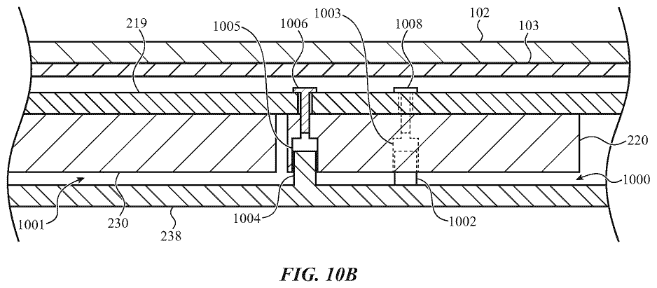

As described herein, the chassis 219 may provide a mounting structure for components such as the circuit board assembly 220 and the battery 230. FIG. 10A is a partial plan view of the housing structure 104, illustrating an example positioning of the circuit board assembly 220 relative to alignment features of the housing structure 104. FIG. 10B is a partial cross-sectional view of the device 100, viewed along line 10B-10B in FIG. 10A, illustrating the battery 230 and the circuit board assembly 220 coupled to the chassis 219.

With reference to FIG. 10A, the housing structure 104 includes a rear panel 238. Alignment pins 1002, 1004 may extend from an interior surface of the rear panel 238 (e.g., the surface of the rear panel 238 facing the front cover assembly of the device). The alignment pins may be used to align the circuit board assembly 220 relative to both the housing structure 104 and the chassis 219.

The circuit board assembly 220, shown in broken lines in FIG. 10A, includes alignment holes, including a first hole 1003 and a second hole 1005. The first hole 1003 may receive the alignment pin 1002 therein, and the second hole 1005 may receive the alignment pin 1004 therein. In some cases, one of the alignment pins 1002, 1004 may be a cylindrical alignment pin, while the other may be a diamond-shaped alignment pin. The combination of a cylindrical and diamond-shaped pin may align the circuit board assembly 220 relative to the housing structure 104 while avoiding binding, misalignments, or other assembly issues that may occur when using multiple alignment pins (e.g., multiple cylindrical alignment pins). More particularly, in this configuration, the engagement between the pin 1004 and the hole 1005 constrains translational movement of the circuit board assembly 220, while the interface between the diamond-shaped pin 1002 and the hole 1003 constrains rotational movement of the chassis 219 about the pin 1004. However, the diamond shape of the pin 1002 reduces the interfacing or interfering surfaces between the pin 1002 and the hole 1003 (e.g., as compared to a cylindrical pin in a cylindrical hole), thereby reducing the likelihood of binding, misalignments, or other undesirable interferences (e.g., due to manufacturing tolerances of the various alignment features). In some cases, the cylindrical hole 1003 and the diamond-shaped pin 1002 are used instead of a cylindrical pin and a slot for ease of manufacturing. In particular, it may be more difficult to form a slot through circuit board substrates (e.g., glass- or fiber-reinforced polymer substrates) than it is to form a cylindrical hole. Thus, the selection of a diamond-shaped pin with a cylindrical hole may provide more efficient manufacturing (e.g., less time, less tool wear, less complicated machinery and/or operations, and the like).

While the housing structure 104 includes the alignment pins to align the circuit board assembly 220, in some cases, the circuit board assembly 220 is not fastened to the housing structure 104. FIG. 10B illustrates an example construction of the device 100 after the circuit board assembly 220 is aligned to the housing structure 104 and the chassis 219 is attached to the housing structure. More particularly, when assembling the device, the circuit board assembly 220 may be placed in position on the housing structure 104 prior to the attachment of the chassis 219. After positioning the circuit board assembly 220 on the housing structure 104 such that the alignment pins are positioned in the alignment holes of the circuit board assembly 220, the chassis 219 may be positioned over the circuit board assembly 220 and secured to the housing structure 104, as described herein. Notably, the alignment pins and holes are configured to position the circuit board assembly 220 relative to the chassis 219 such that attachment features of the circuit board assembly 220 and the chassis 219 (e.g., fastener holes) are aligned. Fasteners may then be inserted through holes in the chassis 219 and into holes in the circuit board assembly 220, which results in the circuit board assembly 220 being lifted off of the rear panel 283 and into contact with the chassis 219 (and into thermal contact with the vapor chamber that is coupled to the chassis 219, as described herein).

FIG. 10B illustrates the circuit board assembly 220 after being fastened to the chassis 219. As shown, the circuit board assembly 220 is between the chassis 219 and the rear panel 238, and fasteners 1006, 1008 (e.g., threaded fasteners) have been positioned through holes in the chassis 219 and threaded into the circuit board assembly 220, thus pulling the circuit board assembly 220 against the chassis 219 (and the vapor chamber, omitted from FIG. 10B for clarity). As shown, the alignment pins 1002, 1004 are configured with a length (e.g., height above the rear panel 283) such that they remain at least partially within the holes 1003, 1005, respectively, even when the circuit board assembly 220 has been pulled away from the rear panel 238 and against the chassis 219. Thus, the alignment pins remain functional to maintain the alignment and positioning of the circuit board assembly 220 within the system, even though the circuit board assembly 220 is fastened to a different structure. Stated another way, the device 100 includes an alignment system that uses features extending from a housing structure (e.g., the rear panel 238) to maintain alignment of a component that is fastened to a separate structure (e.g., the chassis 219 that is opposite the rear panel 238).

Further, the fastening of the circuit board assembly 220 to the chassis 219 introduces a clearance distance 1000 between the circuit board assembly 220 and the rear panel 238. This clearance distance 1000 may serve as a thermal break (e.g., an air gap) between the circuit board assembly 220 and the rear panel 238, thus inhibiting heat flow from the circuit board assembly 220 to the rear panel 238. This may help avoid heat being transferred to the portions of the housing structure that define or are proximate to exterior surfaces of the device, as described elsewhere herein. FIG. 10B also illustrates the battery 230 positioned between the chassis 219 and the rear panel 238 and structurally coupled to the chassis 219, with a clearance distance 1001 defined between the battery 230 and the rear panel 238. The clearance distance 1001 may perform the same or similar functions as the clearance distance 1000 or other gaps or clearance distances (e.g., thermal breaks) described herein. The clearance distances 1000, 1001 may also help thermally isolate the battery 230 and the circuit board assembly 220 from a wireless charging coil, which may produce heat during battery charging or other operations.

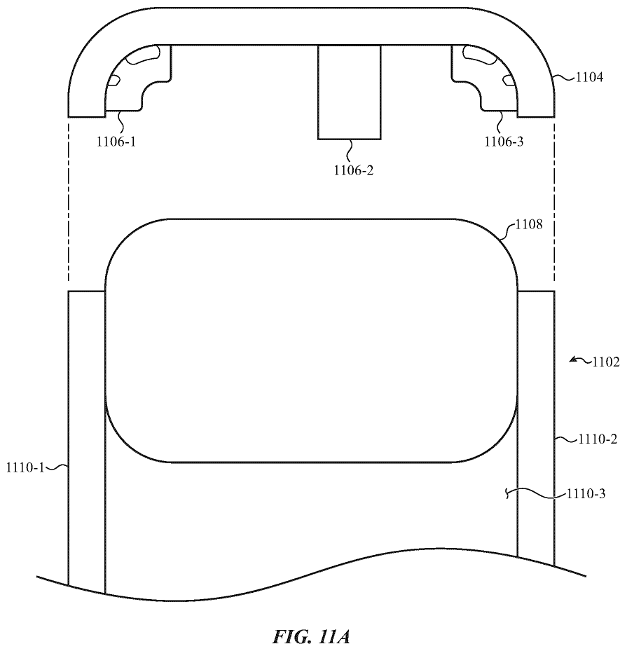

FIG. 11A illustrates metal structures that may be coupled together to form at least a portion of the housing structure 104, and in particular, the portions of the housing structure 104 that define the top side wall, the protrusion 151, and the rear frame 130 of the device 100. As shown in FIG. 11A, a first metal structure 1102 may be coupled to a second metal structure 1104. The first metal structure 1102 may be a unitary forged or machined structure with features that generally resemble the lateral side walls, the rear panel, and the protrusion of the device 100. More particularly, the first metal structure 1102 may define a first metal segment 1110-3 which will be formed into the rear panel 283, a second metal segment 1108 that protrudes from the portion 1110-3 and which will be formed into the protrusion 151, and third and fourth metal segments 1110-1, 1110-2 which will be formed into lateral side walls 128, 127, respectively. The second metal structure 1104 may define a metal segment that will be formed into a top side wall and corners of the housing structure 104. The first metal structure 1102 and the second metal structure 1104 may define three-dimensional features that serve as precursor features to the ultimate shape and configuration of the housing structure 104. More particularly, each of the metal segments may have relative sizes and shapes that correspond to the relative sizes and shapes of the final housing structure 104. The final housing structure 104 may be formed by processing operations such as machining, overmolding, and the like, which are ultimately applied to the assembly of precursor structures to form the housing structure 104. For example, holes may be drilled, nonconductive joint structures may be molded in place, features and surfaces may be machined, and the like, in order to form the housing structure 104.

The second metal structure 1104 may be attached to the first metal structure 1102 to form the precursor assembly for the housing structure 104. Additionally, a third metal structure may be attached to the first metal structure 1102 along the bottom side of the first metal structure 1102 to form the bottom side and corners of the housing structure 104. With reference to FIG. 11A, the second metal structure 1104 may include coupling features 1106 (1106-1-1106-3), which may be used to attach the second metal structure 1104 to the first metal structure 1102. For example, the coupling features 1106 may be configured to overlap portions of the first metal structure 1102 to serve as weld points to at least temporarily attach the first and second metal segments.

More particularly, the process of attaching the metal structures and forming the housing structure 104 may include positioning the second metal structure 1104 in position relative to the first metal structure 1102. This may include positioning the second metal structure so that the coupling features 1106 overlap the first metal structure, and such that one or more gaps remain between the first and second metal structures. Once positioned (e.g., in a jig or other fixture), the first and second metal structures are attached by welding the coupling features to the first metal structure 1102. Once coupled, additional operations may be performed, including without limitation (and in no particular order), inserting the assembly into a mold and molding a nonconductive material in place (e.g., in one or more gaps between the metal structures, thereby forming a nonconductive joint structure), machining, drilling, polishing, and the like.

FIG. 11B illustrates a simplified view of a portion of the housing structure 104, after the metal structures in FIG. 11A are attached and further operations are performed. More particularly, FIG. 11B illustrates a simplified view of an internal side of the rear-facing sensor array 141 and/or the protrusion 151.

As shown, the housing structure 104 includes a set of holes 1118 (1118-1-1118-3) formed through the protrusion 151. As described herein, camera modules may extend at least partially into the holes 1118. The housing structure 104 also includes holes 1120-1, 1120-2, and a flash module and a depth sensor module may extend at least partially into the holes 1120-1, 1120-2, as described herein. Windows or covers may be positioned in the holes 1118, 1120 to cover the holes and the internal components while providing optical or other necessary access to the internal systems.

As described herein, a gap may be formed at least partially around the protrusion 151 to define one or more slot antennas. FIG. 11B illustrates an example of the gap 1121. The gap 1121 may be at least partially filled with a nonconductive joint structure, as defined herein, to close the gap and seal the housing structure 104 while also allowing the slot (which is formed between metal structures) to define slot antennas.

A slot antenna may be defined by a slot that is formed in a conductive material, such as the metal of a housing structure 104. The slot (along with the nonconductive or dielectric material in the slot) may serve to conductively isolate portions of the metal structure along the length of the slot. The dimensions, such as the length, of the slot may at least partially define the frequencies over which the slot antenna communicates, and/or other antenna properties or performance characteristics. Thus, conductive elements may be provided across the gap 1121 to conductively couple the metal segments of the housing structure 104 at various locations along the gap 1121 in order to define multiple slot antennas of different lengths. More particularly, a conductive coupling across the gap 1121 may define a conductive path between opposite sides of the slot, and thus define a local end (at least conductively) of a slot antenna. Multiple conductive couplings may be provided to define multiple slot antennas along the slot. Slot antennas may be defined by one or multiple conductive elements. For example, an open-ended slot antenna may be defined by or include a single conductive element across the gap 1121, while a closed slot antenna may be defined by or include two conductive elements across the gap 1121 (e.g., conductive elements may define two ends of a slot antenna).

Conductive elements may include conductive components that are added to the housing structure 104 in order to define a conductive coupling across the gap 1121, and may also include conductive bridges that are unitary with the metal segments that define the gap 1121. For example, FIG. 11B illustrates conductive bridges 1114 (e.g., 1114-1-1114-4), which may be portions of material that remain after the gap 1121 is formed by machining the gap around the protrusion 151. For example, after a precursor structure is formed (e.g., by attaching the first and second metal structures 1102, 1104), the gap 1121 may be formed around the protrusion 151 (e.g., by machining, laser cutting, etc.). (It will be understood that part of the gap 1121 around the protrusion 151 may be defined between the first and second metal structures 1102, 1104, and that portion of the gap may therefore be present in the precursor structure without machining, due to how the metal structures are positioned when they are attached).

FIG. 11B also illustrates conductive components 1112 (e.g., 1112-1, 1112-2) that are attached to the metal structure 1102 and span the gap 1121 to conductively couple the metal segment 1108 (which defines the protrusion 151) and the metal segment 1110-3 (which defines the rear panel 283, for example). The conductive components 1112 may be metal structures (e.g., strips, wire, brackets, conductive traces on circuit substrates, etc.), and may be conductively coupled to the metal structures via fasteners, welding, soldering, brazing, or any other suitable technique. Similar to the conductive bridges 1114, the conductive components 1112 may define local ends of slot antennas.

The metal segment or segments that define the opposite sides of the slot may be conductively isolated along the length of the slot. This conductive isolation (along with the conductive couplings at the end(s) of the slot) define the slot antenna and allow the slot to operate as an antenna. Further, as described herein, the gap 1121 may be at least partially filled with a nonconductive joint structure, maintaining the conductive isolation between the opposite sides of the slot antenna.

As shown, conductive elements may be provided between the metal segment 1108 and the metal segments 1110. Additionally, conductive elements may be provided between the metal segment 1108 and the metal segment 1104. For example, conductive component 1112-1 may conductively couple the metal segment that defines the protrusion (metal segment 1108) and the metal segment that defines the top side and optionally one or more corners of the housing structure 104 (e.g., the metal segment 1104). The conductive component 1112-1 may define an end of a slot antenna, or may serve to conductively couple the metal segment 1104 to the electrical ground of the device. Notably, as described herein, the metal segment 1104 may define one or more antennas, and the conductive component 1112-1 may provide a conductive coupling that facilitates the antenna functionality of the metal segment 1104.

It will be understood that not all conductive couplings that span the gap 1121 necessarily define an end of a slot antenna. For example, in some cases, a coupling may be provided for structural functions (e.g., to improve rigidity and/or strength of the housing structure 104).

In order to operate the slot antennas, wireless communications circuitry may be operatively coupled to the slot antennas and configured to send and receive wireless signals via the slot antennas. For example, wireless communication circuitry may be conductively coupled to the metal segment(s) that define the slot antennas at certain locations in order to operate the slot antennas that are defined by different portions of the gap 1121. FIG. 11B illustrates various example coupling points 1116, which may correspond to antenna feeds for the slot antennas defined between various pairs of conductive elements. For example, a first coupling point 1116-1 may correspond to an antenna feed for a first slot antenna 1119-1 defined by the gap 1121 (e.g., with the element 1114-1 defining an end of the slot antenna), a second coupling point 1116-2 may correspond to an antenna feed for a second slot antenna 1119-2 defined by the gap 1121 (e.g., with the elements 1114-2, 1114-3 defining ends of the slot antenna), a third coupling point 1116-3 may correspond to an antenna feed for a third slot antenna 1119-3 defined by the gap 1121 (e.g., with the elements 1114-3, 1114-4 defining ends of the slot antenna), and a fourth coupling point 1116-4 may correspond to an antenna feed for a fourth slot antenna 1119-4 defined by the gap 1121 (e.g., with the element 1114-4 defining an end of the slot antenna). In some cases, the ends of the metal segments 1110-1 and 1110-2 may define radiating elements (which may not require a slot). The ends of the metal segment 1110-1, 1110-2 may be used as antennas instead of or in addition to the slot antennas 1119-1, 1119-4 (and may use different feed points, such as feed points conductively coupled to the metal segments 1110-1, 1110-2).

Conductive bridges 1114 may also thermally couple the protrusion 151 (e.g., the metal segment or structure that defines the protrusion 151) with the metal segment 1110-3. The thermal couplings may help transfer heat between these portions of the housing. In some cases, heat from a circuit board assembly (or other heat-producing components) may be transferred to the metal segment 1110-3, and may be spread via the conductive bridges 1114 to the protrusion 151. Generally and broadly, the conductive bridges 1114 may facilitate thermal spreading through and among the housing structure, which may generally help reduce peak temperatures of the device. Additional thermal couplings may also be provided, such as thermally conductive straps, tapes, foams, etc. Conductive components 1112 may also provide thermal coupling between the protrusion 151 and other housing components.

The coupling points 1116 are merely examples of coupling points that may be used to operate the slot antennas, and wireless communication circuitry (or other components or systems) may be conductively coupled to other locations along the gap and for other reasons. For example, antenna tuning circuitry may be conductively coupled to the metal segments at particular locations, and ground connections may be provided at particular locations. Such connections may facilitate the operation of the slot antennas that are defined by the gap. As described herein, wireless communication circuitry, or portions thereof, may be shared among multiple antennas. As used herein wireless communication circuitry may refer to a set of device resources that may facilitate wireless communications using antennas. Thus, a reference to first, second, and third wireless communication circuitry, etc., does not necessarily imply that the wireless communication circuitries are different or distinct. In some cases, the wireless communication circuitry that is operatively coupled to a slot antenna is unique to that slot antenna, while in other cases, multiple antennas are operatively coupled to the same wireless communication circuitry (and/or multiple antennas share one or more wireless communication circuitry resources).

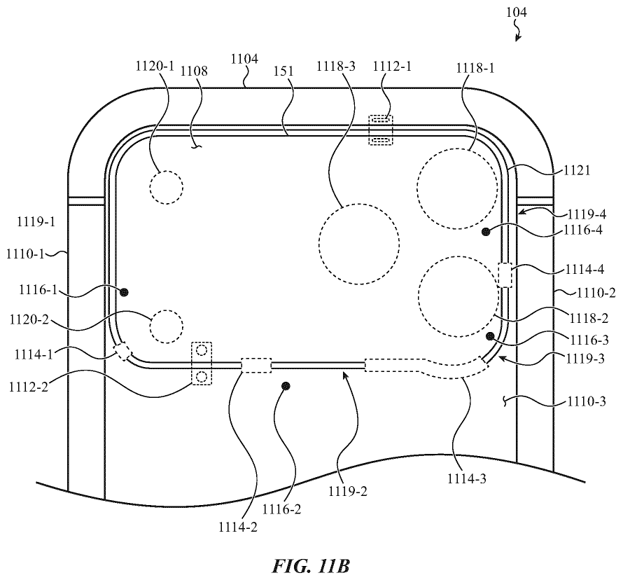

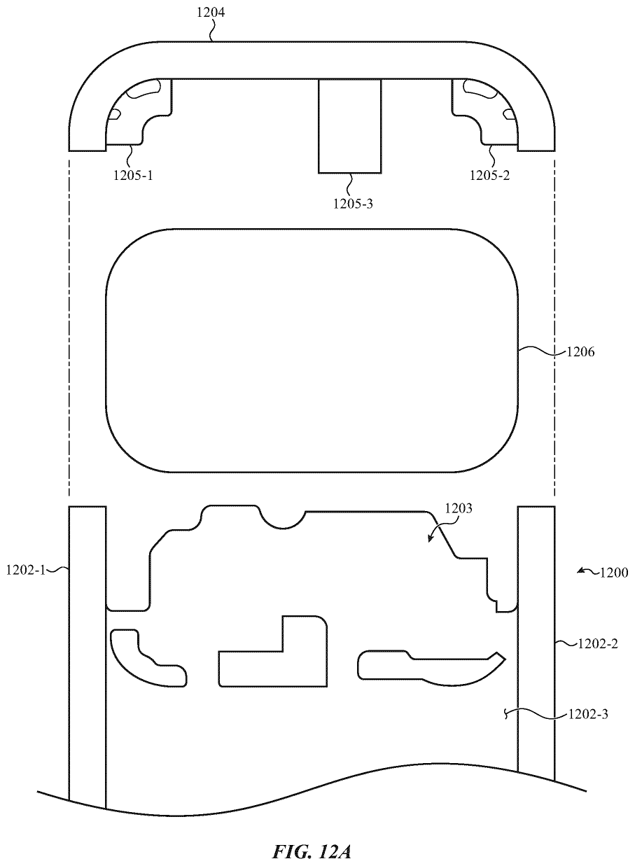

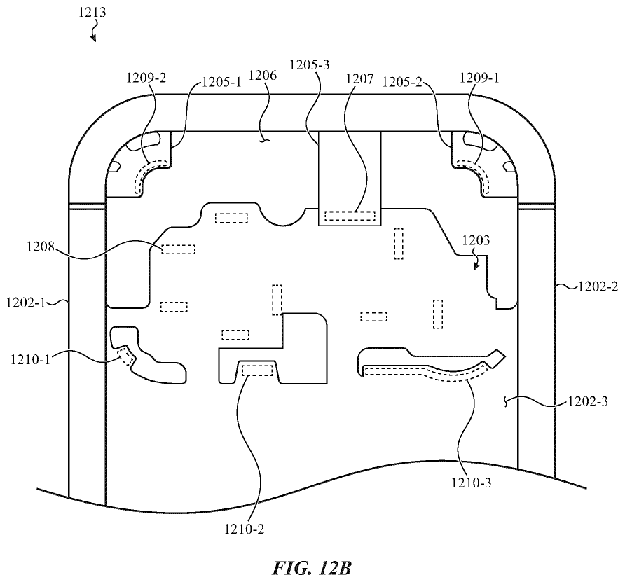

FIGS. 12A-12B illustrate another example of metal structures that may be coupled together to form at least a portion of the housing structure 104, and in particular, the portions of the housing structure 104 that define the top side wall, the protrusion 151, and the rear frame 130 of the device 100. As shown in FIG. 12A, a first metal structure 1200, a second metal structure 1204, and a third metal structure 1206 may be coupled together to form a precursor assembly (as shown in FIG. 12B). The first metal structure 1200 may be a unitary forged or machined structure with features that generally resemble the lateral side walls, the rear panel, and the protrusion of the device 100. More particularly, the first metal structure 1200 may define a first metal segment 1202-3 which will be formed into the rear panel 283, and second and third metal segments 1202-1, 1202-2 which will be formed into lateral side walls 128, 127, respectively. The second metal structure 1204 may define a metal segment that will be formed into a top side wall and corners of the housing structure 104. The third metal structure 1206 may be formed into the protrusion 151. Together, the first, second, and third metal structures of FIG. 12A may define three-dimensional features that serve as precursor features to the ultimate shape and configuration of the housing structure 104. More particularly, each of the metal segments may have relative sizes and shapes that correspond to the relative sizes and shapes of the final housing structure 104. The final housing structure 104 may be formed by processing operations such as machining, overmolding, and the like, which are ultimately applied to the assembly of precursor structures to form the housing structure 104. For example, holes may be drilled, nonconductive joint structures may be molded in place, features and surfaces may be machined, and the like, in order to form the housing structure 104.

The first, second, and third metal structures 1200, 1204, 1206 may be attached together to form the precursor assembly for the housing structure 104. Additionally, a fourth metal structure may be attached to the first metal structure 1200 along the bottom side of the first metal structure 1200 to form the bottom side and corners of the housing structure 104. With reference to FIG. 12A, the second metal structure 1204 may include coupling features 1205 (1205-1-1205-3), which may be used to attach the second metal structure 1204 to the third metal structure 1206. For example, the coupling features 1205 may be configured to overlap portions of the third metal structure 1206 to serve as weld points to at least temporarily attach the first and second metal segments.

More particularly, the process of attaching the metal structures and forming the housing structure 104 may include positioning the first, second, and third metal structures 1200, 1204, 1206 in position relative to one another. This may include positioning the second metal structure 1204 such that the coupling features 1205 overlap the third metal structure 1206 (and such that one or more gaps remain between the second and third metal structures), and positioning the third metal structure 1206 relative to the first metal structure 1200 so that a coupling feature 1203 overlaps the third metal structure 1206. Once positioned (e.g., in a jig or other fixture), the second and third metal structures 1204, 1206 are attached by welding the coupling features 1205 to the third metal structure 1206 (and/or to the coupling feature 1203 of the first metal structure), and the first and third metal structures are attached by welding the coupling feature 1203 to the third metal structure 1206. Once coupled, additional operations may be performed, including without limitation (and in no particular order), inserting the assembly into a mold and molding a nonconductive material in place (e.g., in one or more gaps between the metal structures, thereby forming a nonconductive joint structure), machining, drilling, polishing, and the like.

FIG. 12B illustrates a simplified view of a portion of the precursor structure 1213 (e.g., an interior side of the structure where the rear-facing sensor array is positioned), after the metal structures in FIG. 12A are attached. In particular, welds 1209 couple the second metal structure 1204 to the third metal structure 1206, while weld 1207 couples the second metal structure 1204 to the first metal structure 1200 (via the coupling feature 1203). Welds 1208 (one indicated, others shown in broken lines) and 1210 couple the third metal structure 1206 to the first metal structure 1200.

The structure shown in FIG. 12B is a precursor structure, and further operations may be performed to produce the housing structure 104. For example, the precursor structure may be inserted into a mold, and a nonconductive material may be injected in order to form the nonconductive joint structures of the housing structure 104. Since the nonconductive joint structures may structurally couple housing components, as described herein, after the molding operation certain weld points between the various housing structures and/or coupling features may be removed (e.g., via machining). For example, the coupling features and welds 1207, 1209 may be removed, thereby removing the metal structural coupling between the second metal structure 1204 and the third metal structure 1206 (e.g., leaving the nonconductive joint structure as the sole structural coupling between these structures). As another example, the welds 1208 and the coupling feature 1203 may be removed (e.g., via machining), to expose an interior surface of the third metal structure 1206 (to which components such as the cameras, a depth sensor module, a flash module, and the like, will be coupled). As described herein, in some cases, some welds and/or material joining the first metal structure 1200 and the third metal structure 1206 remain in place, such as to define ends of slot antennas or to otherwise conductively and/or structurally couple the first and third metal structures.

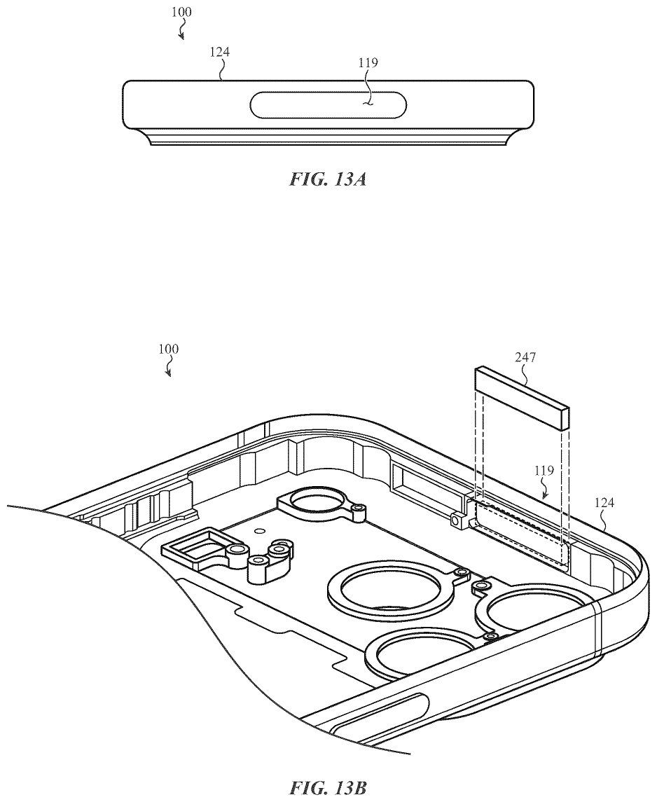

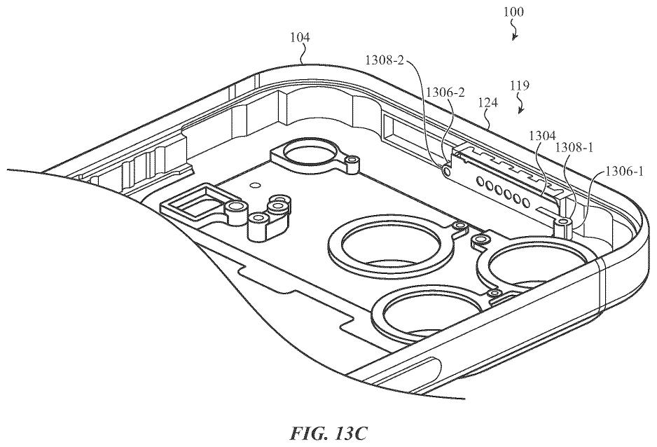

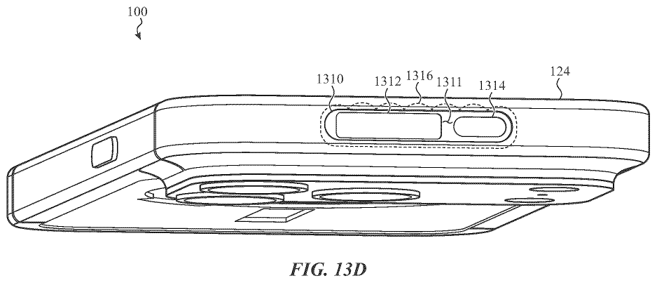

As described herein, the electronic device 100 may include an antenna module configured to transmit and receive wireless signals through a hole in a metal segment of the housing structure 104. FIGS. 13A-13D illustrate an example implementation of an antenna module as described herein.

FIG. 13A is a top side (or end) view of the device 100, illustrating the antenna window 119 in the housing component 124 (e.g., a metal segment of the housing structure 104). As described herein, the antenna window 119 may be formed of one or more polymer materials (including fiber-reinforced polymer materials), glass, sapphire, ceramic, or another suitable radio-frequency transmissive material (e.g., a dielectric material). The window 119 may be formed from or include multiple different components or members to facilitate the antenna functions. The window 119 may be positioned in an opening formed through the housing component 124 (FIG. 13D). An exterior surface of the antenna window 119 may be substantially flush with an exterior surface of the housing component 124 and may define a portion of the top exterior surface of the device 100.

FIG. 13B is a partial exploded view of the device 100, showing an example positioning of the antenna module 247 in the housing structure 104. In particular, the antenna module 247 may be positioned along an interior surface of the housing component 124, such that the antenna is proximate a hole formed through the housing component 124.

FIG. 13C illustrates the device 100 with a bracket 1304 positioned over the antenna module 247 and retaining the antenna module 247 in position proximate the antenna window 119. The bracket 1304 may be formed of metal (or another conductive material), and may be conductively coupled to conductive (e.g., metal) components of the housing structure 104. For example, as described herein, the housing component 124 may operate as an antenna. Accordingly, the antenna module 247 may be positioned in a recess or pocket that is defined in a portion of the housing component 124 that operates as an antenna radiator (e.g., a radiating structure). The bracket 1304 may therefore be conductively coupled to the housing component 124 to provide a strong conductive coupling across the recess and around the antenna module 247, thereby reducing or mitigating effects of the recess on the antenna functionality of that segment of the housing component 124. More particularly, the bracket 1304 (e.g., a metal or otherwise conductive bracket) may be coupled to first connection point 1306-1 (e.g., a mounting boss) of the housing component 124 at a first conductive feature 1308-1, and may be coupled to second connection point 1306-2 (e.g., a mounting boss) of the housing component 124 at a second conductive feature 1308-2. Screws, bolts, welds, solder joints, or the like, may structurally and conductively couple the bracket 1304 to the housing component 124. In some cases, the connection point 1306-1 is coupled to an electrical ground of the device, and the connection point 1306-2 is coupled to a tunable or selectable ground circuit (e.g., allowing the connection point 1306-2 to be connected to the electrical ground, disconnected from the electrical ground, or the like). The connection state of the connection point 1306-2 may depend at least in part on a mode of the antenna of the housing component 124. In some cases, the connection point 1306-1 is or includes a boss that is not integrally formed with the housing component 124, but is at least retained in a nonconductive joint structure (e.g., at least partially encapsulated), and conductively coupled to the housing component 124 via a conductive connector. In other examples, the connection point 1306-1 is integral with (e.g., machined from) the housing component 124.

FIG. 13D illustrates a top perspective view of the device 100 with the antenna window removed, illustrating an example internal structure of the housing component 124. As shown, a first hole 1312 may be formed through the housing component 124 to allow the antenna module 247 to transmit and receive wireless signals through the housing component 124. A second hole 1314 may also be formed through the housing component 124. The first and second holes may extend through a bottom surface of a recess 1310 that is formed along the exterior surface of the housing component 124.

The second hole 1314 may provide an interlock feature for the material of the antenna window 119, which may be molded in place. More particularly, the antenna window 119 may be formed of a polymer material, which may be molded into the first hole 1312, the second hole 1314, and in the recess 1310 (e.g., via an injection molding process), such that the material substantially fills the recess 1310 and the first and second holes 1312, 1314. The material of the antenna window may also extend along the interior side of the housing component 124, such that a bridge segment 1311 between the first and second holes is encapsulated in the material. In this way, the use of both a first hole and a second hole through the housing component 124 results in a structurally secure coupling of the antenna window 119 to the housing component 124. In some cases, the antenna window 119 is formed of the same material as the nonconductive joint structures, as described herein, and may be formed during the same molding process. In particular, a housing precursor structure may be positioned in a mold, and the material for the nonconductive joint structure may be injected into the mold to form the nonconductive joint structures as well as the antenna window 119 (including internal portions of the antenna window 119). In some cases, the antenna window 119 is contiguous with one or more of the nonconductive structures of the device 100, while in other cases it is separate from the nonconductive joint structures.

In some cases, a channel 1316 may be formed along a periphery of the recess 1310 to provide an undercut region that engages the material of the antenna window 119 to retain the antenna window 119 in place. For example, a T-slot cutter may be used to machine the channel 1316 (e.g., a slot-like channel that extends into the walls of the recess). When the dielectric material of the antenna window 119 is molded to the housing component 124, the material may flow into the channel 1316, thereby interlocking with the channel to inhibit decoupling, peeling, or other detachment of the antenna window 119 from the housing component 124.

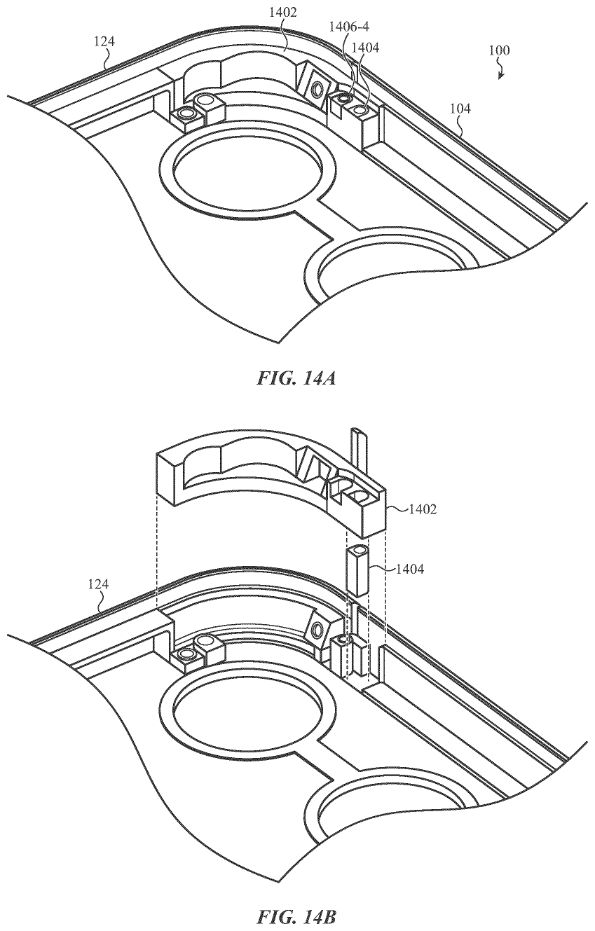

As described herein the device 100 may include an assembled chassis member 219, which is attached to the housing structure 104 via fasteners. In some cases, the chassis member 219 is formed of metal or another conductive material. As such, the chassis member 219 may impact the operation of metal housing structures that are used as antennas. In some cases, in regions where the chassis member 219 is secured to the housing structure 104 at a location proximate a housing-based radiating element, the chassis member 219 is coupled to the housing structure 104 via a conductively isolated mounting feature. FIGS. 14A-14B illustrate partial exploded views of the housing structure 104, illustrating a conductively isolated mounting feature 1404 (e.g., a threaded boss) that may be used to couple to a chassis member 219. In particular, as shown in FIG. 14A, the mounting feature 1404 may be at least partially encapsulated in a nonconductive joint structure 1402 (which may be contiguous with and/or the same structure as the nonconductive joint structure 122-1, FIG. 1A). FIG. 14B shows the device 100 with a portion of the nonconductive joint structure 1402 and the mounting feature 1404 separate from the housing structure 104. In particular, the mounting feature 1404 is not part of a metal housing component (e.g., it is not a feature that is machined from the metal material of a housing component), but instead is a separate component. The mounting feature 1404 may be positioned in a mold during the molding process that produces the nonconductive joint structures, and may be conductively decoupled from (e.g., not in physical contact with) the metal of the housing structure 104. Rather, the mounting feature 1404 may be at least partially encapsulated in the nonconductive joint structure 1402 such that it is securely coupled to the housing structure 104 (e.g., to act as a structural mounting point for the chassis member 219), while also being conductively isolated (e.g., floating) relative to the other metal components of the housing structure 104. In this way, the chassis member 219 can be secured to the housing structure, even at a location proximate a housing-based antenna structure, while limiting or mitigating its effects on antenna performance.

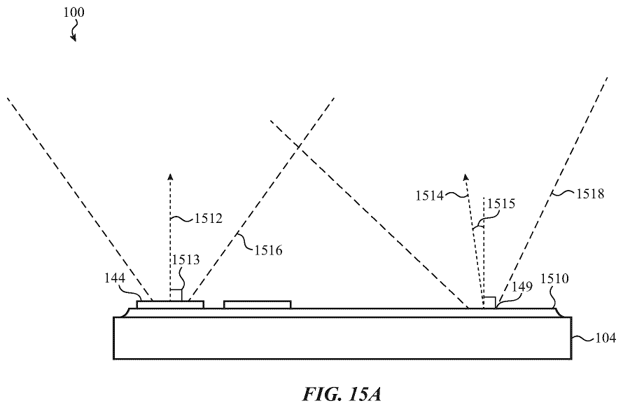

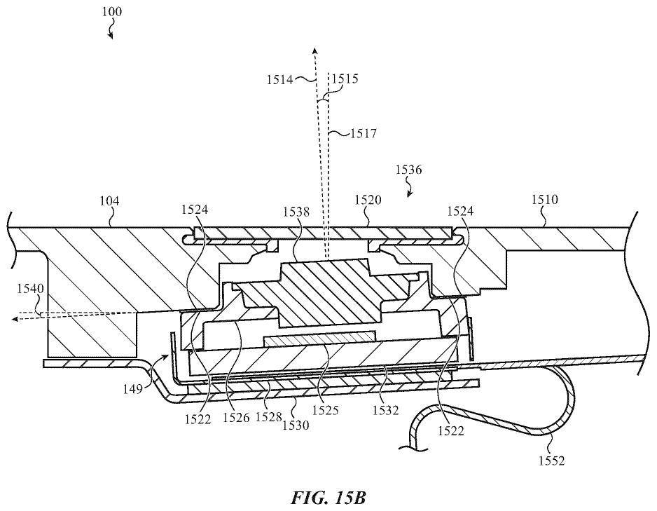

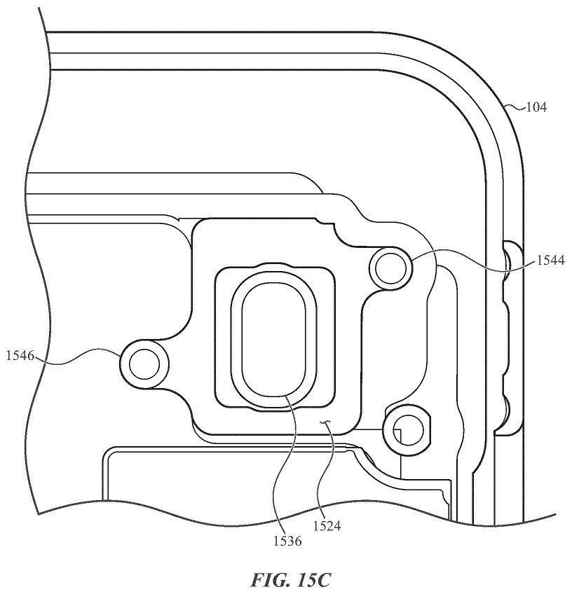

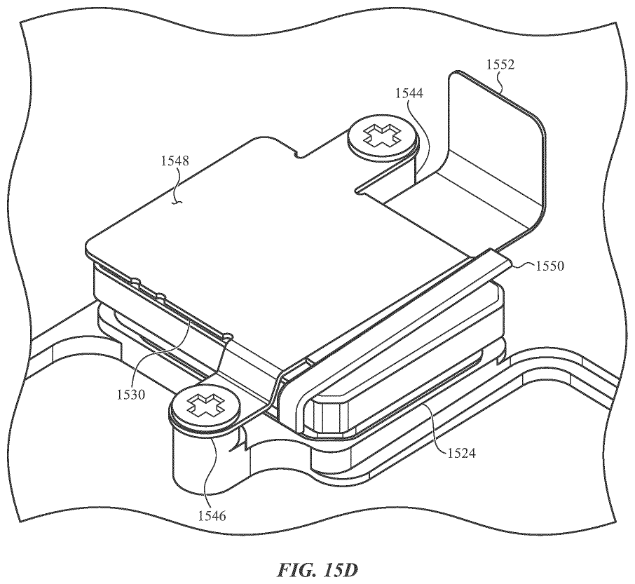

As noted above, in some cases, a depth sensor module 149 of an electronic device (e.g., device 100) may be aimed at an angle (e.g., non-perpendicular to the rear exterior surface of the device) in order to achieve a target overlap between the field of view of the cameras and the illumination pattern (and generally the field of view) of the depth sensor module 149. FIG. 15A is a bottom end view of the device 100, illustrating the effect of angling the depth sensor module 149 relative to the cameras. In particular, as shown in FIG. 15A, the camera 144 may have a field of view 1516, and the camera lens assembly of the camera 144 may define a principal axis 1512. As illustrated by angle 1513, the principal axis 1512 may be substantially perpendicular to the rear exterior surface 1510 (e.g., the exterior surface defined by the protrusion 151, or any other portion of the housing to which the cameras are coupled or location at which the cameras are positioned). The principal axis 1512 may also define the center of the field of view of the lens assembly of the camera 144. It will be understood that the principal axes of the other rear-facing cameras of the device 100 (e.g., 142, 146) may also be perpendicular to the rear exterior surface 1510 of the housing.

The depth sensor module 149 (or the depth sensing system more generally) may also include one or more lens assemblies. For example, the depth sensor module 149 may include a first lens assembly associated with a light projection system (e.g., a projector lens assembly) and a second lens assembly associated with an image capture system (e.g., an image capture lens assembly). The projector lens assembly may be used to project light (e.g., a pattern of dots and/or a flood of illumination) to illuminate an object or scene, and the image capture lens assembly may be configured to capture an image of the object or scene illuminated by the projector. The depth sensing system may determine information about the object or scene based at least in part on the captured image and/or properties of the light received through the image capture lens assembly (e.g., distance(s) between the depth sensor module 149 and one or more objects, a depth map of object(s) or scene(s), or the like).

In some cases, the depth sensor module 149 may emit a beam, via the projector lens assembly (and associated light emitting component(s)), where the beam includes optical pulses. An optical receiver receives, via the image capture lens assembly, reflections of the optical pulses, and outputs electrical signals in response thereto. Processing circuitry coupled to the receiver may receive, in response to each of at least some of the optical pulses emitted by the transmitter, a first electrical signal output by the receiver at a first time due to stray reflection within the apparatus, and a second electrical signal output by the receiver at a second time due to the beam reflected from the scene. The processing circuitry may generate a measure of the time of flight of the optical pulses to and from points in the scene by taking a difference between the respective first and second times of output of the first and second electrical signals.

As used herein, a lens assembly (e.g., for a camera, depth sensing system, or other system) may include one or more lens elements, and may focus or otherwise refract light (which may be or may include visible light, infrared light, laser light, or any other type of light). The lens assemblies may each be configured for their particular purposes and for the modules or systems in which they are integrated.

As shown in FIG. 15A, the depth sensor module 149 may be angled or tilted relative to the exterior surface 1510 of the device. More particularly, the principal axis 1514 of the lens assembly (or assemblies) of the depth sensor module 149 are angled towards the camera 144 (and/or other rear-facing cameras of the rear-facing sensor array). Angling the principal axis 1514 of the lens assembly of the depth sensor module 149 towards the camera 144 (e.g., nonparallel to the principal axis 1512) results in the field of view 1518 of the lens assembly overlapping the field of view of the camera 144 (and/or the other rear-facing cameras) nearer to the device 100 than would be achieved if the principal axis of the lens assembly were perpendicular to the exterior surface 1510 (and/or parallel to the principal axis of the lens assembly of the camera 144). This allows the depth sensing system to provide depth information (e.g., distances, depth maps, etc.) for a greater range of objects or scenes in the field of view of the camera 144, particularly proximate the close focus distance of the camera 144 (e.g., the closest distance that the camera 144 is capable of focusing to).

The principal axis 1514 of the lens assemblies of the depth sensing system may be angled (angle 1515, measured from the normal 1517 to the exterior surface 1510) between about 1 degree and about 5 degrees towards the principal axis 1512, or between about 2 degrees and about 7 degrees towards the principal axis 1512. In some cases, the angle 1515 may be selected in conjunction with the fields of view of the camera 144 and the depth sensing system such that the field of view 1516 of the camera 144 and the field of view 1518 of the one or more of the depth sensor lens assemblies at least partially overlap between about 50 centimeters and about 100 centimeters from the exterior surface 1510, or between about 20 centimeters and about 50 centimeters from the exterior surface. In some cases, the angle 1515 may be selected in conjunction with the minimum focusing distance of the camera 144 (or of any other rear-facing camera), such that the fields of view 1516, 1518 at least partially overlap at (or nearer than) the minimum focusing distance of the camera 144 (or of any other rear-facing camera).

FIG. 15A illustrates the angling of the depth sensor lens assembly (or assemblies) relative to the camera 144. However, it will be understood that this is merely for illustrative purposes, and that the angling of the depth sensor lens assembly results in the depth sensor lens assembly being angled towards all of the rear-facing cameras in the rear-facing sensor array (e.g., cameras 144, 142, 146). In some cases, the principal axis of the depth sensor lens assembly is substantially in plane (e.g., coplanar) with the principal axis of one rear-facing camera. In other cases, the principal axis of the depth sensor lens assembly is substantially in plane (e.g., coplanar) with a composite axis that is based on multiple principal axes of multiple rear-facing cameras (e.g., a composite axis at a geometric center or centroid of the principal axes of multiple rear-facing cameras). In some cases, the depth sensor is tilted about the y-direction of the device (e.g., only the y-direction).

As described herein, the depth sensor module 149 (and/or the depth sensing system more generally) may include multiple lens assemblies, such as an image capture lens assembly and a projector lens assembly. It will be understood that the description of angling a lens assembly of the depth sensor module 149 may apply to all of the lens assemblies of the depth sensor module 149, or only a subset of the lens assemblies. Thus, for example, both an image capture lens assembly and a projector lens assembly may be angled towards the rear-facing cameras, as described herein. Indeed, as described herein, in some cases, both an image capture lens assembly and a projector lens assembly are part of the same depth sensor module 149, and the angling of the depth sensor may be achieved by mounting the module at an angle relative to the exterior surface of the housing. Thus, the principal axis of the image capture lens assembly and the principal axis of the projector lens assembly may be angled a same angle towards the principal axis of the camera lens assembly. In other examples, different lens assemblies of a depth sensing system are angled differently. For example, a projector lens assembly of a depth sensing system may have a principal axis that is parallel to a principal axis of a camera, while an image capture lens assembly of the depth sensing system may have a principal axis that is oblique to the principal axis of the camera. In such cases, the lens assemblies may be positioned in the same housing or module, or in different housings or modules.

FIG. 15B illustrates a partial cross-sectional view of the device 100, viewed along line 15B-15B in FIG. 1B, depicting the depth sensor module 149 coupled to the housing structure 104. The depth sensor module 149 includes a lens assembly 1538. As shown, the housing structure 104 (e.g., a metal segment of the housing structure that defines the protrusion 151) defines a hole 1536, and the depth sensor module 149 (e.g., the lens assembly 1538) is aligned with the hole 1536 (e.g., to receive and/or emit light through the hole 1536). The lens assembly 1538 may be a projector lens assembly, or an image capture lens assembly, as described herein. The device 100 may further include a light transmissive cover 1520 positioned in the hole 1536 and over the depth sensor module 149. The light transmissive cover 1520 may be transmissive in the particular range of the electromagnetic spectrum in which the depth sensing system operates.

The depth sensor module 149 further includes a bracket 1526, a substrate 1532, a circuit component 1525, and a housing cover 1528. The lens assembly 1538 may be coupled to the bracket 1526, and positioned over the circuit component 1525. The circuit component 1525 may represent an imaging sensor or a light source, depending on the particular function of the lens assembly 1538.

The housing structure 104 may define a depth sensor mounting surface 1524 opposite the exterior surface 1510. The depth sensor mounting surface 1524 may define a mounting plane that is oriented at an oblique angle relative to the exterior surface 1510. For example, the depth sensor mounting surface 1524 (e.g., the mounting plane defined by the mounting surface 1524) may be angled relative to the exterior surface 1510 at an angle 1540 that results in the desired angle 1515 of the principal axis 1514 of the lens assembly 1538. Thus, for example, if the desired angle 1515 of the principal angle (relative to the normal 1517 of the exterior surface 1510) is 5 degrees, the angle 1540 of the depth sensor mounting surface 1524 (relative to the plane of the exterior surface 1510) is also 5 degrees. This allows the depth sensor module 149 to be built without angling the lens assemblies or other components within the depth sensor module itself, because the depth sensor module may be angled, in its entirety, by being mounted directly to the angled depth sensor mounting surface. In some cases, the depth sensor mounting surface is a machined surface along the interior side of the housing (e.g., opposite the exterior side).

As shown, the bracket 1526 of the depth sensor module 149 may define a mounting face 1522 that is mounted to the mounting surface 1524 of the housing structure 104. The mounting face 1522 may be substantially perpendicular to the principal axis 1514 of the lens assembly, such that the angle 1540 of the mounting surface 1524 defines the angle of the principal axis of the lens assembly towards the rear-facing cameras from the normal 1517 of the rear surface. In some cases an adhesive may be positioned between the mounting face 1522 of the bracket 1526 and the mounting surface 1524 of the housing structure 104 to attach the bracket 1526 to the mounting surface 1524. The adhesive may be a pressure sensitive adhesive, a heat sensitive adhesive, an adhesive film, or any other suitable adhesive.

The electronic device 100 may also include a cowling 1530 that covers and optionally retains the depth sensor module 149 in the housing. In some cases, the cowling 1530 may include an angled portion that generally conforms to the angle of a rear or interior surface of the housing cover 1528 of the depth sensor module 149. For example, as described herein, the depth sensor module 149 may be designed such that the principal angle of the lens assemblies are generally perpendicular to the bracket 1526, the substrate 1532, the circuit component 1525, and the housing cover 1528. Accordingly, the rear surface of the housing cover 1528 may be angled at the same angle as the mounting surface 1524 and mounting face 1522 when the depth sensor module 149 is mounted in the housing. The angled portion of the cowling 1530 may allow the cowling to contact or otherwise couple to the rear surface of the housing cover 1528 to retain the depth sensor module 149 in place. In some cases, the cowling 1530 covers at least a portion of a flexible circuit element of the depth sensor module 149, and optionally provides a biasing force to maintain the depth sensor module 149 against the mounting surface 1524.

In the example electronic device 100, the portion of the housing structure 104 that defines the mounting surface 1524 is formed of metal. In other examples, the portion of the housing to which a depth sensor module is coupled may be formed of another material, such as glass (e.g., a glass rear cover or glass window portion), a polymer, a composite, or the like. In such cases, the mounting surface may be formed via molding, machining, lapping, casting, or any other suitable process or technique. Further, while the foregoing example uses an angled mounting surface to define the angle of the depth sensor module (and its lens assemblies), this is merely one example. In other implementations, the depth sensor module may be angled in other ways, such as with a variable-thickness shim positioned between the depth sensor module and the housing, or by angling the lens assembly within the depth sensor module.

Moreover, in the instant example, the depth sensor module is mounted via a front-facing surface of the depth sensor module. In other examples, the depth sensor module may be mounted via the rear surface of the depth sensor module (e.g., to a chassis or other internal structure of the device). In such cases, the angle of the principal axis of the lens assembly may be effectuated in other ways, such as with angled mounting structures, shims, or the like.

FIG. 15C depicts an interior side of the housing structure 104, showing the mounting region of the depth sensor module (with the depth sensor module 149 removed). As shown, the housing structure 104 defines the hole 1536 with which the depth sensor module 149 is aligned (e.g., through which the depth sensor transmits and/or receives light). The hole 1536 may be oblong, to accommodate multiple lens assemblies (e.g., the projector and the image capture lens assemblies) positioned next to one another. In other examples, the hole 1536 may have another shape or configuration.

The mounting surface 1524 may at least partially surround the hole, and define the angle of the depth sensor module, as described herein. The housing structure 104 may also include mounting features 1544, 1546 (e.g., bosses) to which the cowling 1530 may be coupled (e.g., via screws or other fasteners).

FIG. 15D is a perspective view of the interior side of the housing structure 104 with the depth sensor module 149 mounted thereto. FIG. 15D depicts the angled mounting surface 1524 to which the depth sensor module 149 is mounted and that defines the angle of the depth sensor module. As shown, the mounting surface 1524 may be raised relative to other interior surfaces of the housing structure 104. The cowling 1530 covers and optionally secures the depth sensor module 149 in the housing, and may cover a portion of a flexible circuit element 1552, which extends from the depth sensor module 149 and operatively couples the depth sensor module to other components of the device 100 (e.g., a processing system).

In some cases, the cowling 1530 includes a first portion 1548 and a second portion 1550. The first portion 1548 may extend at an angle, as described with respect to FIG. 15B, and may contact or engage with a surface of the depth sensor module 149. The first portion 1548 may provide a biasing force to the depth sensor module 149 or otherwise retain, cover, and/or protect the depth sensor module 149. The second portion 1550 of the cowling may be substantially parallel to the rear exterior surface 1510 of the housing structure 104 and/or to a midplane of the device 100. The second portion 1550 of the cowling 1530 may be configured to present a non-angled surface to other interior components of the device, such as a flexible circuit element. For example, a flexible circuit element may overlie the cowling 1530, and the second portion 1550 may define a surface that engages the flexible circuit element or otherwise defines an interface surface of the cowling 1530 with respect to the overlying flexible circuit element.

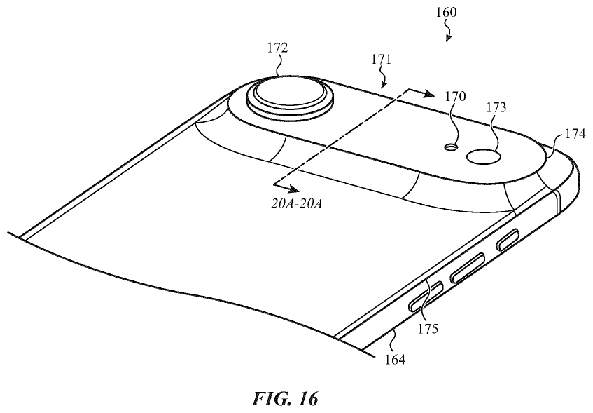

FIG. 16 illustrates a portion of the back or rear side of the device 160. As shown, the device 160 includes a rear cover 175 coupled to the housing structure 164. The rear cover 175 may define substantially all of the back or rear surface of the device 160. The rear cover 175 may be formed from or include a transparent or optically transmissive material, as described herein. The rear cover 175 may be a unitary rear cover, shaped from a single piece or billet of silicate-based materials to define a protrusion along the exterior side of the rear cover 175 and a corresponding recess along an interior side of the rear cover 175.

The device 160 may also include a sensor array 171 (e.g., a rear-facing sensor array in a rear-facing sensor array region) that includes a camera 172, a flash 173 (e.g., to illuminate a subject during an image capture operation), and a microphone 170 (among other possible components). The sensor array 171 may be in a sensor array region that is defined by a protrusion 174 in the rear cover 175 of the device 160. The protrusion 174 may define a portion of the rear exterior surface of the device 100, and may at least partially define a raised sensor array region of the sensor array 171.

The rear cover 175, including the protrusion 174, may be formed from a single piece of material, such as glass (or a glass ceramic or other glass-like material). In such cases, the protrusion 174 may be formed by a machining operation in which material is removed from a precursor material (e.g., a blank) to form the surfaces and shapes of the rear cover 175 and the protrusion 174. In some cases, the rear cover 175 is formed and/or shaped by a combination of operations, such as a gross molding operation that generally defines the overall shape of the rear cover 175 (e.g., having a thicker or protruded region at one end), followed by a machining or other forming operation to produce the final shape. The gross molding operation may include a slumping operation. As another example, the rear cover 175 is formed by adding a glass (or other material) sheet to a base sheet to define a precursor structure with an increased thickness region, from which the protrusion 174 is formed.

As shown and described, the rear cover 175 may have a recessed region opposite the protrusion 174. By forming the recessed region opposite the protrusion 174, additional space may be provided in that region of the device 160 to contain components, including, without limitation, at least a portion of a circuit board assembly, the camera 172, the microphone 170, the flash 173, front-facing cameras and sensors, a speaker module (e.g., for providing sound output from one or more speaker openings), and the like.

The protrusion 174 may extend substantially entirely from one sidewall of the housing structure 164 to an opposite sidewall of the housing structure 164 (e.g., completely across the back of the device 160 from right to left), and may be centered (e.g., relative to a central longitudinal axis). The protrusion 174 may have a generally pill-shaped (or obround or stadium-shaped) profile, with a longitudinal axis extending generally from left to right across the rear of the device 160.

The components of the rear-facing sensor array 171 may be aligned on the longitudinal axis of the protrusion 174. Thus, for example, the camera 172, the microphone 170, and the flash 173 may be aligned on the longitudinal axis of the protrusion 174, though other configurations are also contemplated.

FIG. 17A is a cross-sectional perspective view of a portion of the rear cover 175. As shown in FIG. 17A, the protrusion 174 along the exterior surface of the rear cover 175 corresponds to a recess 1700 along the interior surface of the rear cover 175. The recess 1700 provides interior volume within the device enclosure to accommodate components like a circuit board assembly, processing element, the camera 172, the flash 173, the microphone 170 (and other audio modules), and the like (and/or portions of these or other components).

As described herein, the protrusion 174 defines a first portion of a rear surface of the device 160. The rear cover 175 also defines a panel region 1701 that defines a second portion of the rear surface of the mobile phone. The panel region 1701 may be below the protrusion 174, and may correspond to a portion of the device 160 that is thinner than the device at the protrusion 174.

The depth of the recess 1700 (e.g., from the interior surface at the panel region 1701 to the bottom surface of the recess 1700) may be between about 1.0 mm and about 4.0 mm, or between about 2.0 mm and about 3.0 mm. Other depths may also be used.

The rear cover 175 may have a different thickness at the panel region 1701 than at the protrusion 174. For example, the thickness of the rear cover 175 at the panel region 1701 may be less than the thickness of the rear cover 175 at the protrusion 174. For example, the thickness of the rear cover 175 at the panel region 1701 may be between about 0.5 mm and about 0.8 mm, and the thickness of the rear cover 175 at the protrusion 174 may be between about 0.8 mm and about 1.0 mm. In some cases, the thickness of the rear cover 175 is substantially the same (e.g., equal) at the panel region 1701 and the protrusion 174.

The rear cover 175 also defines a curved transition surface 1707 (e.g., a curved transition region) along an interior surface of the rear cover 175 and extending from the panel region 1701 to the bottom surface of the recess 1700. The curved transition surface 1707 may at least partially define the recess 1700. The curved transition surface 1707 may also extend from a portion of a mounting interface of the rear cover 175, as described herein. The rear cover 175 may also define an exterior curved transition surface 1713 along the exterior surface of the rear cover 175 and extending from the panel region 1701 to the top surface of the protrusion 174. The curved transition surfaces 1707, 1713 may be part of a transition region between the panel region 1701 and the protrusion 174 (and/or the rear-facing sensor array region defined by the protrusion 174).

As described herein, the rear cover 175 may be formed at least in part by machining. In some cases, both the interior curved transition surface 1707 and the exterior curved transition surface 1713 may be machined surfaces.

A polymer structure 1702 may be coupled to the interior surface of the rear cover 175. The polymer structure 1702 may be coupled to the rear cover 175 along the curved transition surface 1707. The polymer structure 1702 may bond to the glass surface of the rear cover 175, and may also couple other components to the rear cover 175. For example, mounting tabs 1708 may be at least partially encapsulated in the polymer structure 1702, and thereby coupling the mounting tabs 1708 to the rear cover 175. The mounting tabs 1708 may mate with a corresponding connector that is coupled to the housing structure 164 to secure the rear cover 175 to the housing structure 164 (FIG. 4).

The polymer structure 1702 may be a thermoset polymer structure that is molded against the curved transition surface 1707 to conform to the transition surface and encapsulate the mounting tabs 1708 and a support plate 1710, as described herein.

The device 160 may also include a support plate 1710 positioned in the recess 1700 along a bottom surface of the recess 1700 (e.g., an interior surface portion of the rear cover 175). The support plate 1710 may be a structural mounting point for components of the device 160, such as a camera module (e.g., a rear-facing camera module), a flash module (e.g., to illuminate a subject during an image capture operation), and the like. For example, the camera module 172 (e.g., rear-facing camera module) may be coupled to the support plate 1710, thereby coupling the camera module to the rear cover 175. The support plate 1710 may also be at least partially encapsulated by the polymer structure 1702. For example, at least part of a peripheral portion of the support plate 1710 may be encapsulated by the polymer structure 1702, as illustrated in FIG. 17B.

FIG. 17B illustrates a partial cross-sectional view of the rear cover assembly of the device 160 (corresponding to a section along line 20A-20A in FIG. 16). As shown in FIG. 17B, the polymer structure 1702 may define a first portion 1704 of a mounting interface and an interior surface portion of the rear cover 175 may define a second portion 1706 of the mounting interface. The rear cover 175 may be coupled to a housing structure (e.g., the housing structure 164) along the mounting interface, such as via adhesive 1712. The adhesive 1712 may be a continuous adhesive that extends along both the first and second portions of the mounting interface. In some cases, the rear cover 175 is adhered to the housing structure 164 along substantially the entire outer periphery of the rear cover 175. This may seal the device 160 against ingress of dirt, liquid, or other contaminants, and may securely attach the rear cover 175 to the housing structure 164. Proximate the protrusion, the mounting interface may be defined by both the rear cover 175 and the polymer structure 1702. In some regions of the rear cover 175, the mounting interface is defined solely by the interior surface of the rear cover 175.

Notably, first portion 1704 of the mounting surface, defined by the polymer structure 1702, and the second portion of the mounting surface, defined by the rear cover 175, may be coplanar. The coplanarity may be defined at least in part by the molding process that forms the polymer structure 1702. In particular, FIG. 17C illustrates the rear cover 175 prior to the application of the polymer structure 1702. As shown, a mold 1716 may be positioned relative to the rear cover 175, and the mold 1716 may define a mold cavity 1714 that corresponds to the shape of the polymer structure 1702. In examples where the polymer structure 1702 encapsulates other components, such as mounting tabs 1708, the mounting tabs may be held in their desired position by a fixture. A flowable thermoset polymer material may be injected or otherwise introduced into the mold cavity 1714, which causes the flowable polymer material to flow into contact with the rear cover 175 (e.g., on the curved transition surface 1707) and encapsulate a portion of the support plate 1710 and the mounting tabs 1708. The flowable thermoset polymer material may harden (e.g., cure) and adhere to the rear cover 175 along the curved transition surface 1707.

As shown, the mold 1716 may include a flat or planar surface that contacts the mounting interface of the rear cover 175 at the top of the curved transition surface. This results in the polymer structure 1702 forming the first portion 1704 of the mounting interface that is coplanar with the second portion 1706 defined by the rear cover 175. In the recess 1700, the mold 1716 may contact the support plate 1710 to define how far along the surface of the support plate 1710 the polymer structure 1702 extends.

The molding operation described with respect to FIG. 17C may be a low injection pressure overmolding process. In such cases, the flowable material may be cured or otherwise hardened with an ultraviolet curing operation. The mold 1716 may be optically transmissive (e.g., at target wavelengths) to allow ultraviolet light to reach and cure the flowable material.

The rear cover 175 may also include a cosmetic member 1711 positioned on the interior surface of the silicate-based material substrate of the rear cover 175. In some cases, the cosmetic member 1711 extends over the entire or substantially entire interior surface of the rear cover 175, including along the interior surfaces of the panel region 1701, the protrusion 174, and the curved transition surface 1707. The cosmetic member 1711 may therefore be positioned between the silicate-based material rear cover member and the polymer structure 1702.

The cosmetic member 1711 may occlude the interior components of the device 160 while also imparting a cosmetic appearance (e.g., a color, image, pattern, etc.) that is visible along the exterior of the rear cover 175. The cosmetic member 1711 may include at least one opaque layer applied directly to the surface of the silicate-based material substrate, and at least one outer layer over the at least one opaque layer. The polymer structure 1702 may adhere to the outer layer, as shown in FIGS. 17B-17C. In some cases, the cosmetic member 1711 has a thickness between about 30 microns and about 70 microns.

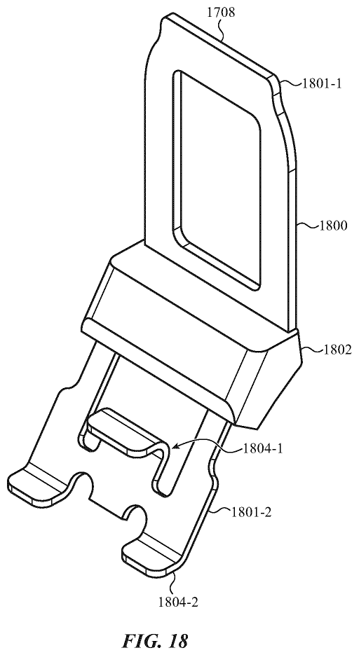

FIG. 18 illustrates an example mounting tab 1708 that may be at least partially encapsulated in the polymer structure 1702. The mounting tab 1708 may be configured to engage with a clip or other complementary mechanism of the device 160 to couple the rear cover 175 to the housing structure 164. The mounting tab 1708 may include a frame structure 1800 and a body structure 1802. The body structure 1802 may be a polymer material and may at least partially encapsulate the frame structure 1800 (which may be metal). The frame structure 1800 defines a tab portion 1801-1 that is configured to engage with the clip or other complementary mechanism of the device 160, and a retention portion 1801-2 that is configured to be embedded and/or encapsulated in the polymer structure 1702. The retention portion 1801-2 may include interlocking features 1804 (e.g., 1804-1, 1804-2) which may be portions of the metal frame structure that extend obliquely from the retention portion 1801-2. The obliquely extending interlocking features may define a strong structural engagement with the polymer structure 1702, and may inhibit extraction of the mounting tab 1708 from the polymer structure 1702.

The body structure 1802 may also be at least partially encapsulated in the polymer structure 1702. In some cases, the body structure 1802 provides mold contact surfaces that the mold 1716 contacts during the molding operation. More particularly, the body structure may provide more uniform, flatter, and/or larger surfaces for the mold 1716 to contact (as compared to the frame structure 1800 alone), thereby inhibiting leaking through the mold/mounting tab interface during molding operations.

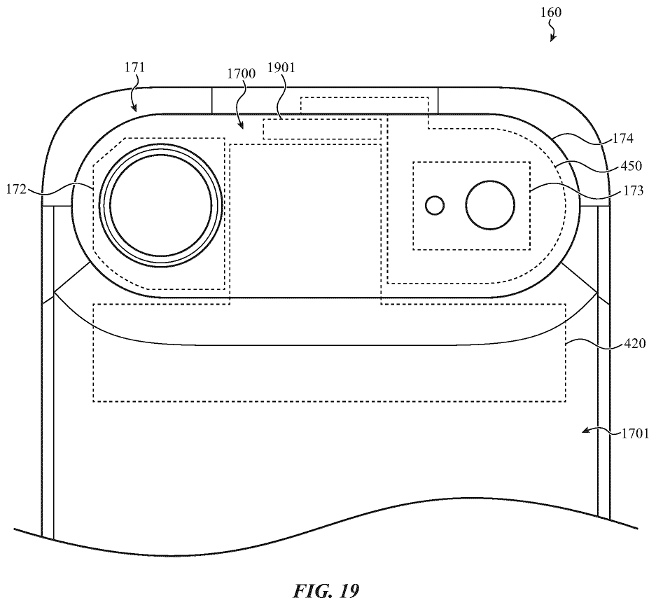

As described herein, the protrusion 174 and corresponding recess 1700 of the rear cover 175 provide additional internal volume within the device 160 in which components may be positioned. FIG. 19 illustrates a portion of the device 160, illustrating example positions of some components of the device 160 relative to the recess 1700. As shown, some components span both the recess 1700 and the panel region 1701, while others are positioned entirely or substantially entirely in the recess 1700. For example, the circuit board assembly 420 may span both the recess 1700 and the panel region 1701. The camera module 172, flash module 173 (e.g., to illuminate a subject during an image capture operation), speaker module 450, and front-facing sensors 1901 (e.g., a front-facing camera, optical facial recognition system) may be positioned entirely or substantially entirely within the recess 1700 (or in the internal volume that is defined by and/or below the recess 1700).

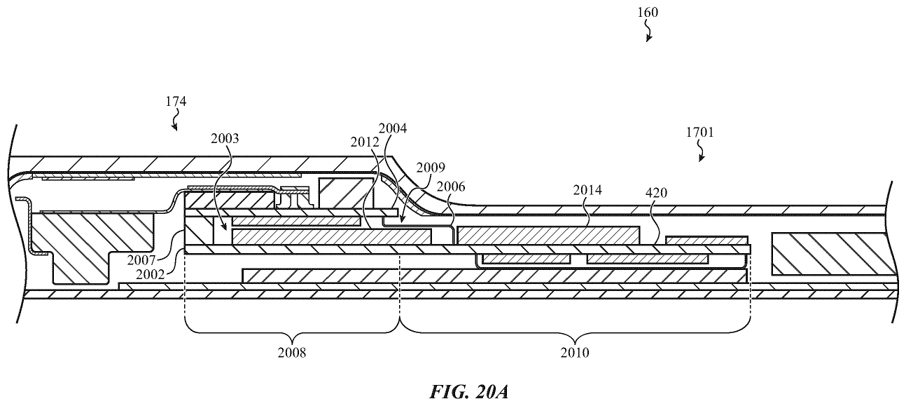

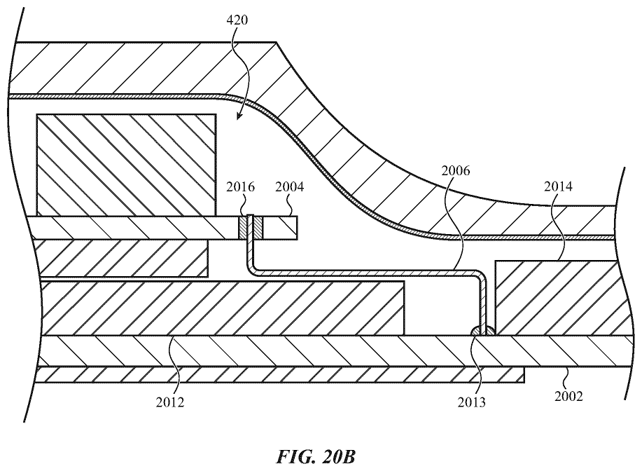

FIG. 20A is a partial cross-sectional view of the device 160, viewed along line 20A-20A in FIG. 16. FIG. 20A illustrates an example arrangement of components within the device 160. As described herein, the configuration of the rear cover 175 of the device 160, and in particular the protrusion 174 and the corresponding recess 1700, provide a portion of an interior volume that has an increased height. This portion of the interior volume provides space for mounting various device components, as described herein.

In addition to the volume defined by the recess 1700, device components may also be positioned in the internal volume defined below the panel region 1701. In some cases, components may span the recess region 1700 and the panel region 1701, and in such cases, the components may be configured to conform to the available space inside the device. For example, the circuit board assembly 420 may be configured with a stepped multi-layer configuration that allows the circuit board assembly 420 to span both the recess region and the panel region, while maximizing volume usage in both regions.

For example, as shown in FIG. 20A, the circuit board assembly 420 includes a first substrate 2002 and a second substrate 2004. The second substrate 2004 (or top substrate) may be set apart from the first substrate 2002 (or bottom substrate) to define an internal region 2003. Circuit components (e.g., processors, memory, integrated circuits, etc.) may be coupled to various surfaces of the circuit board assembly 420, including exterior surfaces, as well as the surfaces that define the internal region 2003.

The circuit board assembly 420 may include a dual-layer region 2008, where the second substrate 2004 is positioned over the first substrate 2002, as well as a single-layer region 2010. The dual-layer region 2008 may be positioned in the volume defined by the recess of the device, while the single-layer region 2010 may be positioned in the volume defined by the panel region of the device. Thus, the circuit board assembly 420 has a stepped, dual-thickness configuration that allows it to span both the larger, recess region and the thinner panel region, allowing highly efficient use of the volume of the device and providing ample space for the numerous components coupled to the circuit board assembly 420.

In some cases, the internal volume of a multi-layer circuit board assembly is naturally electromagnetically shielded by conductive elements in both the upper and lower circuit board substrates, as well as in the wall that separates the substrates. In the case of the circuit board assembly 420, however, the internal region 2003 is not completely enclosed by the second substrate 2004. In particular, completely enclosing the internal region 2003 would not allow a component, such as the circuit element 2012 (e.g., a processor), to span both the dual-layer region 2008 and the single-layer region 2010, and would generally limit the possible arrangements of components on the circuit board assembly 420.

In order to provide shielding to the components in the internal region 2003 without completely enclosing the internal region 2003 with circuit board substrates and wall structures (e.g., the wall structure 2007), the circuit board assembly 420 may include an inter-level shield member 2006. The inter-level shield member 2006 may extend from the first substrate 2002 to the second substrate 2004 and may be conductively coupled to both the first and second substrates to define an electromagnetic shield around the opening 2009 between the substrates. The inter-level shield member 2006 may extend a distance away from the opening 2009, thereby extending the shielded area beyond that which is covered by the second substrate 2004. Moreover, since the inter-level shield member 2006 is thinner than the second substrate 2004, the inter-level shield member 2006 may still fit under the panel region of the device 160, thus allowing for greater use of the available volume within the device. In some cases, at least a first portion of the inter-level shield member 2006 is positioned in the recess region, while at least a second portion of the inter-level shield member 2006 is positioned in the panel region 1701. Similarly, the circuit element 2012 (e.g., a processor) may be positioned at least partly in the recess region and at least partly in the panel region. As another example, the circuit element 2012 may be positioned at least partially in a volume defined between the first and second substrates 2002, 2004, and at least partially in a volume defined between the first substrate 2002 and the inter-level shield member 2006.

FIG. 20B is a partial cross-sectional view of the device 160, illustrating additional detail of the circuit board assembly 420 and the inter-level shield member 2006. As described herein, the inter-level shield member 2006 may be conductively (and structurally) coupled to the first and second substrates 2002, 2004. For example, the inter-level shield member 2006 may be soldered to the first substrate 2002 (e.g., at solder joint 2013) and soldered to the second substrate 2004. In some cases, the second substrate 2004 may include holes 2016 (e.g., plated through-holes). Tabs or other features of the inter-level shield member 2006 may extend into the holes 2016, and are soldered in place. Thus, the inter-level shield member 2006 is conductively coupled to the first and second substrates (e.g., to electrical grounds of the substrates), thereby forming a shield around the internal region 2003.

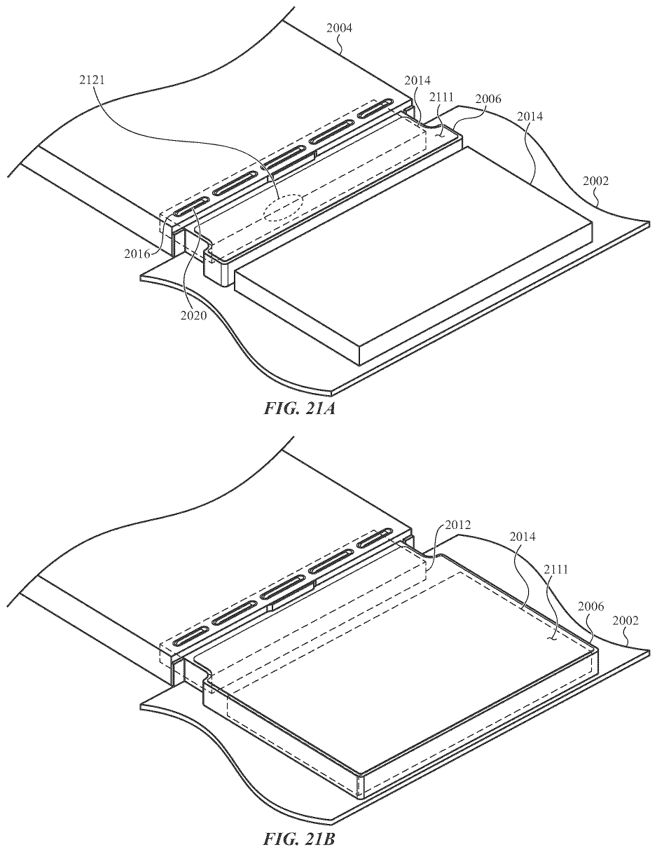

FIG. 21A illustrates a perspective view of the circuit board assembly 420. As shown, tabs 2020 of the inter-level shield member 2006 are positioned in the holes 2016 of the second substrate 2004. FIG. 21A also illustrates the relative positioning of the circuit element 2012 under the inter-level shield member 2006, and another circuit element 2014 outside of the inter-level shield member 2006 and on the substrate 2002 (as shown in FIG. 20A). Thus, as shown, the circuit element 2014 is within the shielding structure defined by the first and second substrates and the inter-level shield member 2006.

In some cases, access to the internal region 2003 may be desired, even after the inter-level shield member 2006 has been coupled to the first and second substrates. For example, in some cases, an underfill material (e.g., a flowable polymer material that at least partially surrounds and/or encapsulates circuit elements in the internal region 2003) may be introduced into the internal region 2003 after the inter-level shield member 2006 is soldered or otherwise secured to the substrates. In such cases, one or more holes (e.g., hole 2121) may be defined through the top surface of the inter-level shield member 2006. These holes may allow the underfill material to be introduced into the internal region 2003 and/or on the first substrate 2002 after the inter-level shield member 2006 is attached. The holes may be covered by a conductive material, such as a conductive layer 2111 (e.g., a woven metallic fabric, a metal or conductive foil, a metal or conductive sheet, etc.). The conductive layer 2111 may conductively couple to the inter-level shield member 2006, thereby maintaining the integrity of the shielding functionality of the inter-level shield member 2006. In some cases, the hole 2121 may also provide visual access to the internal region 2003 for inspection, prior to the attachment of the conductive layer 2111. While one hole 2121 is shown, it will be understood that multiple holes may be provided.

FIG. 21B illustrates a perspective view of another example configuration for the inter-level shield member 2006. In this example, the inter-level shield member 2006 extends further along the first substrate 2002 to enclose another circuit element 2014. Since the inter-level shield member 2006 may have a height above the first substrate 2002 that can fit into the panel region of the device, the configuration shown in FIG. 21B may shield additional components on the circuit board assembly 420 without changing the overall dimensions of the device 160.

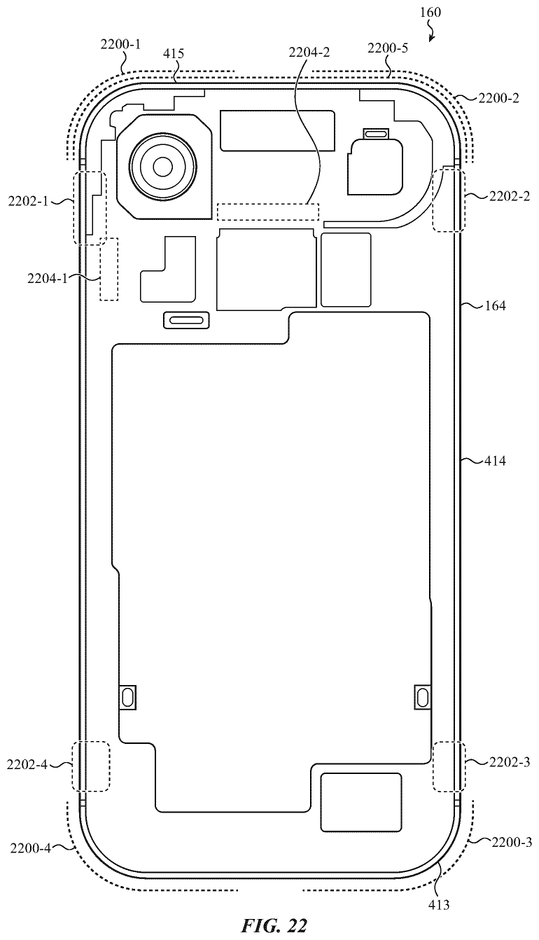

FIG. 22 is a simplified plan view of the front of the device 160 with the rear cover assembly removed. As described with respect to other device housings, the housing structure 164 may include multiple metal segments that are configured to operate as antennas. FIG. 22 illustrates an example arrangement of antennas of the device 160, including antennas defined by metal housing segments and antenna modules within the device 160. For example, the device 160 may include a first set of antennas 2200 (2200-1-2200-5) that are defined by various top and bottom segments of the housing structure 164. For example, antennas 2200-1 and 2200-2 may be defined by the metal housing segment 415 and antennas 2200-3 and 2200-4 may be defined by the metal housing segment 413. As described herein, the housing segment 415 may define at least a portion of a top side of the device 160 and at least a portion of two corners of the device 160. The housing segment 415 may define a continuous u-shaped structure that defines the top exterior surface and at least a portion of two corners of the device 160. The housing segment 413 may define at least a portion of a bottom side of the device 160 and at least a portion of two corners of the device 160. The housing segment 413 may define a continuous u-shaped structure that defines the bottom exterior surface and at least a portion of two corners of the device 160.

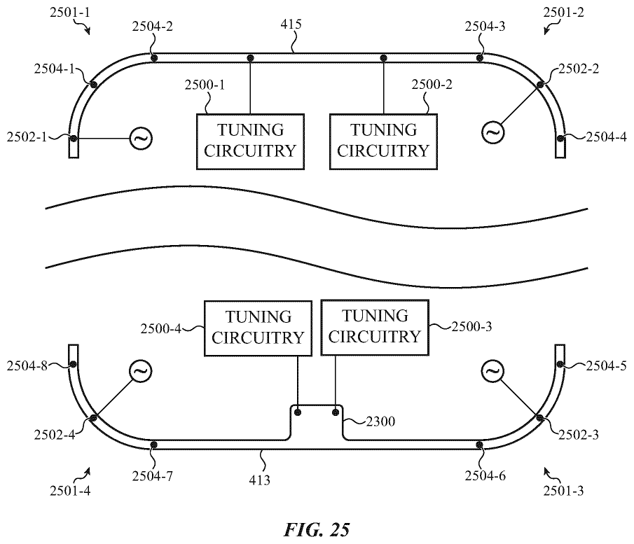

As described herein, different portions of the continuous metal housing segments 413, 415 may be used as antennas and/or antenna radiators. In order to facilitate the use of different portions of a continuous metal segment as separate antenna radiators or elements (e.g., separately controlled, or otherwise configured to send and receive wireless signals substantially independently of other portions of the metal segment), various connections may be made to the housing segments to define the radiating lengths of antennas, adjust the radiating properties of the metal segments, and the like, as described in greater detail with respect to FIG. 25. In some cases, the device may selectively configure the housing segments 413, 415 to operate at different radiating lengths. For example, in some communication modes, the device 160 may configure the housing segment 415 to operate as two separate radiating elements, 2200-1, 2200-2 (e.g., in a MIMO mode). In other communication modes, the device 160 may configure the housing segment 415 to operate as a single radiating element 2200-5 (e.g., spanning portions of the housing segment 415 that were used as separate radiating elements).

The housing segment 414 may also define antennas. For example, the housing segment 414 may define antennas 2202-1-2202-4, which are positioned along lateral side walls of the device 160 (proximate the corners of the device). The device 160 may also include antenna modules 2204-1, 2204-2 which may be positioned within the enclosure of the device and may radiate through the front and/or rear covers of the device.

The antennas of the device 160 may be configured to operate at various frequencies and/or frequency bands or ranges, and may be operated together in various modes, as described herein (including, for example 2×2 MIMO modes, 4×4 MIMO modes, and the like). In some cases, the antennas 2202-4, 2202-3, and 2200-2 may be configured for communications in a first frequency range (e.g., about 3 GHz to about 5 GHZ), the antenna 2204-2 may be configured for communications in a second frequency range (e.g., about 7.5 GHz to about 8.5 GHZ, about 6 GHz to about 9 GHz, or another suitable band or range), the antenna 2204-1 may be configured for communications in a third frequency range (e.g., Wi-Fi communications, such as 5 GHz, 6 GHz Wi-Fi communications), the antenna 2202-2 may be configured for communications in a fourth frequency range (e.g., GPS communications, such as using the GPS L5 signal specifications, or another GPS signal specification). The antenna 2204-2 may also be configured for communications in the third frequency range (e.g., Wi-Fi communications, such as 5 GHz, 6 GHz Wi-Fi communications), and may be used in conjunction with the antenna 2204-1 (e.g., in a MIMO mode).

The other antennas, including the antennas 2200-1-2200-5 may be configured for various combinations of wireless communications, including various frequency bands, communications protocols and/or standards, and the like. For example, the antennas 2200-4, 2200-3, and 2200-5 may be configured for operations between about 600 MHz to about 1000 MHz, for communications in a frequency range between about 1400 MHz to about 1500 MHz, for operations between about 1700 MHz to about 2200 MHz, and for operations between about 2300 MHz to about 2700 MHz. The antenna 2200-1 may be configured for operations between about 1700 MHz to about 2200 MHz, for operations between about 2300 MHz to about 2700 MHz, and for operations between about 3400 MHz and about 5000 MHz. Tuning circuitry or other wireless communications circuitry may operate the same antenna (e.g., the same conductive portion of the housing) in different modes and/or for different frequencies. For example, the antennas may be switchable between operations in different frequency ranges or bands.

As described herein, one or more of the antennas of the device 160 may be configured for use in multiple frequency bands and/or communications protocols. For example, the antennas 2200-4 and 2200-3 (among others) may be switchable to operate in different frequency bands or ranges (e.g., switching between high band and low band communications, or between or among other frequency bands or ranges). Tuning circuitry and/or grounding circuitry may be used to configure a particular antenna or portion of a housing structure for operation in a particular band or range. It will be understood that an antenna being configured for operations relating to a certain frequency band or range includes the antenna being used to send and/or receive wireless signals within or around those frequency bands or ranges. It will be understood that the example frequency ranges or bands of the antennas described herein are merely examples, and the various antenna elements or radiators may be tuned for different frequency ranges or bands, and/or different combinations of frequency ranges or bands, in various implementations.

The various antennas and antenna modules may be adapted to use or be used with beam-forming or other techniques to adapt signal reception depending on the use case. For example, groups of antennas may be used for conducting MIMO wireless communications schemes, including 4G, 4G LTE, and/or 5G MIMO communication protocols.

As described herein, the device 160 includes a charging port 165, which may be defined at least in part by a hole formed directly through the housing structure 164 (e.g., along a bottom side surface) and which may provide access to a charging and/or communications connector therein. In some cases, the surface of the charging port 165 (e.g., the surface that is defined by the material of the housing structure 164) may define an inner surface of the charging port and may be configured to interface (e.g., contact) with a corresponding plug. This configuration may obviate the need for a separate charging port sleeve or shield member to be positioned within the charging port 165, and may facilitate a reduction in the overall thickness of the device (e.g., distance between the front and rear surfaces).

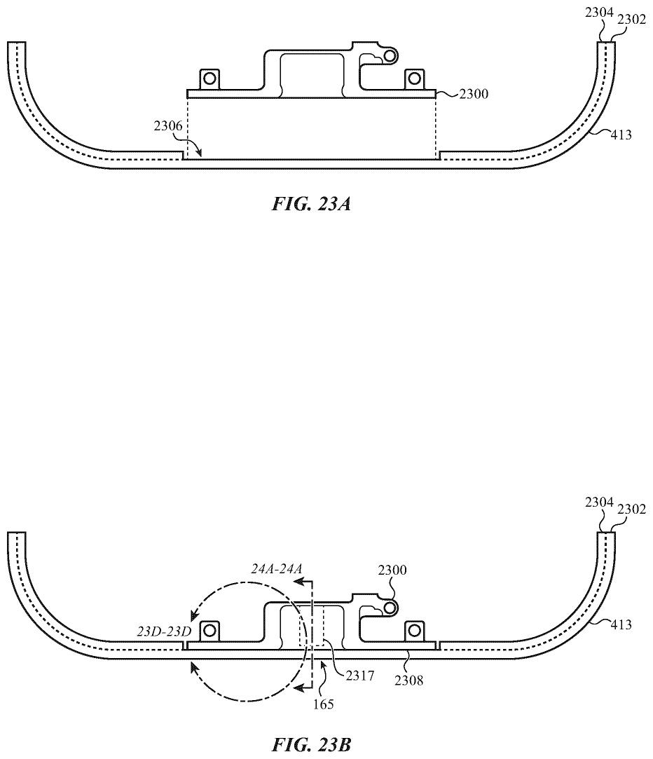

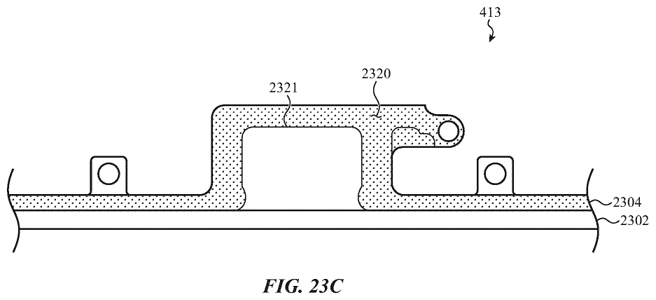

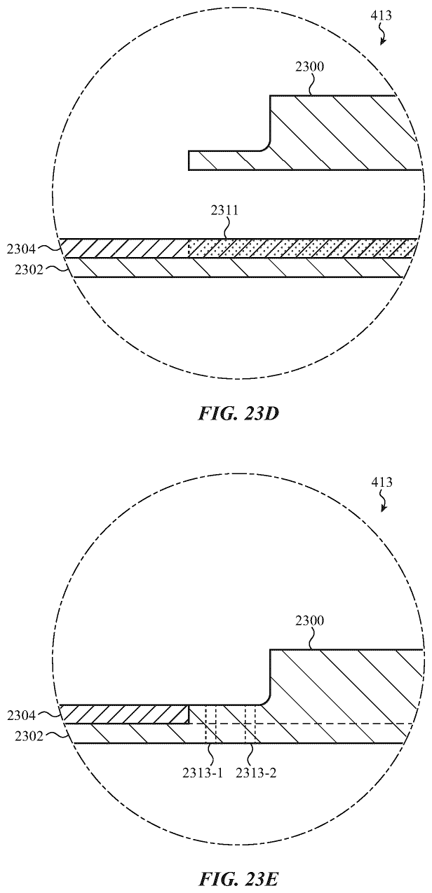

FIGS. 23A-23B illustrate an example construction of the charging port 165 of the device 160. For example, FIG. 23A illustrates a partial exploded view of the housing segment 413 of the device 160. As described herein, the housing segment 413 may define first and second corners of the device 160, and the charging port 165 may be positioned between the first and second corners. Moreover, the portions of the housing segment 413 on opposite sides of the charging port 165 may be configured to operate as antennas, as described herein. Further, the housing segment 413 may be conductively coupled to electrical ground of the device (and/or to other wireless communication circuitry) that effectively isolates the radiating portions of the housing segment 413 from the charging port 165.

The housing segment 413 may be a clad structure comprising a first portion 2302 (e.g., an exterior portion) formed of a first metal and defining an exterior surface of the housing segment 413, and a second portion 2304 (e.g., an interior portion) formed of a second metal and defining at least a portion of an interior surface of the housing segment 413. The first metal may be titanium and the second metal may be aluminum. The clad structure may be constructed by extruding a clad precursor and forming and/or machining the precursor into a final shape. The discussion of clad structures provided herein are generally applicable to the clad structure of the housing segment 413. Moreover, it will be understood that the housing segments 414, 415 may also be formed from or include clad structures.

The charging port 165 may be defined at least in part by a port structure 2300 that is coupled to the housing segment 413 and defines at least an interior wall of the charging port 165. As described herein, the port structure 2300 may also define a mounting surface for the front and rear cover assemblies.

To couple the port structure 2300 to the housing segment 413, a portion of the core of the clad structure (e.g., the second portion 2304) may be removed. This may form a recess and expose an interior surface 2306 of first portion 2302 of the clad structure to which the port structure 2300 may be coupled. In some cases, the port structure 2300 is made of the same material (e.g., metal) as the first portion 2302 (e.g., the cladding portion), such as titanium. Accordingly, by removing a portion of the core material, the port structure 2300 may be coupled to a section of the housing of the same material. The port structure 2300 may be welded to the first portion 2302 of the clad structure to couple the port structure 2300 to the housing segment 413. The welding may include laser welding along the interface between the port structure 2300 and the cladding (e.g., the first portion 2302). As depicted, the laser may be directed into the page, along the seam between the housing segment 413 and the port structure 2300. Welding the port structure 2300 to the housing segment 413 may define a unitary structure (e.g., a unitary metal segment) that includes the port structure 2300 as well as multiple antenna radiators, as described herein.

FIGS. 23D-23E illustrate a detail view of the housing segment 413 before (FIG. 23D) and after (FIG. 23E) welding the port structure 2300 to the housing segment 413. FIGS. 23D-23E are illustrated as cross-sections through the components (e.g., in an x-y plane) to more clearly show the materials and structures. As shown in FIG. 23D, the material 2311 of the second portion 2304 (core portion) may be removed to expose the surface of the first portion 2302 (cladding portion). The port structure 2300 may then be welded to the first portion 2302, resulting in the unitary structure shown in FIG. 23E. A weld seam 2315 may exist between the cladding and the port structure 2300, but the ultimate structure may be a unitary structure. Further, in cases where the materials of the cladding and the port structure 2300 are the same, the port structure 2300 and the cladding may be substantially indistinguishable from one another.

In some cases, after the port structure 2300 is welded to the housing segment 413, additional machining and/or forming operations are performed. For example, as described herein, the port structure 2300 may ultimately define mounting surfaces to which front and rear cover assemblies are attached. In some cases, the mounting surfaces are machined after the port structure 2300 is welded to the housing segment 413. In some cases, the mounting surfaces along the housing segment 413 and the port structure 2300 are machined as part of the same operation, resulting in a substantially flush, planar mounting surface.

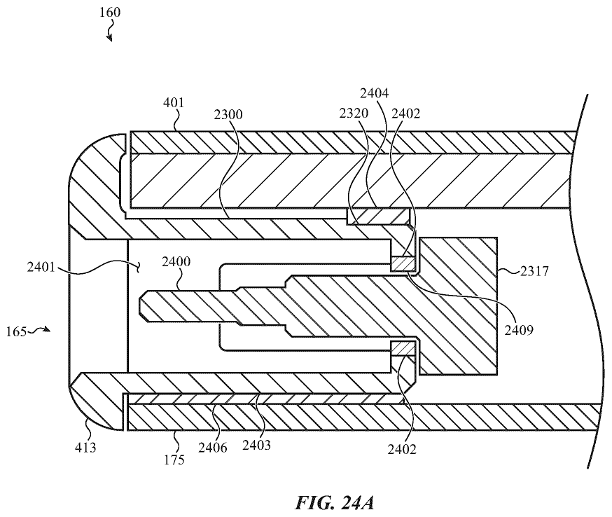

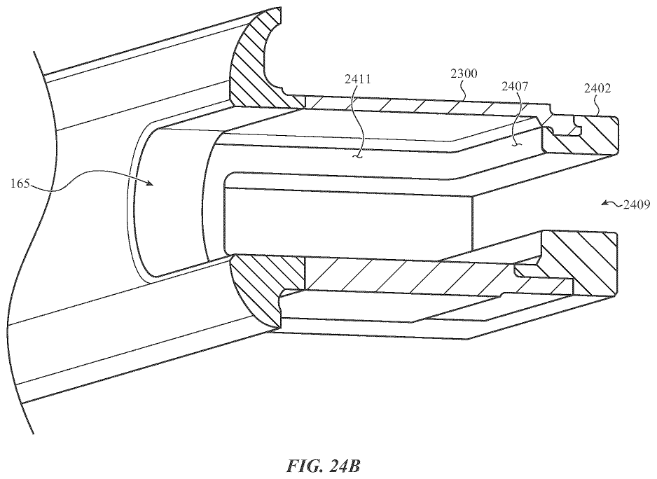

Once coupled (and optional additional machining or forming operations are performed), as shown in FIG. 23B, the port structure 2300 extends from an interior side of the unitary metal housing segment 413. A charging cable connector 2317 (which may correspond to or be the cable connector 453, FIG. 4) may be coupled to the port structure 2300. A connection member 2400 (FIG. 24) of the charging cable connector 2317 may extend into the port to couple to a charging cable.

As described herein, the port structure, as well as the cladding of the housing segment 413 (e.g., first portion 2302) define at least a portion of the interior wall of the charging port 165. Thus, since the port structure 2300 is an integral part of the metal housing segment 413, the housing segment itself defines a portion of the interior wall of the charging port 165, where the wall is configured to surround an outer periphery of a plug of a charging cable. Thus, a separate charging port or charging cable receptacle, which may include a sleeve or other separate material structure to define the interior wall of the charging port 165, may be omitted. By omitting the separate charging port or charging cable receptacle, the housing segment 413 may be made thinner, since redundant structures may be omitted and the charging port 165 may be integrated with the housing structure itself.

Returning to FIG. 23E, in some cases, holes 2313 may be formed through the housing segment 413 where the core material has been removed and the port structure 2300 has been welded to the cladding. The holes 2313 may provide acoustic and/or environmental access to internal components, such as microphones, speakers, pressure sensors, pressure equalization vents or valves, or the like. By forming the holes 2313 through the portion of the housing segment that does not have a seam between dissimilar materials, the potential for galvanic corrosion may be reduced. In particular, since the core material has been removed and the port structure 2300 and the cladding are the same material, there may be no dissimilar-material seams inside the holes 2313. Since the holes 2313 may be exposed to the environment (e.g., water, liquid, humidity, etc.), providing a single material surface may help avoid or inhibit corrosion or other adverse outcomes. By contrast, forming the holes 2313 where the clad structure includes two dissimilar metals may introduce a dissimilar-material seam within the holes.

FIG. 23C illustrates an example configuration of the unitary metal housing segment 413 with the port structure 2300. The port structure 2300 may include a receptacle portion 2321, which may generally correspond to the hole or chamber of the port structure 2300 that receives a plug of a charging cable therein. In some cases, the receptacle portion 2321 may define a minimum thickness, since it must be at least large enough to accommodate the plug. However, adhering a cover assembly (e.g., the front cover assembly) to the receptacle portion 2321 may increase the thickness of the device. Accordingly, the port structure 2300 may define an outer surface 2320 (e.g., a mounting surface) to which the front cover assembly may be coupled (e.g., via adhesive, as described herein). The outer surface 2320 may extend around at least part of the periphery of the receptacle portion 2321, and may be recessed relative to the receptacle portion 2321, such that the overall device thickness may be reduced relative to a configuration where the front cover is mounted to the receptacle portion 2321. Further, FIG. 23C illustrates that the mounting surface is contiguous (e.g., flush and/or coplanar) along both the port structure 2300 and elsewhere along the housing segment 413.

FIG. 24A is a partial cross-sectional view of the device 160, viewed along line 24A-24A in FIG. 23B. FIG. 24A illustrates an example configuration of the charging port 165. For example, the port structure 2300, which is integral with the housing segment 413, defines at least part of an interior wall 2401 of the charging port 165. For example, the exposed surface of the port structure 2300 defines a portion of the interior wall 2401. A charging cable connector 2317 may be coupled to the housing segment 413. The charging cable connector 2317 includes a connection member 2400 that extends through a hole 2409 formed through a bottom surface of the charging port 165. The connection member 2400 is configured to conductively couple to a plug of a charging cable that is inserted into the charging port 165. Notably, the charging cable connector 2317 is not integrated with a wall or receptacle structure that is separate from the housing segment 413. Rather, the charging cable connector 2317 may rely on the wall of the port structure 2300 to define the interior wall of the charging port 165. In some cases, an exposed metal portion of the interior wall of the charging port (e.g., defined by the port structure 2300) may conductively couple to a shielding portion of plug of a charging cable.

In some cases, a molded polymer structure 2402 may be incorporated with the port structure 2300 and the housing segment 413 more generally. The molded polymer structure 2402 may conductively isolate the charging cable connector 2317 from the port structure 2300.

The molded polymer structure 2402 may also define various portions of the charging port 165, and may provide conductive isolation between various components of the charging port 165 and/or a plug that is received in the charging port 165. In particular, the molded polymer structure 2402 may be formed from or include a nonconductive material and may define nonconductive portions of the interior surface of the charging port 165 for providing conductive isolation between components. For example, with reference to FIG. 24B, which is a perspective cross-sectional view of the device 160 through the charging port 165, the molded polymer structure 2402 may be coupled to an end of the port structure 2300 and define at least a portion of a bottom surface 2407 of the charging port 165. As shown, the molded polymer structure 2402 defines a hole 2409 through which the charging cable connector 2317 extends, and may conductively isolate the charging cable connector 2317 from the port structure 2300. Further, the molded polymer structure 2402 may define at least a portion 2411 of the interior wall of the charging port 165 (e.g., a portion of the bottom surface). As described herein, the port structure 2300 itself may define another portion of the interior wall of the charging port 165 (e.g., a side wall). In some cases, an exposed conductive interior wall surface may contact the shielding portion of a plug that is inserted into the charging port 165.

FIG. 24A further illustrates the front cover assembly 401 and the rear cover 175 coupled to the housing segment 413, and in particular, to outer surfaces of the port structure 2300. As described herein, the port structure 2300 defines a first outer surface 2320 (which may extend around the receptacle portion 2321 (e.g., away from the outer periphery of the device 160), thereby allowing closer coupling of the front cover assembly 401 to the port structure 2300. An adhesive 2404 may be positioned on the outer surface and may couple (e.g., adhere) the front cover assembly 401 to the housing segment 413. The adhesive 2404 may extend continuously around the housing structure 164 to adhere the front cover assembly 401 to the housing structure 164.

The port structure 2300 may define a second outer surface 2403, opposite the first outer surface 2320, that faces the rear of the device 160. The rear cover 175 may be coupled to the second outer surface 2403 via an adhesive 2406. The adhesive 2406 may extend continuously around the housing structure 164 to adhere the rear cover 175 to the housing structure 164.

As described herein, the housing segments 413, 415 may be used as antenna radiators for the device 160. In some cases, wireless communication circuitry may be conductively coupled to the housing segments 413, 415 at various points to facilitate the antenna operations. FIG. 25 illustrates an example arrangement of connections to the housing segments 413, 415 to facilitate the antenna functionality. For example, wireless communication circuitry may be coupled to various feed points 2502 along the housing segments 413, 415. For example, feed point 2502-1 may be an antenna feed for a first antenna 2501-1 along a first portion of the housing segment 415, feed point 2502-2 may be an antenna feed for a second antenna 2501-2 along a second portion of the housing segment 415, feed point 2502-3 may be an antenna feed for a third antenna 2501-3 along a first portion of the housing segment 413, and feed point 2502-4 may be an antenna feed for a fourth antenna 2501-4 along a second portion of the housing segment 413. In some cases, feed points may be used or unused in different communication modes, and may act as feed points for different frequency bands, depending on how the housing segments are electrically configured. In some cases, tuning circuitry 2500 may be conductively coupled to the housing segments. Tuning circuitry may allow the housing segments to be tuned for particular frequencies and/or wireless communication operations. Tuning circuitry may be configured to selectively connect the housing segments 413, 415 to an electrical ground, which may allow for selective conductive isolation of the radiating elements of the housing segments to facilitate various wireless communications.

In some cases, tuning circuitry may be conductively coupled to or proximate the port structure 2300. This may allow the port structure to be conductively isolated from the radiating portions of the housing segments in certain operating modes. For example, in some cases, the third antenna 2501-3 may be operated in different modes. In a first mode, the radiating element may extend past the port structure 2300 and optionally incorporate the port structure 2300 and part of the antenna 2501-4 as a radiating structure. In such cases, the turning circuitry 2500 may selectively ground or unground the port structure 2300 in order to configure the housing segment 413 for particular communication operations. The tuning circuitry 2500 may perform other actions or selectively engage and/or disengage conductive members, electrical circuits or components, etc., in order to facilitate the operation of different portions of the housing segment 413 to be operated as one or more antennas.

As described herein, multiple antenna radiators may be defined by a single conductive housing segment. In some cases, the various antenna feeds, grounding points, tuning circuitry, etc., allow different portions of the housing segment to be operated as antenna radiators for different frequency bands, protocols, etc., In some cases, one portion of a housing segment may be operated via a single feed point, which may cause multiple portions of that same housing segment to radiate. For example, in some modes of operation, the housing segment 413 may be supplied with a signal (or otherwise operatively coupled to wireless communication circuitry for the purposes of sending and/or receiving wireless signals) at the feed point 2502-4 (e.g., antenna 2501-4). Due to the continuous conductive structure of the housing segment 413, as well as the largely symmetric shape of the housing segment 413 (e.g., left-to-right, about the port structure 2300) and the coupling to a common electrical ground, feeding at a single feed point 2502-4 may cause the other side of the housing segment 413 (e.g., antenna 2501-4) to radiate as well, despite not being fed with a signal at the feed point 2502-3. This feature may result in higher antenna performance (e.g., signal strength, signal to noise ratio, etc.). It will be understood that operating the housing segment 413 in this way facilitates the operation of both portions of the housing segment 413 for both transmitting and receiving wireless signals. In some cases, during antenna operations where multiple portions of a housing segment are being used as radiating structures from a single feed point, the tuning circuitry 2500-3, 2500-4 may be configured to facilitate the common operation (e.g., by interconnecting electrical tuning circuits to the housing segment 413). In some cases, during antenna operations where different portions of the housing segment 413 operate as independent antenna radiators, the tuning circuitry 2500-3, 2500-4 may be electrically coupled to an electrical ground plane (e.g., shunted to ground).

FIG. 25 also illustrates other example connection points 2504, which may be used as ground points, feed points, tuning circuitry, or the like, including various connection points to the housing segment 415. It will be understood that the description of the antenna operations with respect to the housing segment 413 apply equally and/or by analogy to the housing segment 415, including the ability to operate both sides of the housing segment 415 as an antenna radiator based on a single feed connection. Moreover, it will be understood that FIG. 25 is not meant to be limiting, and is merely an example of various connection points to the housing segments that may be used to facilitate their use as antenna radiators. It will be understood that various antenna configurations and wireless communication operations may be implemented with ground, feed, and tuning circuitry connections to the housing segments.

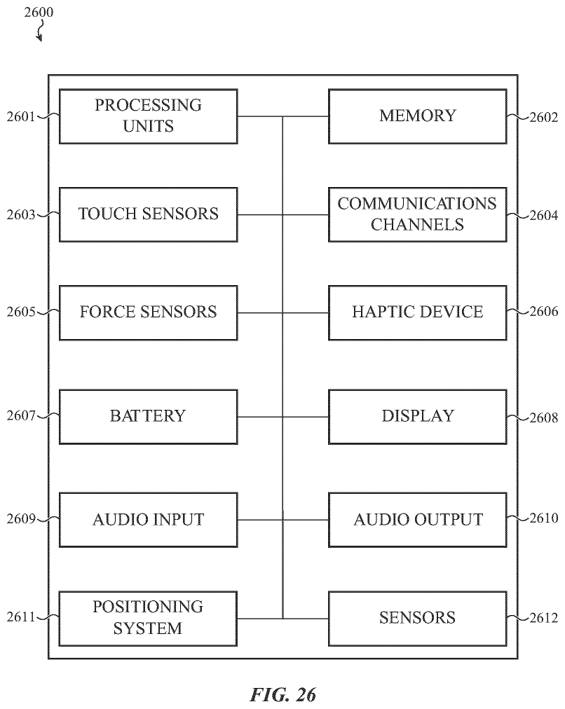

FIG. 26 depicts an example schematic diagram of an electronic device 2600. The electronic device 2600 may be an embodiment of or otherwise represent the device 100, the device 140, and/or the device 160 (or other devices described herein). The device 2600 includes one or more processing units 2601 that are configured to access a memory 2602 having instructions stored thereon. The instructions or computer programs may be configured to perform one or more of the operations or functions described with respect to the electronic devices described herein. For example, the instructions may be configured to control or coordinate the operation of one or more displays 2608, one or more touch sensors 2603, one or more force sensors 2605, one or more communication channels 2604, one or more audio input systems 2609, one or more audio output systems 2610, one or more positioning systems 2611, one or more sensors 2612, and/or one or more haptic feedback devices 2606.

The processing units 2601 of FIG. 26 may be implemented as any electronic device capable of processing, receiving, or transmitting data or instructions. For example, the processing units 2601 may include one or more of: a microprocessor, a central processing unit (CPU), an application-specific integrated circuit (ASIC), a digital signal processor (DSP), or combinations of such devices. As described herein, the term “processor” is meant to encompass a single processor or processing unit, multiple processors, multiple processing units, or other suitably configured computing element or elements. The processing units 2601 may be coupled to a circuit board assembly (which may also be referred to as a circuit board, logic board, logic board assembly, or main logic board), such as the circuit board assemblies described herein.

The memory 2602 can store electronic data that can be used by the device 2600. For example, a memory can store electrical data or content such as, for example, audio and video files, images, documents and applications, device settings and user preferences, programs, instructions, timing and control signals or data for the various modules, data structures or databases, and so on. The memory 2602 can be configured as any type of memory. By way of example only, the memory can be implemented as random access memory, read-only memory, flash memory, removable memory, or other types of storage elements, or combinations of such devices. The memory 2602 may be coupled to a circuit board assembly, such as the circuit board assemblies described herein.

The touch sensors 2603 may detect various types of touch-based inputs and generate signals or data that are able to be accessed using processor instructions. The touch sensors 2603 may use any suitable components and may rely on any suitable phenomena to detect physical inputs. For example, the touch sensors 2603 may be capacitive touch sensors, resistive touch sensors, acoustic wave sensors, or the like. The touch sensors 2603 may include any suitable components for detecting touch-based inputs and generating signals or data that are able to be accessed using processor instructions, including electrodes (e.g., electrode layers), physical components (e.g., substrates, spacing layers, structural supports, compressible elements, etc.), processors, circuitry, firmware, and the like. The touch sensors 2603 may be integrated with or otherwise configured to detect touch inputs applied to any portion of the device 2600. For example, the touch sensors 2603 may be configured to detect touch inputs applied to any portion of the device 2600 that includes a display (and may be integrated with a display). As another example, the touch sensors 2603 may be integrated with a button, switch, or other input system, and may detect touch inputs applied to a surface of the button, switch, or other input system. The touch sensors 2603 may operate in conjunction with the force sensors 2605 to generate signals or data in response to touch inputs. A touch sensor or force sensor that is positioned over a display surface or otherwise integrated with a display may be referred to herein as a touch-sensitive display, force-sensitive display, touchscreen display, or touchscreen.

The force sensors 2605 may detect various types of force-based inputs and generate signals or data that are able to be accessed using processor instructions. The force sensors 2605 may use any suitable components and may rely on any suitable phenomena to detect physical inputs. For example, the force sensors 2605 may be strain-based sensors, piezoelectric-based sensors, piezoresistive-based sensors, capacitive sensors, resistive sensors, or the like. The force sensors 2605 may include any suitable components for detecting force-based inputs and generating signals or data that are able to be accessed using processor instructions, including electrodes (e.g., electrode layers), physical components (e.g., substrates, spacing layers, structural supports, compressible elements, etc.), processors, circuitry, firmware, and the like. The force sensors 2605 may be used in conjunction with various input mechanisms to detect various types of inputs. For example, the force sensors 2605 may be used to detect presses or other force inputs that satisfy a force threshold (which may represent a more forceful input than is typical for a standard “touch” input). Like the touch sensors 2603, the force sensors 2605 may be integrated with or otherwise configured to detect force inputs applied to any portion of the device 2600. For example, the force sensors 2605 may be configured to detect force inputs applied to any portion of the device 2600 that includes a display (and may be integrated with a display), or they may be configured to detect force inputs applied to a button, switch, or other input system. The force sensors 2605 may operate in conjunction with the touch sensors 2603 to generate signals or data in response to touch- and/or force-based inputs.

The device 2600 may also include one or more haptic devices 2606. The haptic device 2606 may include one or more of a variety of haptic technologies such as, but not necessarily limited to, rotational haptic devices, linear actuators, piezoelectric devices, vibration elements, and so on. In general, the haptic device 2606 may be configured to provide punctuated and distinct feedback to a user of the device. More particularly, the haptic device 2606 may be adapted to produce a knock or tap sensation and/or a vibration sensation. Such haptic outputs may be provided in response to detection of touch and/or force inputs, and may be imparted to a user through the exterior surface of the device 2600 (e.g., via a glass or other surface that acts as a touch- and/or force-sensitive display or surface).

The one or more communication channels 2604 may include one or more wireless interface(s) that are adapted to provide communication between the processing unit(s) 2601 and an external device. The one or more communication channels 2604 may include antennas (e.g., antennas that include or use housing components as radiating members), communications circuitry, firmware, software, or any other components or systems that facilitate wireless communications with other devices. In general, the one or more communication channels 2604 may be configured to transmit and receive data and/or signals that may be interpreted by instructions executed on the processing units 2601. In some cases, the external device is part of an external communication network that is configured to exchange data with wireless devices. Generally, the wireless interface may communicate via, without limitation, radio frequency, optical, acoustic, and/or magnetic signals and may be configured to operate over a wireless interface or protocol. Example wireless interfaces include radio frequency cellular interfaces (e.g., 2G, 3G, 4G, 4G long-term evolution (LTE), 5G, GSM, CDMA, or the like), fiber optic interfaces, acoustic interfaces, Bluetooth interfaces, infrared interfaces, USB interfaces, Wi-Fi interfaces (e.g., for communicating using Wi-Fi communication standards and/or protocols, including IEEE 802.11, 802.11b, 802.11a, 802.11 g, 802.11n, 802.11ac, 802.11ax (Wi-Fi 6, 6E), 802.11be (Wi-Fi 26), or any other suitable Wi-Fi standards and/or protocols), TCP/IP interfaces, network communications interfaces, or any conventional communication interfaces. The one or more communications channels 2604 may also include ultra-wideband (UWB) interfaces, which may include any appropriate communications circuitry, instructions, and number and position of suitable UWB antennas.

As shown in FIG. 26, the device 2600 may include a battery 2607 that is used to store and provide power to the other components of the device 2600. The battery 2607 may be a rechargeable power supply that is configured to provide power to the device 2600. The battery 2607 may be coupled to charging systems (e.g., wired and/or wireless charging systems) and/or other circuitry to control the electrical power provided to the battery 2607 and to control the electrical power provided from the battery 2607 to the device 2600. The battery 2607 may be attached to the device via an electrically debondable adhesive, as described herein.

The device 2600 may also include one or more displays 2608 configured to display graphical outputs. The displays 2608 may use any suitable display technology, including liquid crystal displays (LCD), organic light-emitting diodes (OLED), active-matrix organic light-emitting-diode displays (AMOLED), or the like. The displays may use a low temperature polycrystalline silicone (LTPS) or low temperature polycrystalline oxide (LTPO) backplane. The displays 2608 may display graphical user interfaces, images, icons, or any other suitable graphical outputs. The display 2608 may correspond to a display 103, 143, 163, or other displays described herein.

The device 2600 may also provide audio input functionality via one or more audio input systems 2609. The audio input systems 2609 may include microphones, transducers, or other devices that capture sound for voice calls, video calls, audio recordings, video recordings, voice commands, and the like.

The device 2600 may also provide audio output functionality via one or more audio output systems (e.g., speakers) 2610, such as the speaker systems and/or modules described herein. The audio output systems 2610 may produce sound from voice calls, video calls, streaming or local audio content, streaming or local video content, or the like.

The device 2600 may also include a positioning system 2611. The positioning system 2611 may be configured to determine the location of the device 2600. For example, the positioning system 2611 may include magnetometers, gyroscopes, accelerometers, optical sensors, cameras, global positioning system (GPS) receivers, inertial positioning systems, or the like. The positioning system 2611 may be used to determine spatial parameters of the device 2600, such as the location of the device 2600 (e.g., geographical coordinates of the device), measurements or estimates of physical movement of the device 2600, an orientation of the device 2600, or the like.

The device 2600 may also include one or more additional sensors 2612 (also referred to as sensing systems) to receive inputs (e.g., from a user or another computer, device, system, network, etc.) or to detect any suitable property or parameter of the device, the environment surrounding the device, people, or things interacting with the device (or nearby the device), or the like. For example, a device may include temperature sensors, biometric sensing systems (e.g., fingerprint sensors, facial recognition systems, photoplethysmographs, blood-oxygen sensors, blood sugar sensors, or the like), eye-tracking sensors, proximity sensors, depth sensing systems (e.g., time-of-flight based depth or distance sensors), ambient light sensors, retinal scanners, humidity sensors, buttons, switches, lid-closure sensors, or the like. The sensors 2612 may also include cameras, which may be or may include camera modules. Camera modules may refer to assemblies that include camera components such as a lens assembly, an image sensor, a camera module housing or other structural component, and/or other components, systems, structures, etc.

To the extent that multiple functionalities, operations, and structures described with reference to FIG. 26 are disclosed as being part of, incorporated into, or performed by the device 2600, it should be understood that various embodiments may omit any or all such described functionalities, operations, and structures. Thus, different embodiments of the device 2600 may have some, none, or all of the various capabilities, apparatuses, physical features, modes, and operating parameters discussed herein. Further, the systems included in the device 2600 are not exclusive, and the device 2600 may include alternative or additional systems, components, modules, programs, instructions, or the like, that may be necessary or useful to perform the functions described herein.

As described above, one aspect of the present technology is the gathering and use of data available from various sources to improve the usefulness and functionality of devices such as mobile phones. The present disclosure contemplates that in some instances, this gathered data may include personal information data that uniquely identifies or can be used to contact or locate a specific person. Such personal information data can include demographic data, location-based data, telephone numbers, email addresses, Twitter IDs, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to locate devices, deliver targeted content that is of greater interest to the user, or the like. Further, other uses for personal information data that benefit the user are also contemplated by the present disclosure. For instance, health and fitness data may be used to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adopted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of advertisement delivery services, the present technology can be configured to allow users to select to “opt in” or “opt out” of participation in the collection of personal information data during registration for services or anytime thereafter. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data at a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content can be selected and delivered to users by inferring preferences based on non-personal information data or a bare minimum amount of personal information, such as the content being requested by the device associated with a user, other non-personal information available to the content delivery services, or publicly available information.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not targeted to be exhaustive or to limit the embodiments to the precise forms disclosed. It will be apparent to one of ordinary skill in the art that many modifications and variations are possible in view of the above teachings. Also, when used herein to refer to positions of components, the terms above, below, over, under, left, or right (or other similar relative position terms), do not necessarily refer to an absolute position relative to an external reference, but instead refer to the relative position of components within the figure being referred to. Similarly, horizontal and vertical orientations may be understood as relative to the orientation of the components within the figure being referred to, unless an absolute horizontal or vertical orientation is indicated.

Features, structures, configurations, components, techniques, etc. shown or described with respect to any given figure (or otherwise described in the application) may be used with features, structures, configurations, components, techniques, etc. described with respect to other figures. For example, any given figure of the instant application should not be understood to be limited to only those features, structures, configurations, components, techniques, etc. shown in that particular figure. Similarly, features, structures, configurations, components, techniques, etc. shown only in different figures may be used or implemented together. Further, features, structures, configurations, components, techniques, etc. that are shown or described together may be implemented separately and/or combined with other features, structures, configurations, components, techniques, etc. from other figures or portions of the instant specification. Further, for ease of illustration and explanation, figures of the instant application may depict certain components and/or sub-assemblies in isolation from other components and/or sub-assemblies of an electronic device, though it will be understood that components and sub-assemblies that are illustrated in isolation may in some cases be considered different portions of a single electronic device (e.g., a single embodiment that includes multiple of the illustrated components and/or sub-assemblies).

What is claimed is:

1. A mobile phone comprising:
a display;
a front cover positioned over the display;
a housing structure coupled to the front cover and comprising:
a first metal segment defining:
at least a portion of a first side exterior surface of the mobile phone; and
at least a portion of a second side exterior surface of the mobile phone;
a second metal segment at least partially defining a protrusion, the protrusion defining a rear-facing sensor array region of the mobile phone; and
a nonconductive joint structure positioned in a gap defined between the first metal segment and the second metal segment, the gap extending at least partially around the protrusion and defining a slot antenna; and
wireless communications circuitry conductively coupled to at least one of the first metal segment or the second metal segment and configured to cause the slot antenna to radiate to produce a wireless signal.

2. The mobile phone of claim 1, wherein:
the wireless signal is a first wireless signal;
the slot antenna is a first slot antenna along a first portion of the gap;
the wireless communication circuitry is first wireless communication circuitry;
the gap defines a second slot antenna along a second portion of the gap different from the first portion of the gap; and
the mobile phone further comprises second wireless communications circuitry configured to cause the second slot antenna to radiate to produce a second wireless signal.

3. The mobile phone of claim 2, further comprising:
a first conductive element conductively coupling the first metal segment to the second metal segment across the gap at a first location to define an end of the first slot antenna; and
a second conductive element conductively coupling the first metal segment to the second metal segment across the gap at a second location to define an end of the second slot antenna.

4. The mobile phone of claim 1, wherein:
the gap is a first gap;
the housing structure further comprises:
a third metal segment coupled to the first metal segment and the second metal segment and defining at least a portion of a top side exterior surface of the mobile phone; and
a fourth metal segment coupled to the first metal segment and the second metal segment and defining at least a portion of a bottom side exterior surface of the mobile phone.

5. The mobile phone of claim 4, wherein:
the wireless communication circuitry is first wireless communication circuitry; and
the mobile phone further comprises second wireless communications circuitry conductively coupled to the third metal segment and configured to operate a portion of the third metal segment as an additional antenna.

6. The mobile phone of claim 5, wherein:
the third metal segment defines a hole; and
the mobile phone further comprises an antenna module positioned at least partially within the housing structure and configured to transmit and receive wireless signals through the hole in the third metal segment.

7. The mobile phone of claim 6, further comprising a dielectric material window positioned in the hole and covering the antenna module.

8. A portable electronic device comprising:
an enclosure comprising:
a light transmissive cover defining a front exterior surface of the portable electronic device; and
a housing structure comprising:
a first metal segment defining a portion of a rear exterior surface of the portable electronic device; and
a second metal segment protruding from the portion of the rear exterior surface defined by the first metal segment, the second metal segment conductively isolated from the first metal segment along a gap defined between the first metal segment and the second metal segment, the gap defining a slot antenna; and
wireless communications circuitry operatively coupled to the slot antenna and configured to send and receive wireless signals via the slot antenna.

9. The portable electronic device of claim 8, wherein:
the second metal segment defines:
a rear-facing sensor array region;
a first hole extending through the second metal segment in the rear-facing sensor array region; and
a second hole extending through the second metal segment in the rear-facing sensor array region;
the portable electronic device further includes:
a first camera module positioned at least partially in the first hole; and
a second camera module positioned at least partially in the second hole.

10. The portable electronic device of claim 8, further comprising a nonconductive joint structure positioned in the gap and configured to conductively isolate a portion of the first metal segment from a portion of the second metal segment.

11. The portable electronic device of claim 10, wherein the nonconductive joint structure defines a portion of a curved transition surface between the first metal segment and the second metal segment.

12. The portable electronic device of claim 11, wherein:
the portion of the curved transition surface is a first portion of the curved transition surface;
the first metal segment defines a second portion of the curved transition surface; and
the second metal segment defines a third portion of the curved transition surface.

13. The portable electronic device of claim 10, wherein:
the gap extends continuously around a periphery of the second metal segment; and
the nonconductive joint structure defines a continuous ring structure positioned in the gap, the continuous ring structure defining an additional portion of the rear exterior surface of the portable electronic device.

14. The portable electronic device of claim 8, wherein:
the slot antenna is a first slot antenna;
the wireless communication circuitry is first wireless communication circuitry;
the wireless signals are first wireless signals;
the gap further defines a second slot antenna and a third slot antenna; and
the portable electronic device further comprises:
second wireless communication circuitry operatively coupled to the second slot antenna and configured to send and receive second wireless signals via the second slot antenna; and
third wireless communication circuitry operatively coupled to the third slot antenna and configured to send and receive third wireless signals via the second slot antenna.

15. A mobile phone comprising:
a housing structure comprising:
a first housing segment defining a portion of a rear exterior surface of the mobile phone;
a second housing segment defining a protrusion protruding from the first housing segment and defining a rear-facing sensor array region; and
a dielectric structure positioned at least partially within a gap defined between the first housing second and the second housing segment and extending around the protrusion;
wireless communication circuitry operatively coupled to the housing structure at a first location to operate a first portion of the gap as a first slot antenna and operatively coupled to the housing structure at a second location to operate a second portion of the gap as a second slot antenna; and
a camera module coupled to the second housing segment in the rear-facing sensor array region.

16. The mobile phone of claim 15, wherein the housing structure further comprises:
a first conductive element conductively coupling the first housing segment to the second housing segment across the gap at a third location to define an end of the first slot antenna; and
a second conductive element conductively coupling the first housing segment to the second housing segment across the gap at a fourth location to define an end of the second slot antenna.

17. The mobile phone of claim 16, wherein:
the first housing segment is a first metal housing segment;
the second housing segment is a second metal housing segment;
the first conductive element is welded to the first metal housing segment and the second metal housing segment; and
the second conductive element is welded to the first metal housing segment and the second metal housing segment.

18. The mobile phone of claim 15, wherein:
the portion of the rear exterior surface is a first portion of the rear exterior surface;
the second housing segment defines a second portion of the rear exterior surface; and
the dielectric structure defines a portion of a curved transition region extending from the first portion of the rear exterior surface to the second portion of the rear exterior surface.

19. The mobile phone of claim 15, wherein:
the wireless communication circuitry is first wireless communication circuitry;
the housing structure further comprises a third housing segment formed of metal and defining at least a portion of a first corner of the housing structure and at least a portion of a second corner of the housing structure; and
the mobile phone further comprises second wireless communication circuitry operatively coupled to the third housing segment and configured to operate at least a portion of the third housing segment as an additional antenna.

20. The mobile phone of claim 19, wherein:
the third housing segment defines a hole extending therethrough;
the mobile phone further comprises:
a nonconductive window element positioned in the hole and defining a portion of a top exterior surface of the mobile phone; and
an antenna module coupled to the third housing segment and configured to transmit and receive wireless signals through the nonconductive window element.
